(19) United States
(12) Patent Application Publication
(10) Pub. No.: US 2014/0236351 A1
(43) Pub. Date: Aug. 21, 2014

(54) Programmed Dispensing of Consumable Compositions

(71) Applicant: SEARETE LLC, Bellevue, WA (US)

(72) Inventors: Roderick A. Hyde, Redmond, WA (US); Eric C. Leuthardt, St. Louis, MO (US); Robert W. Lord, Seattle, WA (US); Clarence T. Tegreene, Mercer Island, WA (US); Lowell L. Wood, JR., Bellevue, WA (US)

(73) Assignee: SEARETE LLC, Bellevue, WA (US)

(21) Appl. No.: 14/182,201

(22) Filed: Feb. 17, 2014

Related U.S. Application Data
(63) Continuation-in-part of application No. 11/998,461, filed on Nov. 29, 2007.
Application No. 11/998,461 is a continuation-in-part of application No. 12/001,061, filed on Dec. 7, 2007, now Pat. No. 8,718,817.
Application No. 12/001,061 is a continuation-in-part of application No. 12/001,063, filed on Dec. 7, 2007, now Pat. No. 7,804,419.
Application No. 12/001,063 is a continuation-in-part of application No. 12/002,794, filed on Dec. 18, 2007, now Pat. No. 8,457,783.
Application No. 12/002,794 is a continuation-in-part of application No. 12/004,094, filed on Dec. 19, 2007, now Pat. No. 8,362,914.
Application No. 12/004,094 is a continuation-in-part of application No. 12/006,252, filed on Dec. 31, 2007, now Pat. No. 8,758,677.
Application No. 12/006,252 is a continuation-in-part of application No. 12/012,500, filed on Feb. 1, 2008, now Pat. No. 7,919,042.
Application No. 12/012,500 is a continuation-in-part of application No. 12/074,245, filed on Feb. 29, 2008.
Application No. 12/074,245 is a continuation-in-part of application No. 12/217,121, filed on Jun. 30, 2008, now Pat. No. 8,116,907.
Application No. 12/217,121 is a continuation-in-part of application No. 12/383,458, filed on Mar. 23, 2009.
Application No. 12/383,458 is a continuation-in-part of application No. 12/799,977, filed on May 5, 2010, now Pat. No. 8,718,819.
Application No. 12/799,977 is a continuation-in-part of application No. 12/799,978, filed on May 5, 2010.
Application No. 12/799,978 is a continuation-in-part of application No. 12/927,038, filed on Nov. 4, 2010, now Pat. No. 8,652,412.

(51) Int. Cl. A61J 7/04; G06F 19/00

(52) U.S. Cl. CPC A61J 7/0481; G06F 19/3462
USPC 700/244

(57) ABSTRACT

Methods and systems for administering consumable compositions according to a programmed dosing schedule are provided. A method for administering a consumable composition may comprise one or more of the following steps: (a) dispensing a dose of a consumable composition according to a programmed dosing schedule; and (b) detecting an aspect of the consumable composition. A system for administering a consumable composition may comprise: (a) means for dispensing a dose of a consumable composition according to a programmed dosing schedule; and (b) means for detecting an aspect of the consumable composition.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/998,461, entitled Programmed Dispensing of Consumable Compositions, naming Roderick A. Hyde, Eric C. Leuthardt, Robert W. Lord, Clarence T. Tegreene, and Lowell L. Wood, Jr. as inventors, filed Nov. 29, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/001,061, entitled Programmed Dispensing of Consumable Compositions, naming Roderick A. Hyde, Eric C. Leuthardt, Robert W. Lord, Clarence T. Tegreene, and Lowell L. Wood, Jr. as inventors, filed Dec. 7, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/001,063, entitled Programmed Dispensing of Consumable Compositions, naming Roderick A. Hyde, Eric C. Leuthardt, Robert W. Lord, Clarence T. Tegreene, and Lowell L. Wood, Jr. as inventors, filed Dec. 7, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/002,794, entitled Communication Regarding Aspects of a Dispensed Consumable Composition, naming Roderick A. Hyde, Eric C. Leuthardt, Robert W. Lord, Clarence T. Tegreene, and Lowell L. Wood, Jr. as inventors, filed Dec. 18, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/004,094, entitled Communication Regarding Aspects of a Dispensed Consumable Composition, naming Roderick A. Hyde, Eric C. Leuthardt, Robert W. Lord, Clarence T. Tegreene, and Lowell L. Wood, Jr. as inventors, filed Dec. 19, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/006,252, entitled Sterilization of Consumable Composition Dispensers, naming Roderick A. Hyde, Eric C. Leuthardt, Robert W. Lord, Clarence T. Tegreene, and Lowell L. Wood, Jr. as inventors, filed Dec. 31, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/012,500, entitled Sterilization of Consumable Composition Dispensers, naming Roderick A. Hyde, Eric C. Leuthardt, Robert W. Lord, Clarence T. Tegreene, and Lowell L. Wood, Jr. as inventors, filed Feb. 1, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/074,245, entitled Programmed Dispensing Of Consumable Compositions, naming Roderick A. Hyde, Eric C. Leuthardt, Robert W. Lord, Clarence T. Tegreene, and Lowell L. Wood, Jr. as inventors, filed Feb. 29, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,121, entitled Reordering of Consumable Compositions, naming Roderick A. Hyde, Eric C. Leuthardt, Robert W. Lord, Clarence T. Tegreene, and Lowell L. Wood, Jr. as inventors, filed Jun. 30, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/383,458, entitled Programmed Dispensing Of Consumable Compositions, naming Roderick A. Hyde, Eric C. Leuthardt, Robert W. Lord, Clarence T. Tegreene, and Lowell L. Wood, Jr. as inventors, filed Mar. 23, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/799,977, entitled Programmed Dispensing Of Consumable Compositions, naming Roderick A. Hyde, Eric C. Leuthardt, Robert W. Lord, Clarence T. Tegreene, and Lowell L. Wood, Jr. as inventors, filed May 5, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/799,978, entitled Programmed Dispensing Of Consumable Compositions, naming Roderick A. Hyde, Eric C. Leuthardt, Robert W. Lord, Clarence T. Tegreene, and Lowell L. Wood, Jr. as inventors, filed May 5, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/927,038, entitled Sterilization Of Consumable Composition Dispensers, naming Roderick A. Hyde, Eric C. Leuthardt, Robert W. Lord, Clarence T. Tegreene, and Lowell L. Wood, Jr. as inventors, filed Nov. 4, 2010, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND

Programmed regimens of consumable compositions may be prescribed by a physician or may simply be desirable for the health and well-being of an individual. However, confusion may arise concerning the schedule, dosage, and/or compliance with a programmed dosing regimen.

### BRIEF DESCRIPTION OF THE FIGURES

FIG. 1 shows a high-level block diagram of a beverage container.

FIG. 2 is a high-level logic flowchart of a process.

FIG. 3 is a high-level logic flowchart of a process.

FIG. 4 is a high-level logic flowchart of a process.

FIG. 5 is a high-level logic flowchart of a process.

FIG. 6 is a high-level logic flowchart of a process.

FIG. 7 is a high-level logic flowchart of a process.

FIG. 8 is a high-level logic flowchart of a process.

FIG. 9 is a high-level logic flowchart of a process.

FIG. 10 is a high-level logic flowchart of a process.

FIG. 11 is a high-level logic flowchart of a process.

FIG. 12 is a high-level logic flowchart of a process.

FIG. 13 is a high-level logic flowchart of a process.

FIG. 14 is a high-level logic flowchart of a process.

FIG. 15 is a high-level logic flowchart of a process.

FIG. 16 is a high-level logic flowchart of a process.

FIG. 17 is a high-level logic flowchart of a process.

FIG. 18 is a high-level logic flowchart of a process.

FIG. 19 is a high-level logic flowchart of a process.

FIG. 20 is a high-level logic flowchart of a process.

FIG. 21 is a high-level logic flowchart of a process.

FIG. 22 is a high-level logic flowchart of a process.

FIG. 23 is a high-level logic flowchart of a process.

FIG. 24 is a high-level logic flowchart of a process.

FIG. 25 is a high-level logic flowchart of a process.

FIG. 26 is a high-level logic flowchart of a process.

FIG. 27 is a high-level logic flowchart of a process.

FIG. 28 is a high-level logic flowchart of a process.

FIG. 29 is a high-level logic flowchart of a process.

FIG. 30 is a high-level logic flowchart of a process.

FIG. 31 is a high-level logic flowchart of a process.

FIG. 32 is a high-level logic flowchart of a process.

FIG. 33 is a high-level logic flowchart of a process.

FIG. 34 is a high-level logic flowchart of a process.

FIG. 35 is a high-level logic flowchart of a process.

FIG. 36 is a high-level logic flowchart of a process.

FIG. 37 is a high-level logic flowchart of a process.

FIG. 38 is a high-level logic flowchart of a process.

FIG. 39 is a high-level logic flowchart of a process.

FIG. 40 is a high-level logic flowchart of a process.

FIG. 41 is a high-level logic flowchart of a process.

FIG. 42 is a high-level logic flowchart of a process.

FIG. 43 is a high-level logic flowchart of a process.

FIG. 44 is a high-level logic flowchart of a process.

FIG. 45 is a high-level logic flowchart of a process.

FIG. 46 is a high-level logic flowchart of a process.

FIG. 47 is a high-level logic flowchart of a process.

FIG. 48 is a high-level logic flowchart of a process.

FIG. 49 is a high-level logic flowchart of a process.

FIG. 50 is a high-level logic flowchart of a process.

FIG. 51 is a high-level logic flowchart of a process.

FIG. 52 is a high-level logic flowchart of a process.

FIG. 53 is a high-level logic flowchart of a process.

FIG. 54 is a high-level logic flowchart of a process.

FIG. 55 is a high-level logic flowchart of a process.

FIG. 56 is a high-level logic flowchart of a process.

FIG. 57 is a high-level logic flowchart of a process.

FIG. 58 is a high-level logic flowchart of a process.

FIG. 59 is a high-level logic flowchart of a process.

FIG. 60 is a high-level logic flowchart of a process.

FIG. 61 is a high-level logic flowchart of a process.

FIG. 62 is a high-level logic flowchart of a process.

FIG. 63 is a high-level logic flowchart of a process.

FIG. 64 is a high-level logic flowchart of a process.

FIG. 65 is a high-level logic flowchart of a process.

FIG. 66 is a high-level logic flowchart of a process.

FIG. 67 is a high-level logic flowchart of a process.

FIG. 68 is a high-level logic flowchart of a process.

FIG. 69 is a high-level logic flowchart of a process.

FIG. 70 is a high-level logic flowchart of a process.

FIG. 71 is a high-level logic flowchart of a process.

FIG. 72 is a high-level logic flowchart of a process.

FIG. 73 is a high-level logic flowchart of a process.

FIG. 74 is a high-level logic flowchart of a process.

FIG. 75 is a high-level logic flowchart of a process.

FIG. 76 is a high-level logic flowchart of a process.

FIG. 77 is a high-level logic flowchart of a process.

FIG. 78 is a high-level logic flowchart of a process.

FIG. 79 is a high-level logic flowchart of a process.

FIG. 80 is a high-level logic flowchart of a process.

FIG. 81 is a high-level logic flowchart of a process.

FIG. 82 is a high-level logic flowchart of a process.

FIG. 83 is a high-level logic flowchart of a process.

FIG. 84 is a high-level logic flowchart of a process.

FIG. 85 is a high-level logic flowchart of a process.

FIG. 86 is a high-level logic flowchart of a process.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

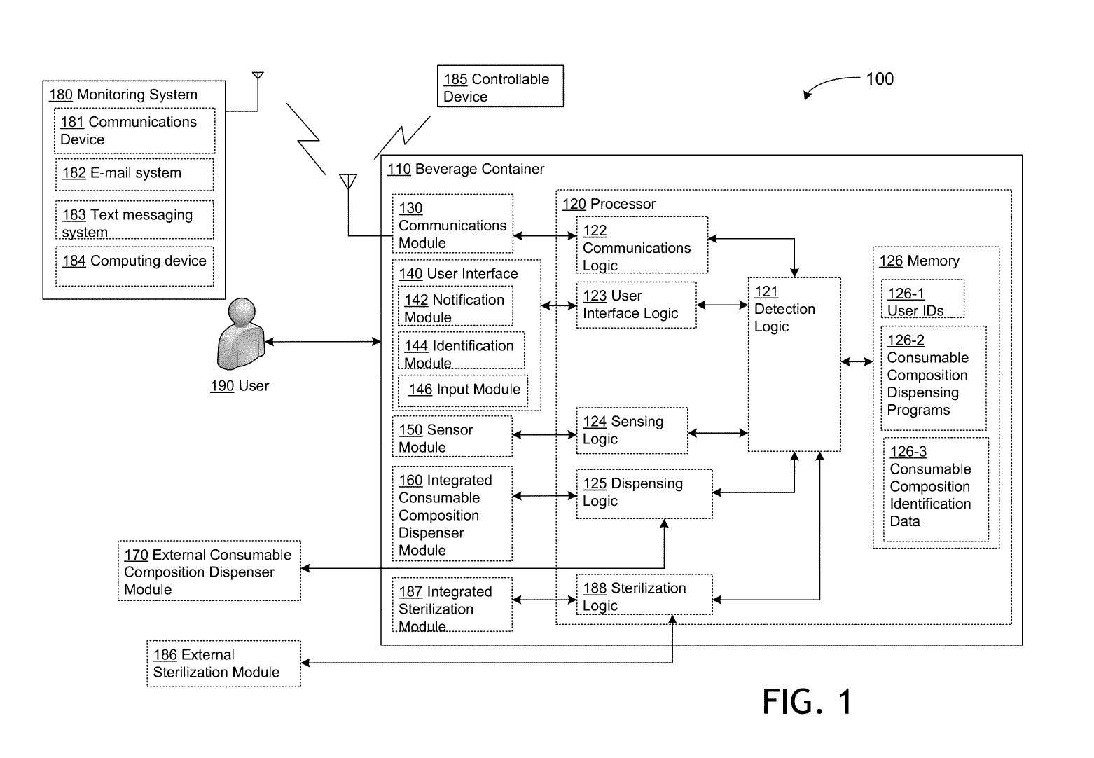

FIG. 1 illustrates an example environment in which one or more technologies may be implemented. A consumable composition dispensing system 100 may comprise a beverage container 110 to be used by user 190. The beverage container 110 may be any receptacle configured for retaining a liquid or gel composition. For example, the beverage container 110 may include a cup, glass, mug, bowl, pitcher, jug, or the like.

The beverage container 110 may include a processor 120 (e.g. a microprocessor), a communications module 130 (e.g. a cellular transceiver, a Bluetooth transceiver, a WiFi transceiver, a satellite transceiver), a user interface 140 (e.g. display, touchscreen, keypad, speaker system), a sensor module 150 (e.g. a thermometer, barometer, concentration sensor, biometric sensor, accelerometer, UV sensor) an integrated consumable composition dispenser module 160 (e.g. injector, mechanical dispenser) and/or an integrated sterilization module 187 (e.g. a heating element).

The integrated consumable composition dispenser module 160 may be physically incorporated as a component of the beverage container 110. The integrated consumable composition dispenser module 160 may include an actuated mechanical apparatus which opens in response to a command from dispensing logic 125, thereby dispensing a dose of the consumable composition. The beverage container 110 may be configured to receive a dose of the consumable composition via gravitational flow or by pressurized injection of the dispensed composition from the integrated consumable composition dispenser module 160.

The external consumable composition dispenser module 170 may be physically separated from the beverage container 110. The external consumable composition dispenser module 170 may include a mechanical apparatus which opens in response to a command from dispensing logic 125 so as to introduce a dose of the consumable composition into the beverage container 110. The beverage container 110 may be configured to receive a dose of the consumable composition via a communicating assembly whereby the beverage container 110 may be physically coupled to the external consumable composition dispenser module 170 via a mutual conduit operably configured to allow the passage of the consumable composition between the external consumable composition dispenser module 170 and the beverage container 110.

Processor 120 may include communications logic 122, user interface logic 123, sensing logic 124, dispensing logic 125, memory 126, and/or sterilization logic 188.

Memory 126 may include user IDs 126-1, consumable composition dispensing programs 126-2, and/or consumable composition identification data 126-3.

User interface 140 may include a notification module 142 (e.g. an LED), an identification module 144 (a fingerprint scanner), and/or an input module 146 (a microphone).

Sensor module 150 may include one or more of a light source sensor, a position sensor, an emission sensor, a spectrophotometer, an infrared or ultraviolet sensor, a biometric sensor and the like. Sensor module 150 may include a biometric sensor which senses the presence of saliva, perspiration, sebum and the like, either on the surface of the beverage container 110 or as a component of the contents therein. Sensor module 150 may include an accelerometer, an inertial motion sensor, and the like, which may sense the movement of the beverage container 110. Sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, and the like which senses a pressure applied to the beverage container 110. Sensor module 150 may include a capacitive concentration sensor which may sense a concentration of the consumable composition present in the beverage container 110. Sensor module 150 may include an inclinometer and the like. Sensor module 150 may include a flowmeter for sensing a flowrate into or out of the beverage container 110. Sensor module 150 may include a capacitive level sensor, such as a strip or dual-probe sensor (e.g., a strip running down that side of the cup to sense a fluid level based at least in part between differences in the known/inferred/assumed dielectric constants of air and a fluid). In some instances, the dielectric constant is recalled/calculated in response to a sensed composition of a fluid (e.g., sensed constituents of an alcoholic cocktail); in other instances, the dielectric constant is assumed (e.g., defaults to that of water). Sensor module 150 may include an electro-chemical analyzer (e.g. an electrode pair disposed within an electrolyte capable of measuring an electrochemical reaction) for measuring a concentration of a gas in an atmosphere. Sensor module 150 may include a chemical composition analysis mechanism (e.g. photoionization sensors, spectroscopic sensors, spectrometric sensors, crystallographic sensors, electrochemical sensors, calorimetric sensors).

The consumable composition dispensing system 100 may further include an external consumable composition dispenser module 170 (e.g. injector, mechanical dispenser) and/or external sterilization module 186 (e.g. an autoclave).

Monitoring system 180 may relay a notification (e.g. a notification that a sterilization of the beverage container 110 has occurred) received from communications module 130 to a communications device 181 (e.g. a cell phone, satellite phone, Blackberry®, and/or land-line phone), e-mail system 182 (e.g. an IMAP, POP3, SMTP, and/or HTTP e-mail server having an e-mail account associated with a user 190), text messaging system 183 (e.g. SMS system in GSM) and/or a computing device 184 (e.g. a personal digital assistant (PDA), personal computer, laptop, music player and/or gaming device).

The consumable composition may be a pharmaceutical composition including, but not limited to, one or more of the following: 5-alpha reductase inhibitors, 5-HT antagonists, ACE inhibitors, adrenergic agonists, adrenergic neurone blockers, alkalising agent, alpha blockers, aminoglycosides, anaesthetics, analgesics, androgens, angiotensin receptor blockers, anti-allergics, antiandrogens, antianginals, antiarrhythmics, antibiotics, anticholinergics, anticholinesterase, anticoagulants, anticonvulsants, antidepressants, antidiarrhoeals, antidopaminergics, anti-emetics, antiepileptics, antiflatulents, antifungal, antifungals, anti-hemophilics, antihistamine, antihistamines, antiplatelets, antipsychotics, antiseptics, antispasmodic, antispasmodics, antithyroid drugs, antitussives, anxiolytics, astringents, barbiturates, benzodiazepine, beta-receptor antagonists, beta-receptor blocker, bile acid sequestrants, bronchodilators, calcitonins, calcium channel blockers, cannabinoids, carbonic anhydrase inhibitors/hyperosmotics, cardiac glycosides, cerumenolyti, cholinergics, corticosteroids, COX-2 selective inhibitors, cycloplegics, cyclopyrrolone, cytoprotectants, decongestants, diphosphonates, diuretics, dopamine antagonist, emetic, fibrinolytics, fluoroquinolones, gonadotropins, growth hormones, H2-receptor antagonists, haemostatic drugs, heparins, hormonal contraceptives, hypnotics, hypolipidaemic agents, imidazoles, immunoglobulins, immunosuppressants, insulin, interferons, laxatives, local anesthetics, mast cell inhibitors, miotics, monoclonal antibodies, movement disorder drugs, mucolytics, muscle relaxants, mydriatics, neuromuscular drugs, nitrates, nitroglycerin, NSAIDs, ocular lubricants, opioids, parasympatholytics, parasympathomimetics, peripheral activators, polyenes, prostaglandin agonists/prostaglandin inhibitors, prostaglandin analogues, proton pump inhibitors, quinolones, reflux suppressants, selective alpha-1 blocker, sildenafil, statins, steroids, stimulants, sulfa drugs, sympathomimetics, thyroid hormones, topical anesthetics, topical antibiotics, vaccines, vasoconstrictors, vasodilators, vasopressin analogues, or the like.

The consumable composition may be a neutraceutical composition including, but not limited to, one or more of the following: vitamins (e.g., ascorbic acid, pyridoxine, riboflavin), minerals (e.g., calcium salts, zinc salts, potassium salts), hormones (e.g., dimethylaminoethanol (DMAE), dehydroepiandrosterone (DHEA), melatonin), biochemicals (e.g., adenosine triphosphate, coenzyme A, cysteine), glandulars (e.g., edible compositions derived from glandular organs of animals such as the thyroid, pancreas, adrenal cortex), herbals (e.g., ginkgo, garlic, goldenseal, echinacea), or the like.

### Application Ser. No. 11/998,461 (0107A-002-005A-000000)

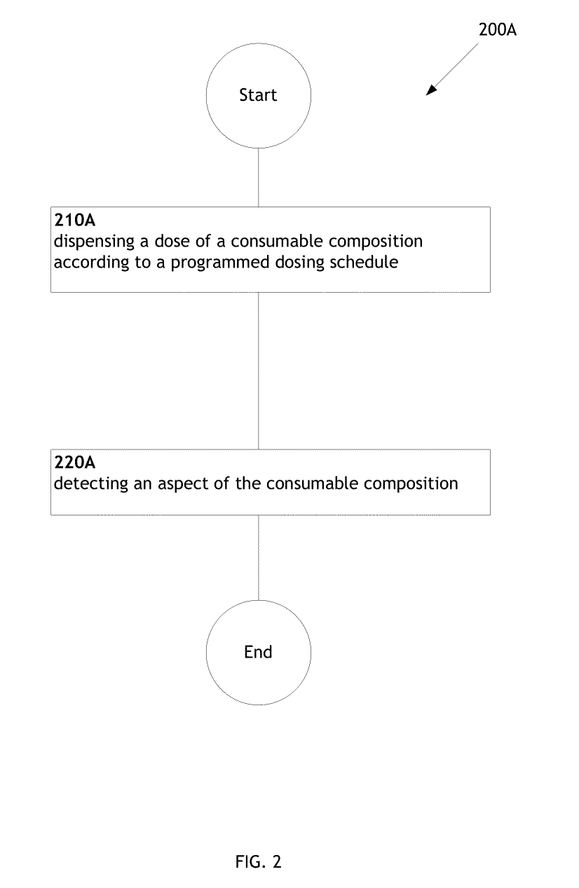

FIG. 2 illustrates an operational flow 200A representing example operations related to programmed dispensing of consumable compositions. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

At operation 210A, a dose of a consumable composition may be dispensed according to a programmed dosing schedule. For example, as shown in FIG. 1, an integrated consumable composition dispenser module 160, and/or an external consumable composition dispenser module 170 may distribute one or more doses (e.g. 30 mg) of a consumable composition (e.g., an anti-depressant, such as Paroxotene) into a beverage container 110 (e.g., a drinking cup) according to a programmed dosing schedule (e.g. electronic data representing a physician-prescribed regimine of medication maintained in memory 126).

At operation 220A, an aspect of the consumable composition may be detected. For example, as shown in FIG. 1, an aspect (e.g. an amount dispensed) of the consumable composition may be detected by detection logic 121 receiving data from sensing logic 124 operably coupled to a sensor module 150 (e.g. a capacitive concentration sensor), communications logic 122 operably coupled to a communications module 130 (e.g. a wireless transceiver), user interface logic 123 operably coupled to a user interface 140 (e.g. a keypad or touchscreen), dispensing logic 125 operably coupled to an integrated consumable composition dispenser module 160, and/or an external consumable composition dispenser module 170 (e.g. an actuated release mechanism), and/or sterilization logic 188 operably coupled to a sterilization module 186, 187 (e.g. an ultra-violet radiation source).

The aspect of the consumable composition may include, but is not limited to, an amount of consumable composition dispensed into the beverage container 110, an amount of consumable composition present in the beverage container 110, an amount of the composition removed from the beverage container 110, an identity (e.g. a chemical composition) of the consumable composition, an identity of a user 190 (e.g. a fingerprint), a user input 146, a programmed schedule for dispensing the consumable composition, and the like.

The aspect of the consumable composition may be communicated via the communication module 130 to an outside entity. The outside entity may be a monitoring system 180 (e.g. a LAN associated with a physician's office) or a controllable device 185 which may be controlled according to the aspect of the consumable composition (e.g. a cell phone).

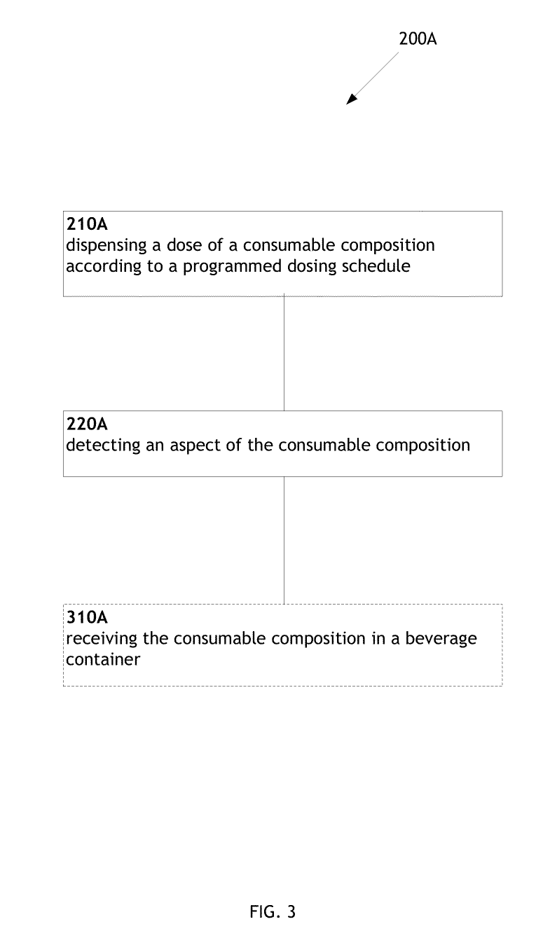

FIG. 3 illustrates an operational flow 300A representing example operations related to programmed dispensing of consumable compositions. FIG. 3 illustrates an example embodiment where the example operational flow 200A of FIG. 2 may include at least one additional operation. Additional operations may include an operation 310A.

At operation 310A, a consumable composition may be received in a beverage container 110. For example, as shown in FIG. 1, the beverage container 110 may include any receptacle configured for retaining liquid or gel composition. The beverage container may include a cup, glass, mug, bowl, pitcher, jug, and the like.

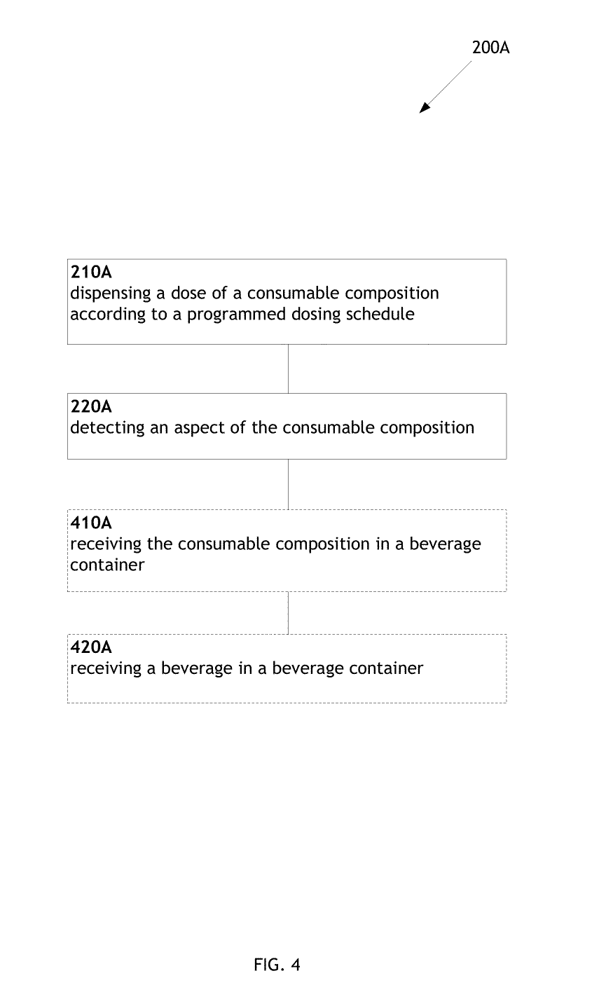

FIG. 4 illustrates an operational flow 400A representing example operations related to programmed dispensing of consumable compositions. FIG. 4 illustrates an example embodiment where the example operational flow 200A of FIG. 2 may include at least one additional operation. Additional operations may include an operation 410A, and/or an operation 420A.

At operation 410A, the consumable composition may be received in a beverage container 110. For example, as shown in FIG. 1, the beverage container 110 may include any receptacle configured for retaining liquid or gel composition. The beverage container may include a cup, glass, mug, bowl, pitcher, jug, and the like.

At operation 420A, a beverage (e.g. water) may be received in the beverage container 110. For example, as shown in FIG. 1, the beverage may include any composition which may be introduced and retained in a beverage container 110, including water, soda pop, coffee, juice, milk, tea and the like.

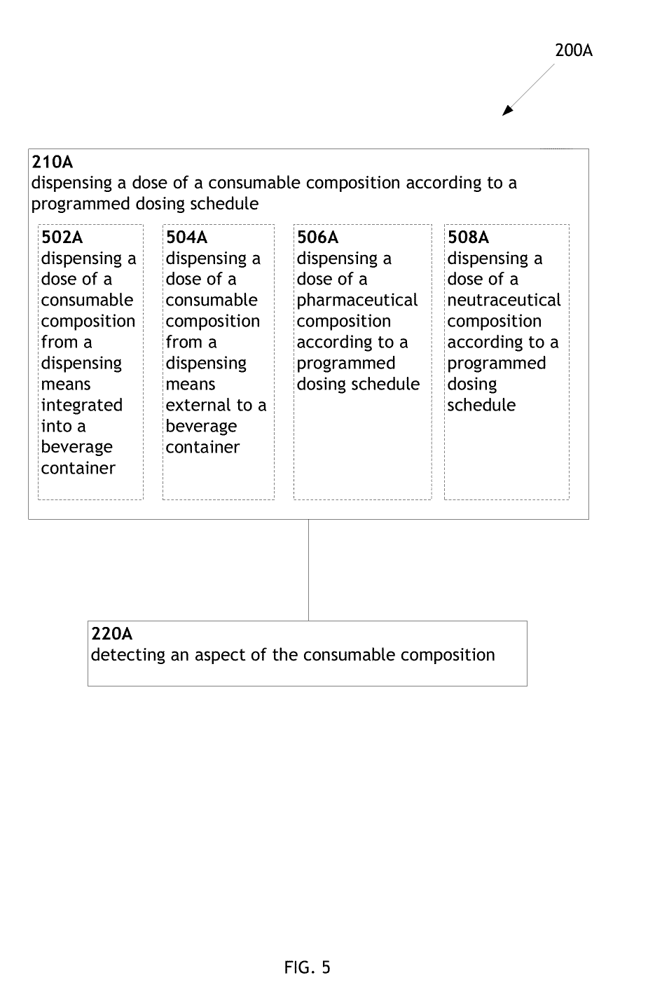

FIG. 5 illustrates alternative embodiments of the example operational flow 200A of FIG. 2. FIG. 5 illustrates example embodiments where the dispensing operation 210 may include at least one additional operation. Additional operations may include an operation 502, an operation 504, an operation 506, and/or an operation 508.

At operation 502A, a dose of a consumable composition may be dispensed from a dispenser module 160 integrated (e.g. physically attached) into a beverage container. For example, as shown in FIG. 1, the integrated consumable composition dispenser module 160 may be physically incorporated as a component of the beverage container 110. The integrated consumable composition dispenser module 160 may include an actuated mechanical apparatus which opens in response to a command from dispensing logic 125, thereby dispensing a dose of the consumable composition. The beverage container 110 may be configured to receive a dose of the consumable composition via gravitational flow or by pressurized injection of the dispensed composition from the integrated consumable composition dispenser module 160.

At operation 504A, a dose of a consumable composition may be dispensed from a consumable composition dispenser module external to a beverage container 110 (e.g. a fountain-type dispenser). For example, as shown in FIG. 1, the external consumable composition dispenser module 170 may be physically separated from the beverage container 110. The external consumable composition dispenser module 170 may include a mechanical apparatus which opens in response to a command from dispensing logic 125 so as to introduce a dose of the consumable composition into the beverage container 110. The beverage container 110 may be configured to receive a dose of the consumable composition via a communicating assembly whereby the beverage container 110 may be physically coupled to the external consumeable composition dispenser module 170 via a mutual conduit operably configured to allow the passage of the consumable composition between the external consumable composition dispenser module 170 and the beverage container 110.

At operation 506A, a dose of a pharmaceutical composition (e.g. an ACE inhibitor) may be dispensed according to a programmed dosing schedule.

At operation 508A, a dose of a neutraceutical composition (e.g. an herbal composition) may be dispensed according to a programmed dosing schedule.

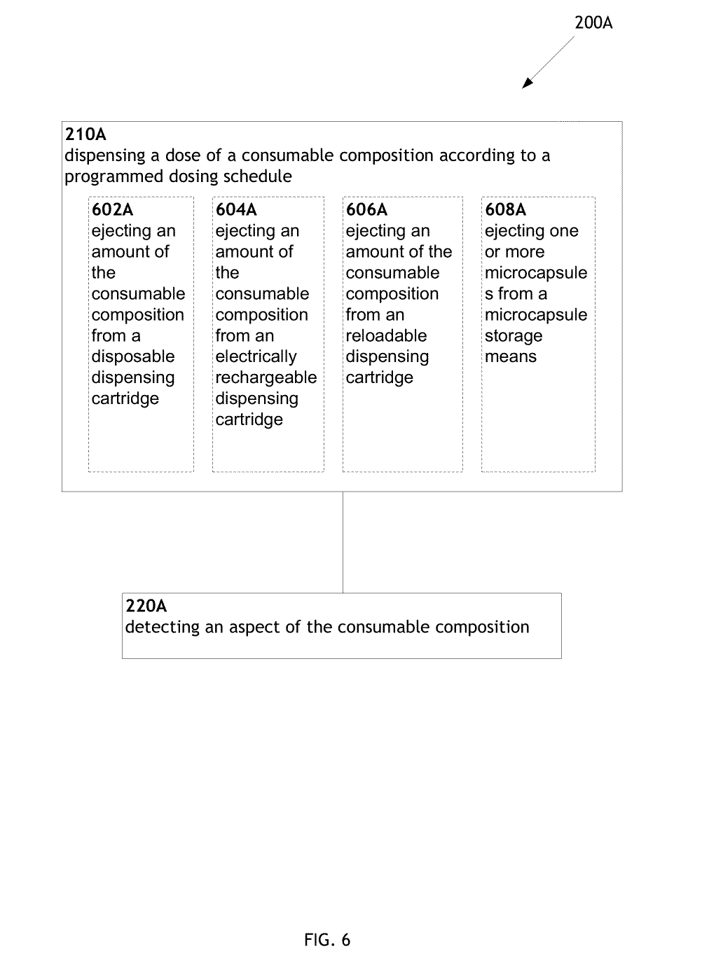

FIG. 6 illustrates alternative embodiments of the example operational flow 200A of FIG. 2. FIG. 6 illustrates example embodiments where the dispensing operation 210A may include at least one additional operation. Additional operations may include an operation 602A, an operation 604A, an operation 606A, and/or an operation 608A.

At operation 602A, an amount of the consumable composition may be ejected (e.g. displaced via pressurization) from a disposable (e.g. single or limited-use) dispensing cartridge. For example, as shown in FIG. 1, the integrated consumable composition dispenser module 160, and/or the external consumable composition dispenser module 170 may be configured to receive a disposable cartridge containing the consumable composition. Upon the dispensation of some or all of the supply of the consumable composition contained in the disposable cartridge, the cartridge may be removed from the integrated consumable composition dispenser module 160, and/or the external consumable composition dispenser module 170 and a replacement cartridge containing an additional supply of the consumable composition may be inserted.

At operation 604A, an amount of the consumable composition may be ejected from an electrically rechargeable dispensing cartridge (e.g. a cartridge including a lithium ion battery). For example, the consumable composition may be ejected from the dispensing cartridge by an electrical pump integrated either into the cartridge or into the integrated consumable composition dispenser module 160, and/or external consumable composition dispenser module 170. The cartridge containing the consumable composition may include a rechargeable battery so as to provide a renewable power source for the electrical pump.

At operation 606A, an amount of the consumable composition may be ejected from a reloadable dispensing cartridge (e.g. a user 190 may add an additional amount of consumable composition to the cartridge). For example, as shown in FIG. 1, the integrated consumable composition dispenser module 160, and/or the external consumable composition dispenser module 170 may be configured to receive a reloadable cartridge containing the consumable composition. Upon the dispensation of some or all of the supply of the consumable composition contained in the disposable cartridge, the cartridge may be removed from the integrated consumable composition dispenser module 160, and/or the external consumable composition dispenser module 170, an additional amount of the consumable composition may be loaded into the cartridge, and the original cartridge replaced into the integrated consumable composition dispenser module 160, and/or the external consumable composition dispenser module 170.

At operation 608A, one or more microcapsules may be ejected from a microcapsule storage module. For example, as shown in FIG. 1, the integrated consumable composition dispenser module 160 and/or the external consumable composition dispenser module may contain one or microcapsules (e.g. enteric drug coatings). The microcapsules may contain the consumable composition. The individual microcapsules may be configured such that the release of the consumable composition therefrom varies from microcapsule to microcapsule thereby providing a controlled release of the consumable composition across a given time period.

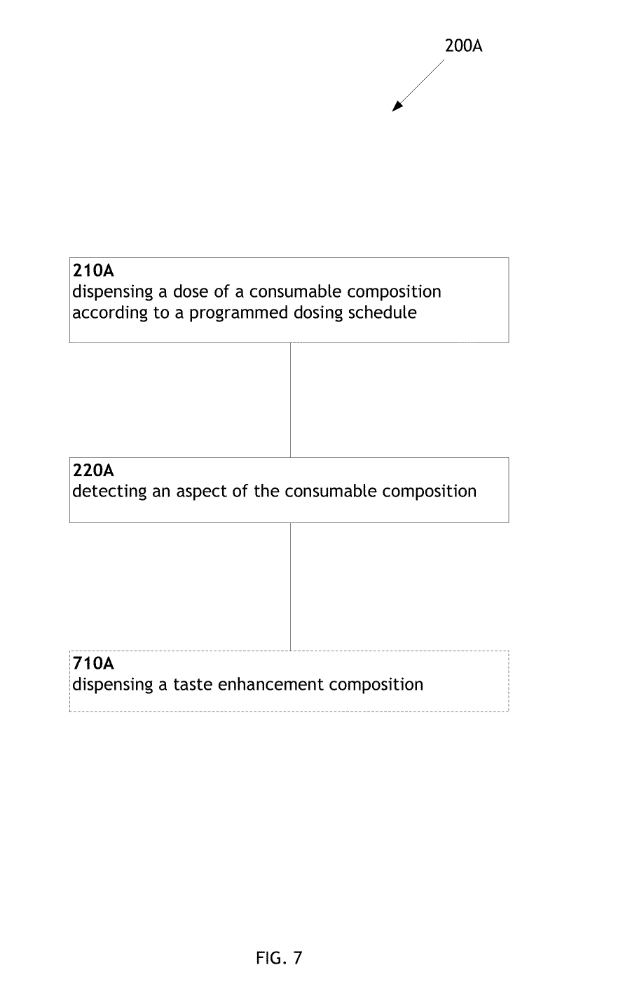

FIG. 7 illustrates example operations related to dispensing a dose of a consumable composition where the example operational flow 200A of FIG. 2 may include at least one additional operation. Additional operations may include an operation 710A.

At operation 710A, a taste enhancement composition (e.g. a fruit distilate) may be dispensed. For example, as shown in FIG. 1, the dispenser module 160 may dispense a taste enhancement. The taste enhancement may include an essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, fermentation product thereof, and the like.

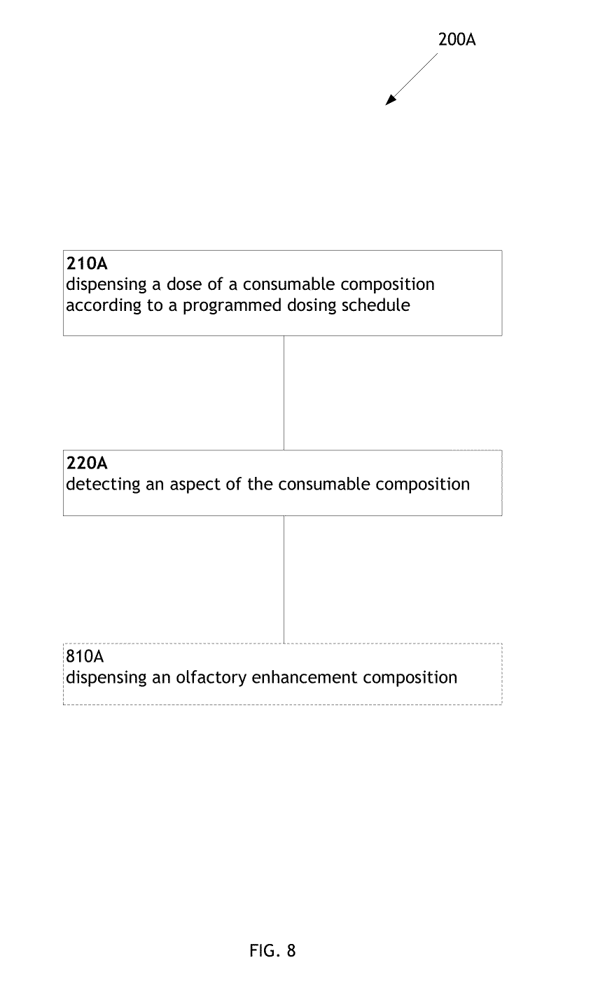

FIG. 8 illustrates an example embodiment where the example operational flow 200A of FIG. 2 may include at least one additional operation. Additional operations may include an operation 810A.

At operation 810A, an olfactory enhancement composition may be dispensed. For example, as shown in FIG. 1, the dispenser module may dispense an olfactory enhancement (e.g. ethyl proprionate). The olfactory enhancement may include diacetyl (butter), isoamyl acetate (banana), cinnamic aldehyde (cinnamon), ethyl propionate (fruit), limonene (orange) ethyl-(E,Z)-2,4-decadienoate (pear), allyl hexanoate (pineapple), ethyl maltol (sugar, cotton candy), methyl salicylate (wintergreen), benzaldehyde (bitter almond), and the like.

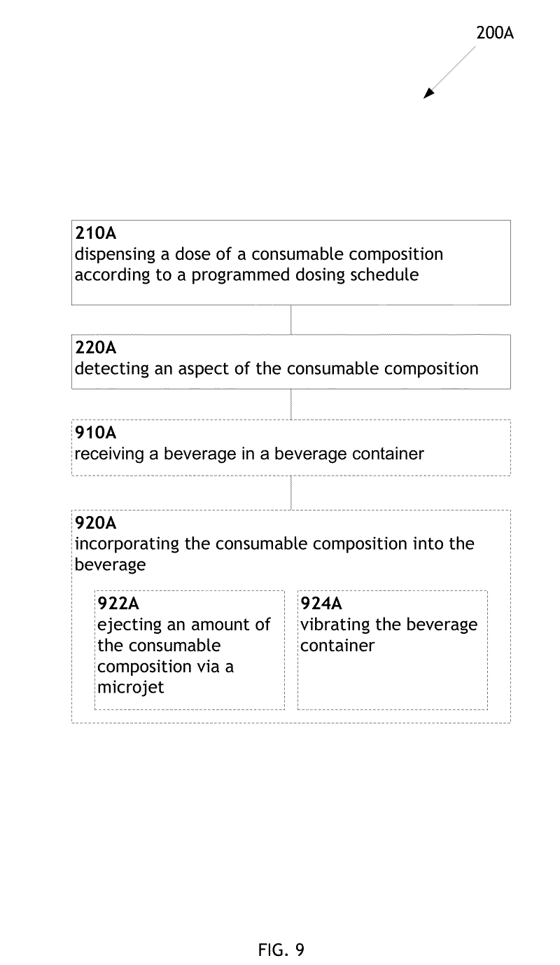

FIG. 9 illustrates an example embodiment where the example operational flow 200A of FIG. 2 may include at least one additional operation. Additional operations may include an operation 910A, an operation 920A, an operation 922A, and/or an operation 924A.

At operation 910A, a beverage may be received in a beverage container. For example, as shown in FIG. 1, the beverage container 110 may include any receptacle configured for retaining liquid or gel composition. The beverage container may include a cup, glass, mug, bowl, pitcher, jug, and the like. The beverage may include any composition which may be introduced and retained in a beverage container, including water, soda pop, coffee, juice, milk, tea and the like.

At operation 920A, the consumable composition may be incorporated (e.g. physically distributed) into the beverage. For example, as shown in FIG. 1, the integrated consumable composition dispenser module 160, and/or the external consumable composition dispenser module 170 may dispense the consumable composition such that it becomes mixed with or may dissolve in the beverage.

At operation 922A, an amount of the consumable composition may be ejected into the beverage container via a microjet (e.g. device having a small outlet orifice whereby a fluid may be dispensed at high velocity). For example, as shown in FIG. 1, the integrated consumable composition dispenser module 160, and/or the external consumable composition dispenser module 170 may comprise a microjet operably configured to dispense the consumable composition into the beverage such that the motion of the consumable composition may induce turbulence in the beverage contained in the beverage container, thereby mixing and/or dissolving the consumable composition in the beverage.

At the operation 924A, the beverage container may be vibrated. For example, as shown in FIG. 1, the beverage container 110 may include an asymmetrical rotating mass operably coupled to a motor. Upon application of power to the motor, the mass may be rotated such that it induces vibration in the beverage container 110. Such vibration may induce turbulence in the beverage contained in the beverage container 110, thereby mixing and/or dissolving the consumable composition in the beverage.

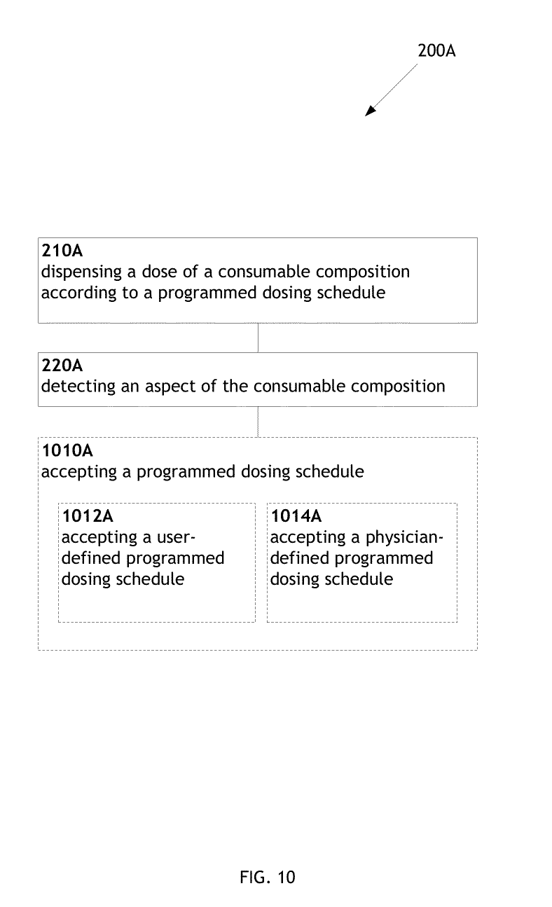

FIG. 10 illustrates an example embodiment where the example operational flow 200A of FIG. 2 may include at least one additional operation. Additional operations may include an operation 1010A, an operation 1012A, and/or an operation 1014A.

At operation 1010A, a programmed dosing schedule may be accepted (e.g. data representing a physician-prescribed medication regimine stored in an electronic medium may be processed). For example, as shown in FIG. 1, the dispensing logic 125 may accept data representing a programmed dosing schedule and may control dispensing of the consumable composition by the integrated consumable composition dispenser module 160, and/or the external consumable composition dispenser module 170 according to the programmed dosing schedule.

At operation 1012A, a user-defined (e.g. a user entering dosing related data via a key-pad or touchscreen) programmed dosing schedule may be accepted. For example, as shown in FIG. 1, a user 190 may provide a user-defined programmed dosing schedule via a manual input module 146 of user interface 140. The user-defined programmed dosing schedule may be maintained in memory 126. Dispensing logic 125 may accept a user-defined programmed dosing schedule from the memory 126 and may control dispensing of the consumable composition by the integrated consumable composition dispenser module 160, and/or the external consumable composition dispenser module 170 according to the user-defined programmed dosing schedule.

At operation 1014A, a physician-defined programmed dosing schedule (e.g. a physician entering dosing data into a remote electronic database) may be accepted. For example, as shown in FIG. 1, a physician may access a monitoring system 180 and may provide a physician-defined programmed dosing schedule. The monitoring system 180 may transmit the physician-defined programmed dosing schedule to the system 100 via a communications module 130. The physician-defined programmed dosing schedule may be maintained in memory 126. Dispensing logic 125 may accept a physician-defined programmed dosing schedule from the memory 126 and may control dispensing of the consumable composition by the integrated consumable composition dispenser module 160, and/or the external consumable composition dispenser module 170 according to the physician-defined programmed dosing schedule.

Monitoring system 180 may also transmit a notification (e.g. a notification that a programmed dosing schedule has been transmitted to the system 100) to a communications device 181 (e.g. a cell phone, satellite phone, Blackberry®, and/or land-line phone), e-mail system 182 (e.g. an IMAP, POP3, SMTP, and/or HTTP e-mail server having an e-mail account associated with a user 190), text messaging system 183 (e.g. SMS system in GSM) and/or a computing system 184 (e.g. a personal digital assistant (PDA), personal computer, laptop, music player and/or gaming device).

### Application Ser. No. 12/001,061 (0107A-002-005B1-000000)

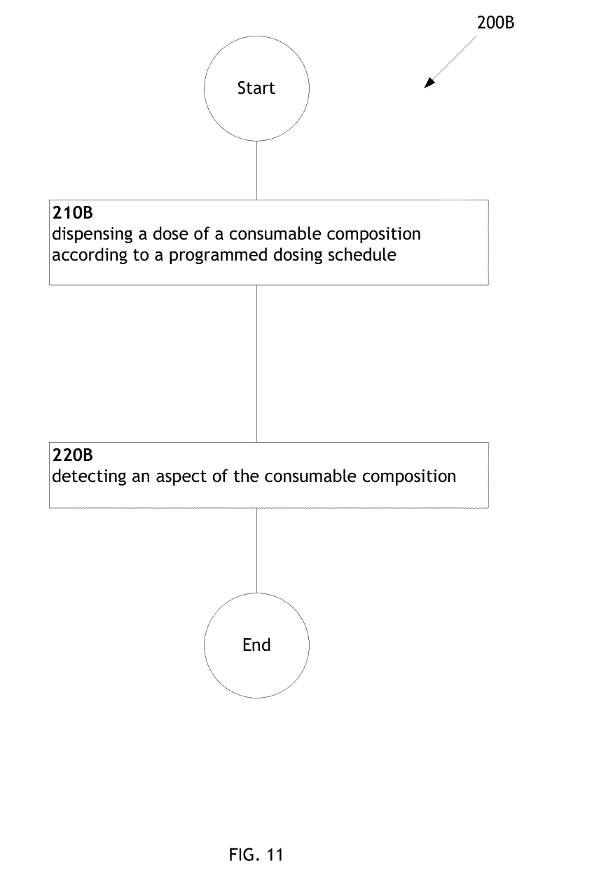

FIG. 11 illustrates an operational flow 200B representing example operations related to programmed dispensing of consumable compositions. In FIG. 11 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

At operation 210B, dispensing a first dose of a consumable composition according to a programmed dosing schedule may occur (e.g. distributing a pharmaceutical composition in accordance with a user or physician-defined regimen). For example, as shown in FIG. 1, integrated consumable composition dispenser module 160, and or external consumable composition dispenser module 170 may distribute doses (e.g. 30 mg) of a consumable composition (e.g. an anti-depressant, such as Paroxotene) into a beverage container 110 (e.g. a cup).

At operation 220B, an aspect of the consumable composition may be detected. For example, as shown in FIG. 1, an aspect (e.g. an amount dispensed) of the consumable composition may be detected by detection logic 121 receiving data from sensing logic 124 operably coupled to a sensor module 150 (e.g. a capacitive concentration sensor), communications logic 122 operably coupled to a communications module 130 (e.g. a wireless transceiver), user interface logic 123 operably coupled to a user interface 140 (e.g. a keypad or touchscreen), dispensing logic 125 operably coupled to an integrated consumable composition dispenser module 160, and/or an external consumable composition dispenser module 170 (e.g. an actuated release mechanism), and/or sterilization logic 188 operably coupled to a sterilization module 186, 187 (e.g. an ultra-violet radiation source).

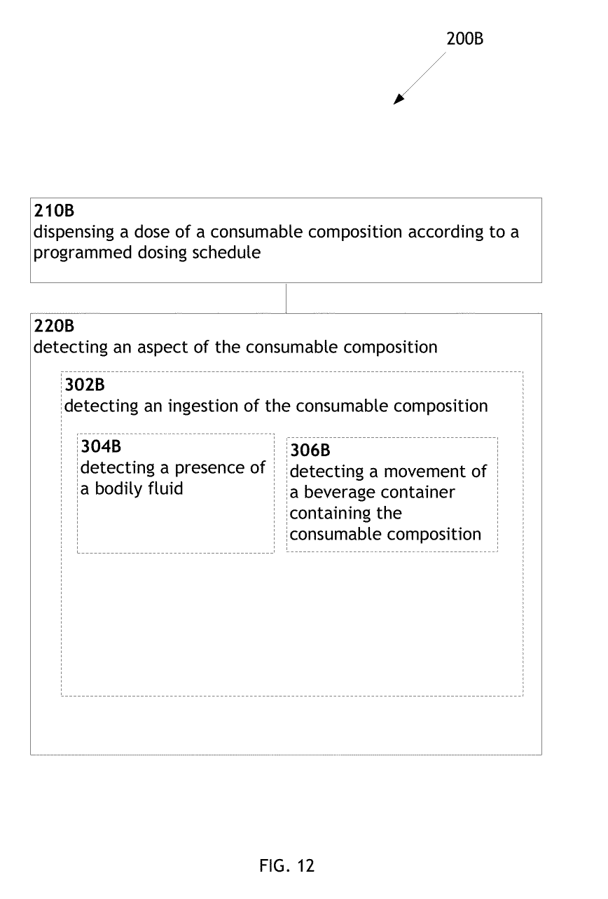

FIG. 12 illustrates alternative embodiments of the example operational flow 200B of FIG. 11. FIG. 12 illustrates example embodiments where the detecting operation 302B may include at least one additional operation. Additional operations may include an operation 304B, and/or an operation 306B.

At operation 302B, detecting at least one ingestion of the consumable composition may occur (e.g. a user has complied with a programmed dosing schedule for the consumable composition by swallowing the consumable composition). For example, as shown in FIG. 1, the sensing logic 124 may be operably coupled to sensor module 150. Upon ingestion of a consumable composition, the sensor module 150 may provide a signal to sensing logic 124 that ingestion has occurred.

Further, at the operation 304B, detecting a presence of a bodily fluid (e.g. biometric detection) may occur. For example, as shown in FIG. 1, the sensor module 150 may include a biometric sensor which senses the presence of saliva, perspiration, sebum and the like, either on the surface of the beverage container 110 or as a component of the contents therein.

At the operation 306B, detecting a movement of a beverage container containing the consumable composition (e.g. accelerometric detection of a user-initiated movement) may occur. For example, as shown in FIG. 1, the sensor module 150 may include an accelerometer, inertial motion sensor and the like, which may sense the movement of the beverage container 110.

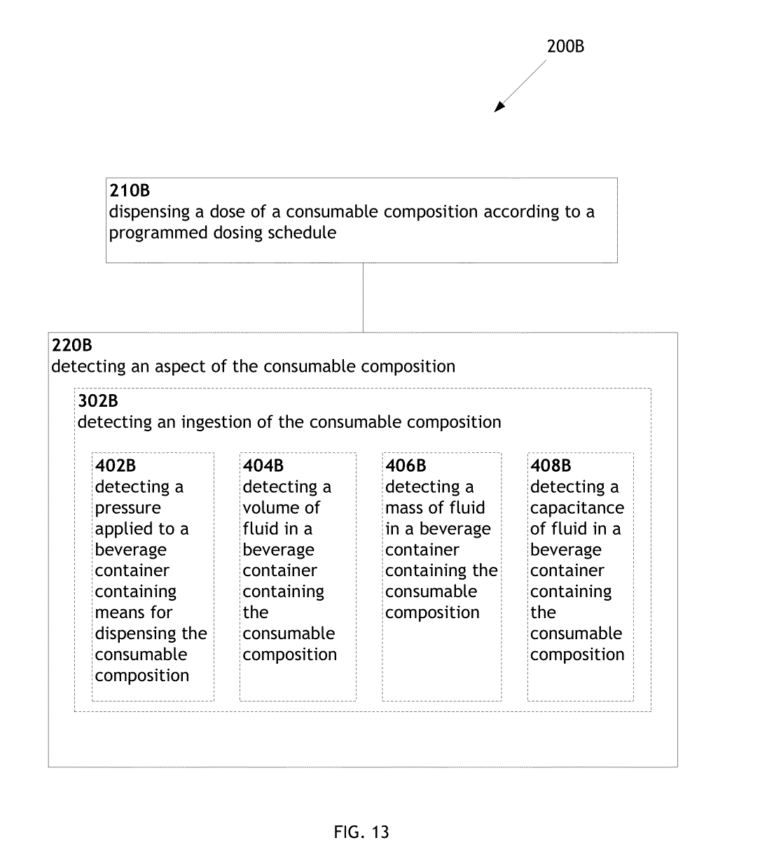

FIG. 13 illustrates alternative embodiments of the example operational flow 200B of FIG. 11. FIG. 13 illustrates example embodiments where the detecting operation 302B may include at least one additional operation. Additional operations may include an operation 402B, an operation 404B, an operation 406B, and/or an operation 408B.

At the operation 402B, detecting a pressure applied to a beverage container containing the consumable composition (e.g. fiber optic pressure detection of a user grasping the beverage container) may occur. For example, as shown in FIG. 1, the sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, and the like which senses a pressure applied to the beverage container 110.

At the operation 404B, detecting a volume of fluid in a beverage container containing the consumable composition may occur (e.g. optical detection). For example, as shown in FIG. 1, the sensor module may include an optical or mechanical sensor which may sense a volume of the fluid in the beverage container 110.

At the operation 406B, detecting a mass of fluid in a beverage container containing the consumable composition may occur (e.g. mechanical deflection pressure detection). For example, as shown in FIG. 1, the sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, and the like which senses a mass of fluid contained in the beverage container 110.

At the operation 408, detecting a capacitance of fluid in a beverage container containing the consumable composition may occur (e.g. chemical field effect transistor detection). For example, as shown in FIG. 1, the sensor module 150 may include a capacitive concentration sensor which may sense a concentration of the consumable composition present in the beverage container 110.

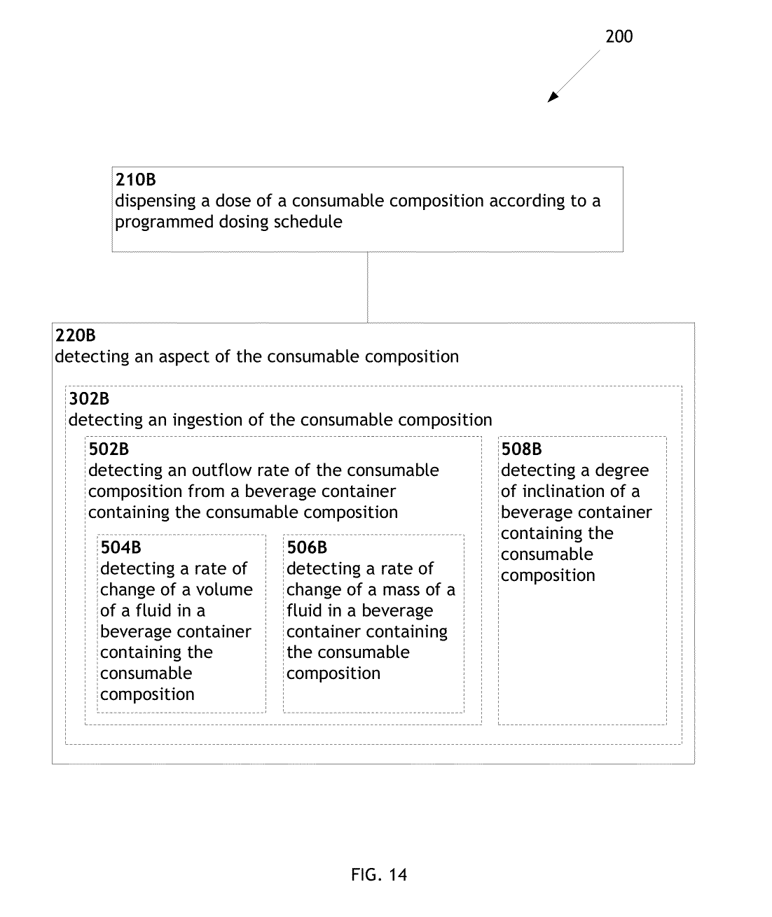

FIG. 14 illustrates alternative embodiments of the example operational flow 200B of FIG. 11. FIG. 14 illustrates example embodiments where the detecting operation 302B may include at least one additional operation. Additional operations may include an operation 502B, an operation 504B, an operation 506B, an operation 508B, and/or an operation 510B.

At the operation 502B, detecting an outflow rate of the consumable composition from a beverage container containing the consumable composition may occur (e.g. a rate at which a physical, chemical, electrical, or optical property changes). For example, as shown in FIG. 1, the sensor module 150 may include a fiber optic pressure/outflow sensor, mechanical deflection pressure/outflow sensor, strain gauge pressure/outflow sensor, piezoresistive pressure/outflow sensor, microelectromechanical (MEMS) pressure/outflow sensor, variable capacitance pressure/outflow sensor, flowmeters, and the like which sense an outflow from the beverage container 110 containing the consumable composition. Such an outflow may indicate a proper ingestion or an improper disposal of the consumable composition, depending on the outflow rate. For example, proper ingestion might be indicated by an outflow rate indicative of normal drinking, while improper disposal might be indicated by an outflow rate indicative of dumping the contents of the cup by upending the cup.

Further, at the operation 504B, detecting a rate of change of a volume of a fluid in a beverage container containing the consumable composition may occur (e.g. a magnetic flowmeter measuring volume outflow from the beverage container over time). Further, at the operation 506B, detecting a rate of change of a mass of a fluid in a beverage container containing the consumable composition may occur (e.g. a piezoresistive pressure sensor measuring the change in the mass present in a beverage container over time). Further, at the operation 508B, detecting a rate of change of a capacitance of a fluid in a beverage container containing the consumable composition may occur (e.g. a capacitive sensor measuring the change of capacitance of the fluid in the beverage container over time).

At the operation 510B, detecting a degree of inclination of a beverage container containing the consumable composition may occur (e.g. a mechanism may detect that a user is rotating the beverage container by a certain degree relative to its designed resting position so as to ingest its contents). For example, as shown in FIG. 1, the sensor module 150 may include an inclinometer and the like. The degree of incline of the beverage container 110 may indicate a proper ingestion or an improper disposal of the consumable composition, depending on the degree of incline.

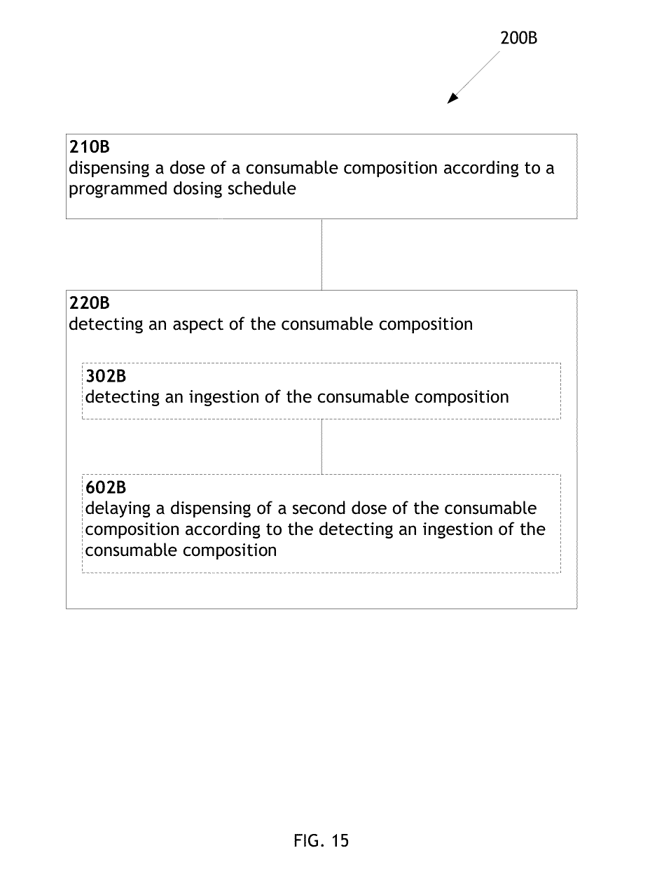

FIG. 15 illustrates alternative embodiments of the example operational flow 200B of FIG. 11. FIG. 15 illustrates example embodiments where the operational flow 200B may include at least one additional operation. Additional operations may include a delaying operation 602B.

At the operation 602B, delaying a dispensing of a second dose of the consumable composition according to the detecting the at least one ingestion of the consumable composition may occur (e.g. a mechanism delaying dispensing until the first dose will have been metabolized). For example, as shown in FIG. 1, the sensing logic 124 may provide data from the sensor module 150 regarding an amount of consumable composition ingested to the detecting logic 121. The dispensing logic 125 may delay a dispensation of a second dose of the consumable composition by the integrated consumable composition dispenser module 160, and/or the external consumable composition dispenser module 170 until the detecting logic 121 indicates of an ingestion of a previously dispensed dose of the consumable composition.

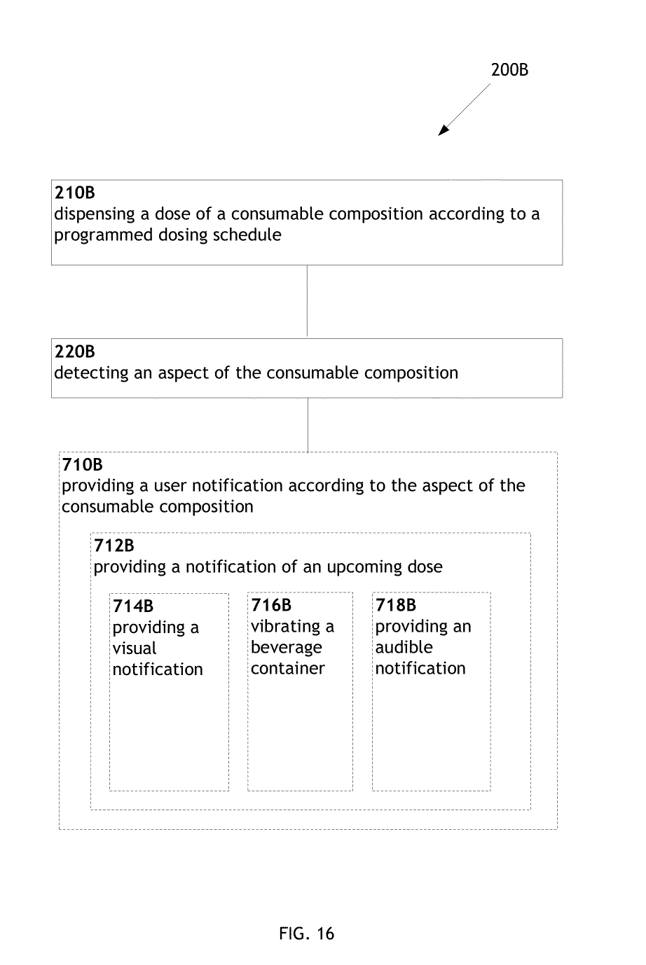

FIG. 16 illustrates example embodiments where the operational flow 200B of FIG. 11 may include at least one additional operation. Additional operations may include an operation 710B.

At operation 710B, providing a user notification according to the aspect of the consumable composition may occur (e.g. a notification of a dispensed dose of a consumable composition according to an amount of the consumable composition dispensed). For example, as shown in FIG. 1, the user interface logic 123 may cause the notification module 142 of the user interface 140 to provide a notification that an amount of consumable composition is about to be dispensed. The notification may include the identity of the consumable composition (e.g., a trade name and/or chemical composition of the consumable composition) and the timing of the dispensation (e.g. “20 minutes ago”).

FIG. 16 further illustrates example embodiments where the user notification operation 710B may include at least one additional operation. Additional operations may include an operation 712B.

At the operation 712B, providing a notification of an upcoming dose may occur (e.g. a dose scheduled according to a programmed dosing schedule will be dispensed at a given time). For example, as shown in FIG. 1, the user interface logic 140 may cause the notification module 142 of the user interface 140 to provide a notification to the user 190.

FIG. 16 further illustrates example embodiments where the upcoming dose notification operation 712B may include at least one additional operation. Additional operations may include an operation 714B, an operation 716B, and/or an operation 718B.

At the operation 714B, providing a visual notification may occur (e.g. a graphical notice on a display screen). For example, as shown in FIG. 1, the notification module 142 of the user interface 140 may include a flashing LED, LCD display screen, and the like.

At the operation 716B, vibrating a beverage container may occur (e.g. movement of an asymmetrical mass). For example, as shown in FIG. 1, the notification module 142 may include an asymmetrical rotating mass operably coupled to a motor. Upon application of power to the motor, the mass may be rotated such that it induces vibration in the beverage container 110.

At the operation 718B, providing an audible notification may occur (e.g. a simple beep or voice command). For example, as shown in FIG. 1, the notification module 142 of the user interface 140 may include a speaker assembly, and the like.

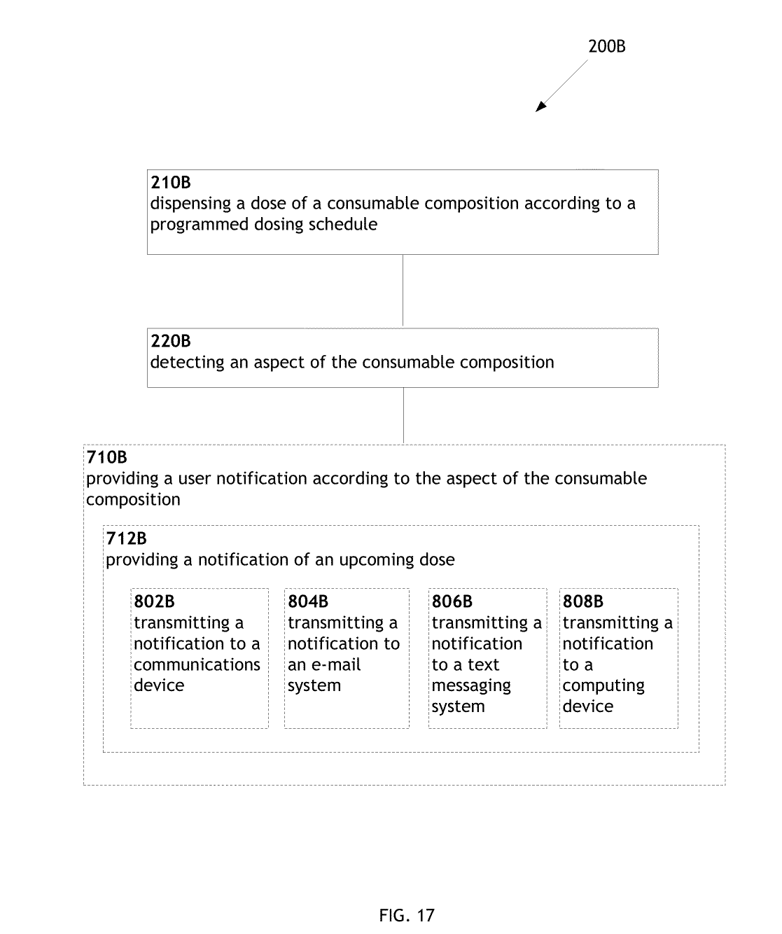

FIG. 17 illustrates alternative embodiments of the example operational flow 200B of FIG. 16. FIG. 17 illustrates example embodiments where the upcoming dose notification operation 712B may include at least one additional operation. Additional operations may include an operation 802B, an operation 804B, an operation 806B, and/or an operation 808B.

At the operation 802B, transmitting a notification to a communications device may occur (e.g. placing an automated call to a user's home phone). For example, as shown in FIG. 1, the communications module 130 may transmit a notification to a monitoring system 180 linked to a communications device 181. The communications device 181 may include a cell phone, satellite phone, Blackberry®, land-line phone, and the like.

At the operation 804B, transmitting a notification to an e-mail system may occur (e.g. an automated e-mail notice to a user's e-mail account). For example, as shown in FIG. 1, the communications module 130 may transmit a notification to a monitoring system 180 linked to an e-mail system 182 including an IMAP, POP3, SMTP, and/or HTTP e-mail server having an e-mail account associated with a user 190.

At the operation 806B, transmitting a notification to a text messaging system may occur (e.g. an automated text message to a user's cell phone). For example, as shown in FIG. 1, the communications module 130 may transmit a notification to a monitoring system 180 linked to a text messaging system 183, such as a SMS system in GSM.

At the operation 808B, transmitting a notification to a computing device may occur (e.g. an automated instant message to a user's computer). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like capable of receiving instant messages from IM providers such as Microsoft®.

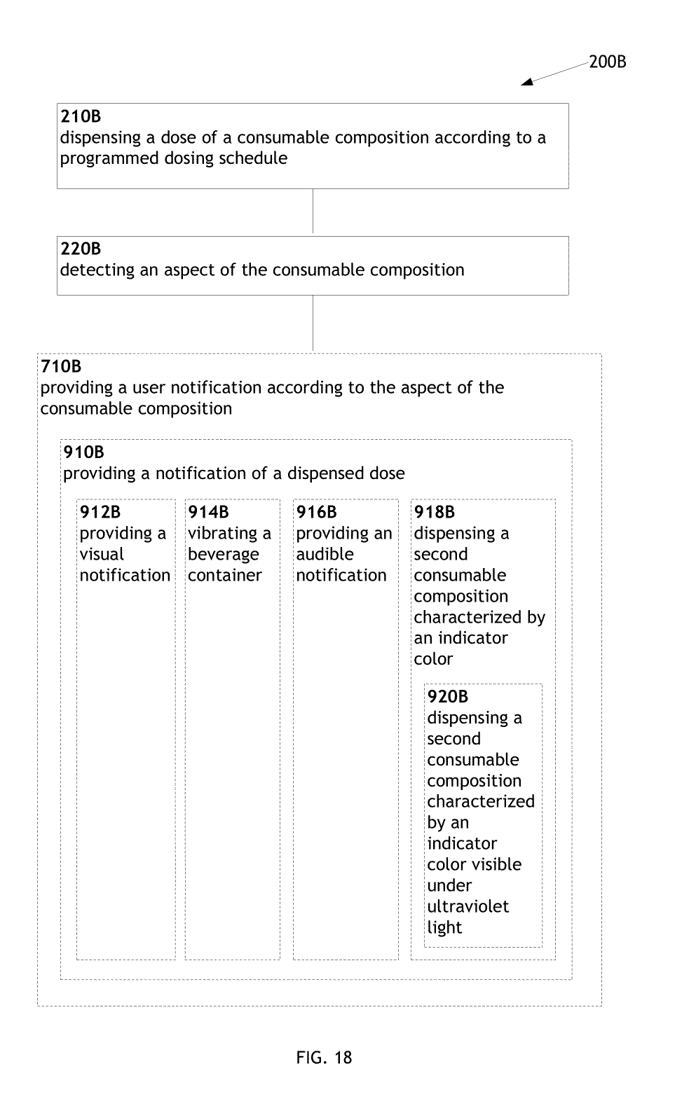

FIG. 18 illustrates alternative embodiments of example operational flow 200B of FIG. 16. FIG. 18 illustrates an example embodiment where the user notification operation 710B may include at least one additional operation. Additional operations may include an operation 910B.

At operation 910B, providing a notification of a dispensed dose may occur (e.g. a dose scheduled according to a programmed dosing schedule has been dispensed at a given time). For example, as shown in FIG. 1, the user interface logic 123 may cause the notification module 142 of the user interface 140 to provide a notification that an amount of the consumable composition has been dispensed. The notification may include the identity of the consumable composition and the timing of the dispensation.

FIG. 18 further illustrates example embodiments where the dispensed dose notification operation 910B may include at least one additional operation. Additional operations may include an operation 912B, an operation 914B, an operation 916B, an operation 918B, and/or an operation 920B.

At the operation 912B, providing a visual notification may occur (e.g. an image of a beverage cup containing a consumable composition displayed on an LCoS display). For example, as shown in FIG. 1, the notification module 142 of the user interface 140 may include a flashing LED, an LCD or LCoS display screen, and the like.

At the operation 914B, vibrating a beverage container may occur (e.g. periodic movement of an oscillating mass). For example, as shown in FIG. 1, the beverage container 110 may include an asymmetrical rotating mass operably coupled to a motor. Upon application of power to the motor, the mass may be rotated such that it induces vibration in the beverage container 110.

At the operation 916B, providing an audible notification may occur (e.g. a vocal notification). For example, as shown in FIG. 1, the notification module 142 of the user interface 140 may include a speaker assembly, and the like, over which a notification may be transmitted. In some instances, the notification includes the dose dispensed and the material dispensed (e.g., “100 mg of Viagra was just dispensed into your cup”).

At the operation 918B, dispensing a second consumable composition characterized by an indicator color may occur (e.g. red, blue or green). For example, as shown in FIG. 1, the dispensing logic 125 may cause the integrated consumable composition dispenser module 160 and/or the external consumable composition dispenser module 170 to dispense a second consumable composition (e.g., Allura Red AC food coloring [2-naphthalenesulfonic acid]) which has a visible indicator color (e.g., red) different from the consumable composition (e.g., a white analgesic, such as acetylsalicylic acid). Further, at the operation 920, dispensing a second consumable composition characterized by an indicator color visible under ultraviolet light may occur (e.g. tonic water comprising quinine). Similarly, compositions visible under other electromagnetic radiation wavelength ranges, such as infrared, may be used.

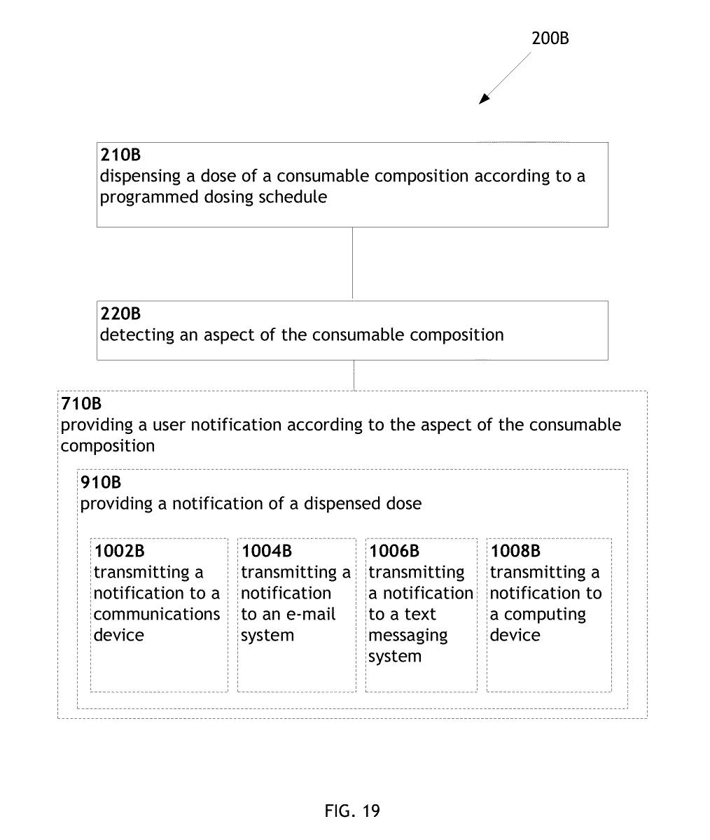

FIG. 19 illustrates alternative embodiments of the example operational flow 200B of FIG. 18. FIG. 19 illustrates example embodiments where the dispensed dose notification operation 910B may include at least one additional operation. Additional operations may include an operation 1002B, an operation 1004B, an operation 1006B, and/or an operation 1008B.

At the operation 1002B, transmitting a notification to a communications device may occur (e.g., sending a text message to a user's cell phone). For example, as shown in FIG. 1, the communications module 130 may transmit a notification to a monitoring system 180 linked to a communications device 181. The communications device 181 may include a cell phone, Blackberry®, land-line phone, and the like.

At the operation 1004B, transmitting a notification to an e-mail system may occur (e.g. sending an e-mail to an IMAP, POP3, SMTP, and/or HTTP e-mail server having an e-mail account associated with a user 190). For example, as shown in FIG. 1, the communications module 130 may transmit a notification to a monitoring system 180 linked to an e-mail system 182.

At the operation 1006, transmitting a notification to a text messaging system may occur (e.g. sending text message to an SMS system in GSM). For example, as shown in FIG. 1, the communications module 130 may transmit a notification to a monitoring system 180 linked to a text messaging system 183.

At the operation 1008B, transmitting a notification to a computing device may occur (e.g. sending an instant message to a personal computer). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like.

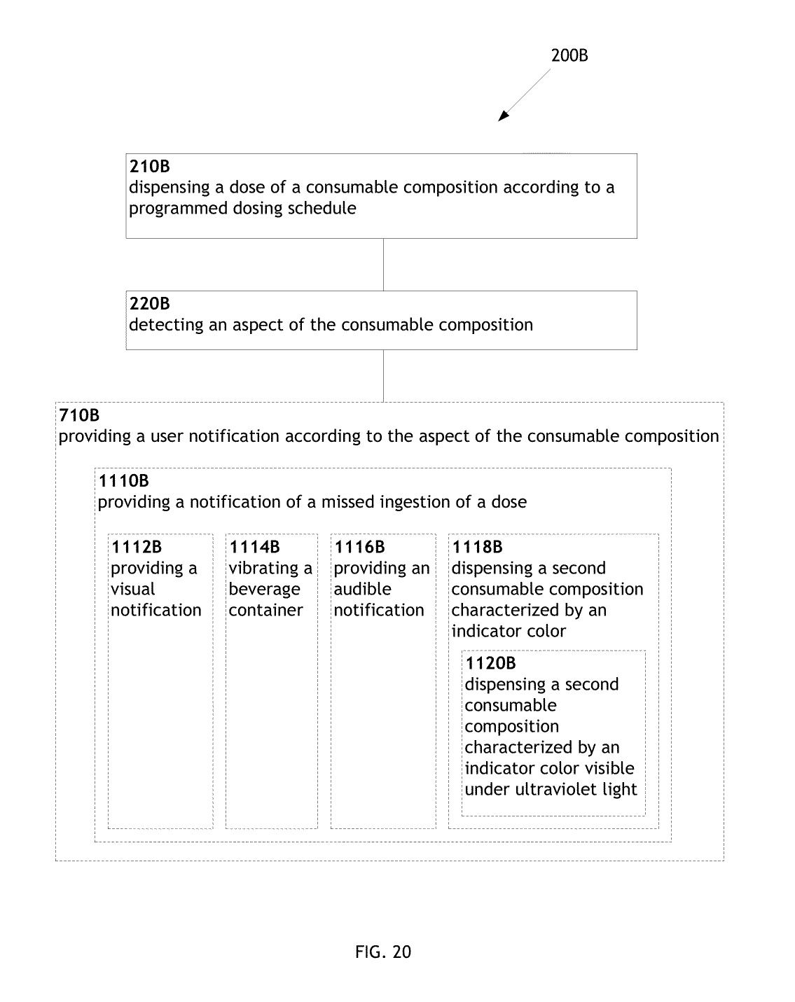

FIG. 20 illustrates alternative embodiments of example operational flow 200B of FIG. 16. FIG. 20 illustrates an example embodiment where the user notification operation 710B may include at least one additional operation. Additional operations may include an operation 1110B.

At operation 1110B, providing a notification of a missed ingestion of a dose may occur (e.g. a dose dispensed according to a programmed dosing schedule has not been ingested). For example, as shown in FIG. 1, the user interface logic 123 may cause the notification module 142 of the user interface 140 to provide a notification that ingestion of the consumable composition has been missed. The notification may include the identity of the consumable composition and the timing of the dispensation (e.g., a dose of Percoset was dispensed at 3:00 pm).

FIG. 20 further illustrates example embodiments where the dispensed dose notification operation 1110B may include at least one additional operation. Additional operations may include an operation 1112B, an operation 1114B, an operation 1116B, an operation 1118B, and/or an operation 1120B.

At the operation 1112B, providing a visual notification may occur (e.g. an LED may change colors from green to red). For example, as shown in FIG. 1, the notification module 142 of the user interface 140 may include a flashing LED, LCD display screen, and the like.

At the operation 1114B, vibrating a beverage container may occur (e.g. rotation of an asymmetrical mass). For example, as shown in FIG. 1, the beverage container 110 may include an asymmetrical rotating mass operably coupled to a motor. Upon application of power to the motor, the mass may be rotated such that it induces vibration in the beverage container 110.

At the operation 1116B, providing an audible notification may occur (e.g. an audio broadcast of a ring tone). For example, as shown in FIG. 1, the notification module 142 of the user interface 140 may include a speaker assembly, and the like.

At the operation 1118B, dispensing a second consumable composition characterized by an indicator color may occur. For example, as shown in FIG. 1, the dispensing logic 125 may cause the integrated consumable composition dispenser module 160 and/or the external consumable composition dispenser module 170 to dispense a second consumable composition (e.g., Sunset Yellow FCF food coloring [disodium salt of 6-hydroxy-5-[(4-sulfophenyl)azo]-2-naphthalenesulfonic acid]) separate from the consumable composition (e.g., an antihistamine) which has a visible indicator color (e.g. yellow) different color than the consumable composition (e.g. white). Further, at the operation 1120, dispensing a second consumable composition characterized by an indicator color visible under ultraviolet light may occur (e.g. a solution containing Vitamin B-12).

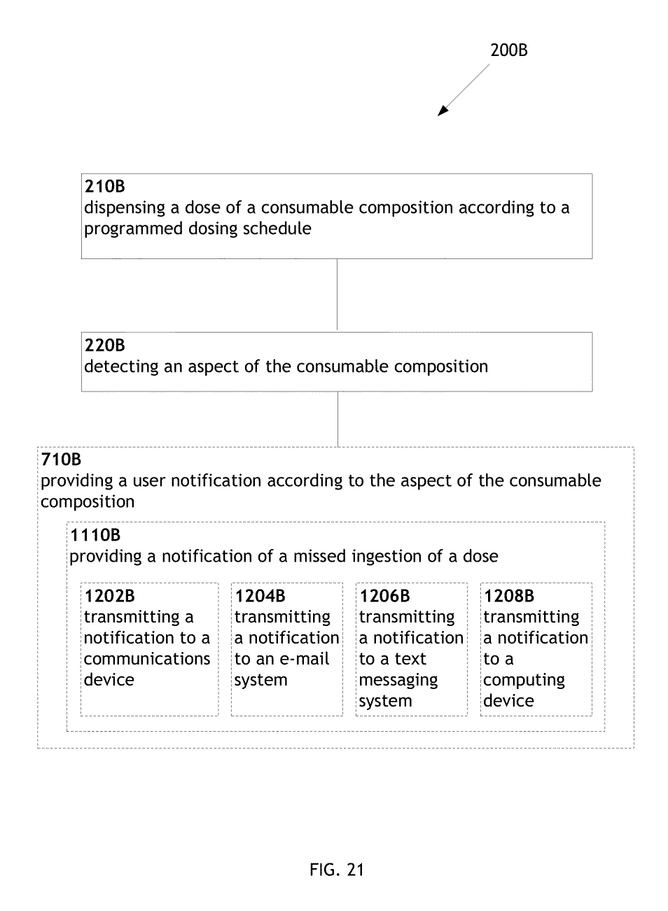

FIG. 21 illustrates alternative embodiments of the example operational flow 200B of FIG. 20. FIG. 21 illustrates example embodiments where the missed dose ingestion notification operation 1110B may include at least one additional operation. Additional operations may include an operation 1202B, an operation 1204B, an operation 1206B, and/or an operation 1208B.

At the operation 1202B, transmitting a notification to a communications device may occur (e.g. sending an instant message to a Blackberry® device). For example, as shown in FIG. 1, the communications module 130 may transmit a notification to a monitoring system 180 linked to a communications device 181. The communications device 181 may include a cell phone, Blackberry®, land-line phone, and the like.

At the operation 1204B, transmitting a notification to an e-mail system may occur (e.g. an e-mail to an IMAP, POP3, SMTP, and/or HTTP e-mail server having an e-mail account associated with a user 190). For example, as shown in FIG. 1, the communications module 130 may transmit a notification to a monitoring system 180 linked to an e-mail system 182.

At the operation 1206B, transmitting a notification to a text messaging system may occur (e.g. text message to an SMS system in GSM). For example, as shown in FIG. 1, the communications module 130 may transmit a notification to a monitoring system 180 linked to a text messaging system 183.

At the operation 1208B, transmitting a notification to a computing device may occur (e.g., an instant message via an online gaming system, such as the Xbox Live® system marketed by the Microsoft® Corporation). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like.

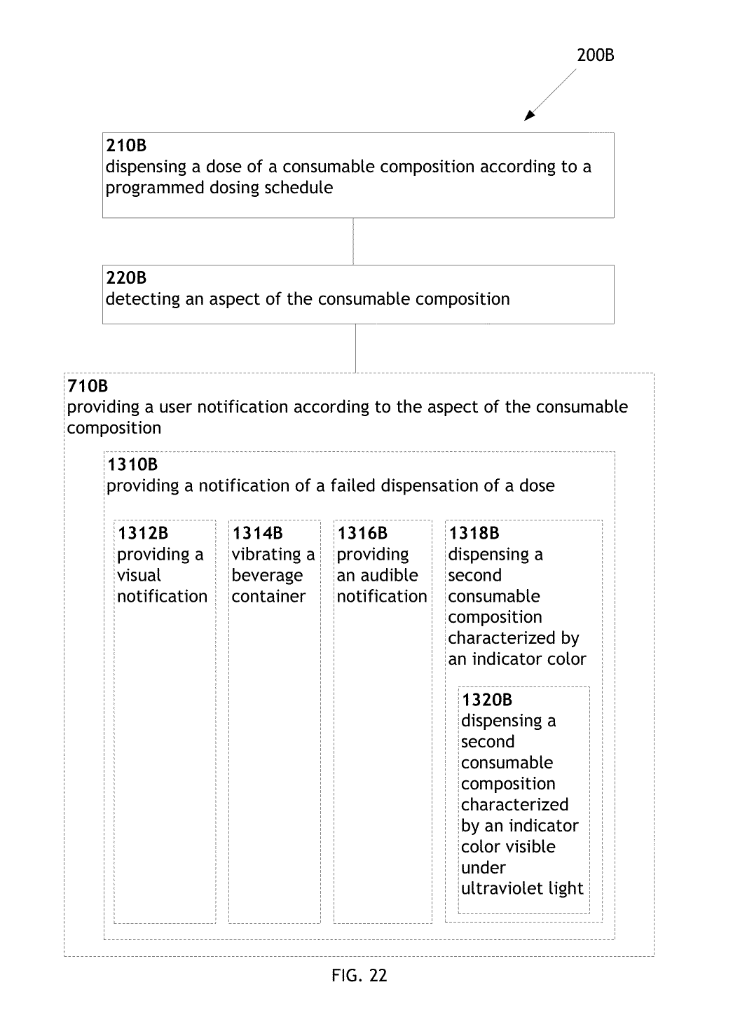

FIG. 22 illustrates alternative embodiments of example operational flow 200 of FIG. 16. FIG. 22 illustrates an example embodiment where the user notification operation 710B may include at least one additional operation. Additional operations may include an operation 1310B.

At operation 1310B, providing a notification of a failed dispensation of a dose may occur (e.g. a dose scheduled to have been dispensed according to a programmed dosing schedule has not been dispensed). For example, as shown in FIG. 1, the user interface logic 123 may cause the notification module 142 of the user interface 140 to provide a notification that an amount of the consumable composition has failed to dispense (e.g., an audio notice stating “A dispensation of your Vicodin has failed.”) The notification may include the identity of the consumable composition and the timing of the dispensation.

FIG. 22 further illustrates example embodiments where the failed dispensation of a dose notification operation 1310B may include at least one additional operation. Additional operations may include an operation 1312B, an operation 1314B, an operation 1316B, an operation 1318B, and/or an operation 1320B.

At the operation 1312B, providing a visual notification may occur (e.g. a textual display on an LCD display). For example, as shown in FIG. 1, the notification module 142 of the user interface 140 may include a flashing LED, LCD display screen, and the like.

At the operation 1314B, vibrating a beverage container may occur (e.g. a spring-loaded mass may be released). For example, as shown in FIG. 1, the beverage container 110 may include an asymmetrical rotating mass operably coupled to a motor. Upon application of power to the motor, the mass may be rotated such that it induces vibration in the beverage container 110.

At the operation 1316B, providing an audible notification may occur (e.g. the mechanical ringing of a bell). For example, as shown in FIG. 1, the notification module 142 of the user interface 140 may include a speaker assembly, and the like.

At the operation 1318B, dispensing a second consumable composition characterized by an indicator color may occur. For example, as shown in FIG. 1, the dispensing logic 125 may cause the integrated consumable composition dispenser module 160 and/or the external consumable composition dispenser module 170 to dispense a second consumable composition (e.g., Brilliant Blue FCF) separate from the consumable composition (e.g., riboflavin) which has a visible indicator color (e.g., blue) distinct from that of the consumable composition (e.g. yellow). Further, at the operation 1320, dispensing a second consumable composition characterized by an indicator color visible under ultraviolet light may occur (e.g., chlorophyll extract).

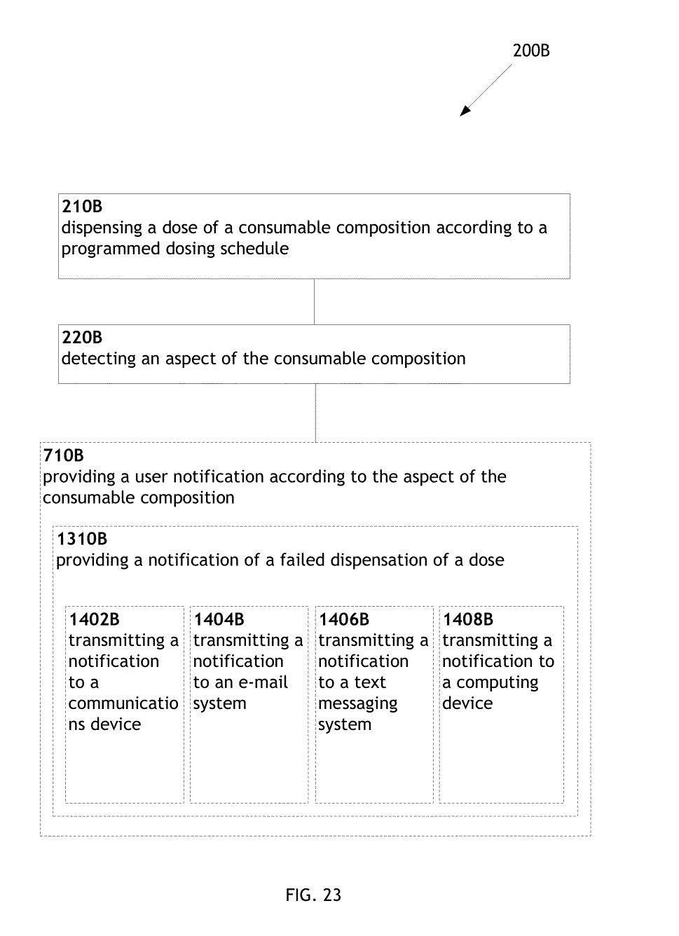

FIG. 23 illustrates alternative embodiments of the example operational flow 200 of FIG. 22. FIG. 23 illustrates example embodiments where the failed dispensation of a dose notification operation 1310B may include at least one additional operation. Additional operations may include an operation 1402B, an operation 1404B, an operation 1406B, and/or an operation 1408B.

At the operation 1402B, transmitting a notification to a communications device may occur (e.g., an automated voicemail sent to a cell phone and/or land line phone). For example, as shown in FIG. 1, the communications module 130 may transmit a notification to a monitoring system 180 linked to a communications device 181. The communications device 181 may include a cell phone, Blackberry®, land-line phone, and the like.

At the operation 1404B, transmitting a notification to an e-mail system may occur (e.g. an e-mail to an IMAP, POP3, SMTP, and/or HTTP e-mail server having an e-mail account associated with a user 190). For example, as shown in FIG. 1, the communications module 130 may transmit a notification to a monitoring system 180 linked to an e-mail system 182.

At the operation 1406B, transmitting a notification to a text messaging system may occur (e.g. text message to an SMS system in GSM). For example, as shown in FIG. 1, the communications module 130 may transmit a notification to a monitoring system 180 linked to a text messaging system 183.

At the operation 1408B, transmitting a notification to a computing device may occur (e.g., an instant message to a music player via a music download service, such as the iTunes® service marketed by Apple® Inc.). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like.

### Application Ser. No. 12/001,063 (0107A-002-005B2-000000)

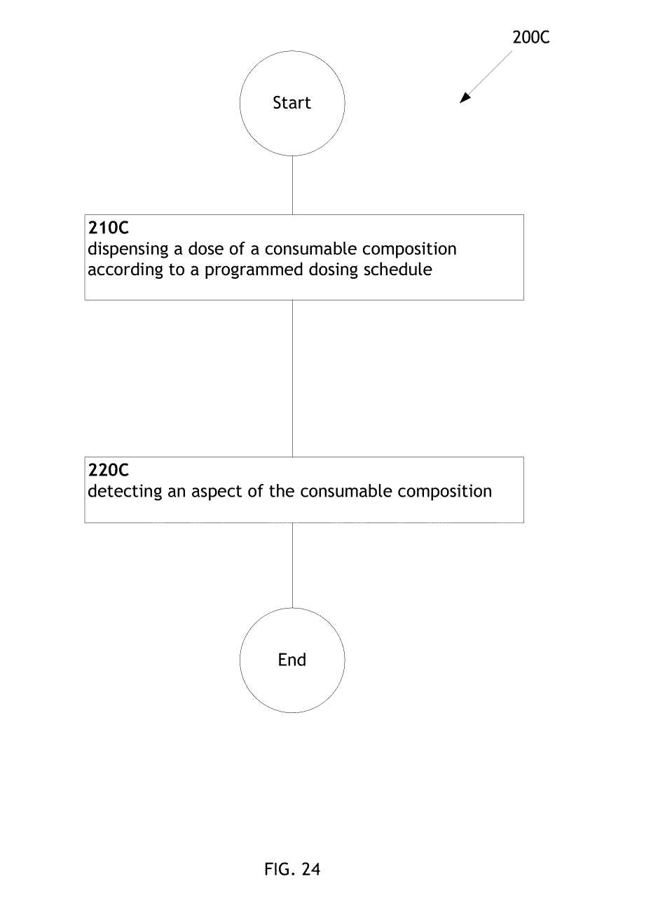

FIG. 24 illustrates an operational flow 200C representing example operations related to programmed dispensing of consumable compositions. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200C moves to a dispensing operation 210C, where dispensing a first dose of a consumable composition according to a programmed dosing schedule may occur (e.g. distributing a pharmaceutical composition in accordance with a user or physician-defined regimen). For example, as shown in FIG. 1, integrated consumable composition dispenser module 160, and or external consumable composition dispenser module 170 may distribute doses (e.g. 30 mg) of a consumable composition (e.g. an anti-depressant, such as Paroxotene) into a beverage container 110 (e.g. a cup).

At operation 220C, an aspect of the consumable composition may be detected. For example, as shown in FIG. 1, an aspect (e.g. an amount dispensed) of the consumable composition may be detected by detection logic 121 receiving data from sensing logic 124 operably coupled to a sensor module 150 (e.g. a capacitive concentration sensor), communications logic 122 operably coupled to a communications module 130 (e.g. a wireless transceiver), user interface logic 123 operably coupled to a user interface 140 (e.g. a keypad or touchscreen), dispensing logic 125 operably coupled to an integrated consumable composition dispenser module 160, and/or an external consumable composition dispenser module 170 (e.g. an actuated release mechanism), and/or sterilization logic 188 operably coupled to a sterilization module 186, 187 (e.g. an ultra-violet radiation source).

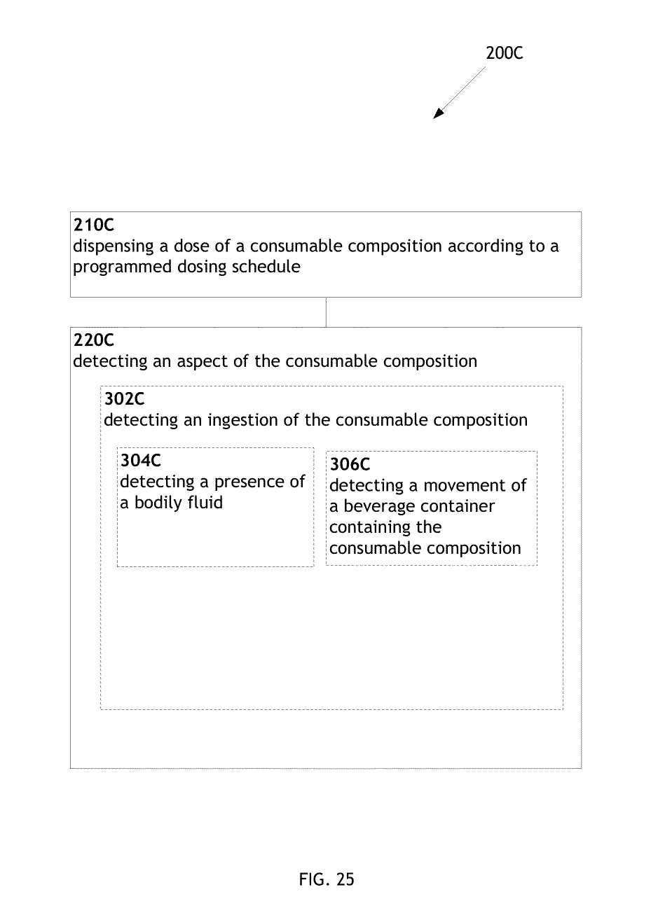

FIG. 25 illustrates alternative embodiments where the example operational flow 200C of FIG. 24 may include at least one additional operation. Additional operations may include an operation 302C.

At the operation 302C, detecting at least one ingestion of the consumable composition may occur (e.g. a user has complied with a programmed dosing schedule for the consumable composition by swallowing the consumable composition). For example, as shown in FIG. 1, the sensing logic 124 may be operably coupled to sensor module 150. Upon ingestion of a consumable composition, the sensor module 150 may provide a signal to sensing logic 124 that ingestion has occurred.

FIG. 25 further illustrates alternative embodiments of the example operational flow 200C of FIG. 24 where the detecting operation 302C may include at least one additional operation. Additional operations may include an operation 304C, and/or an operation 306C.

At the operation 304C, detecting a presence of a bodily fluid (e.g. biometric detection) may occur. For example, as shown in FIG. 1, the sensor module 150 may include a biometric sensor which senses the presence of saliva, perspiration, sebum and the like, either on the surface of the beverage container 110 or as a component of the contents therein.

At the operation 306C, detecting a movement of a beverage container containing the consumable composition (e.g. accelerometric detection of a user-initiated movement) may occur. For example, as shown in FIG. 1, the sensor module 150 may include an accelerometer, inertial motion sensor and the like, which may sense the movement of the beverage container 110.

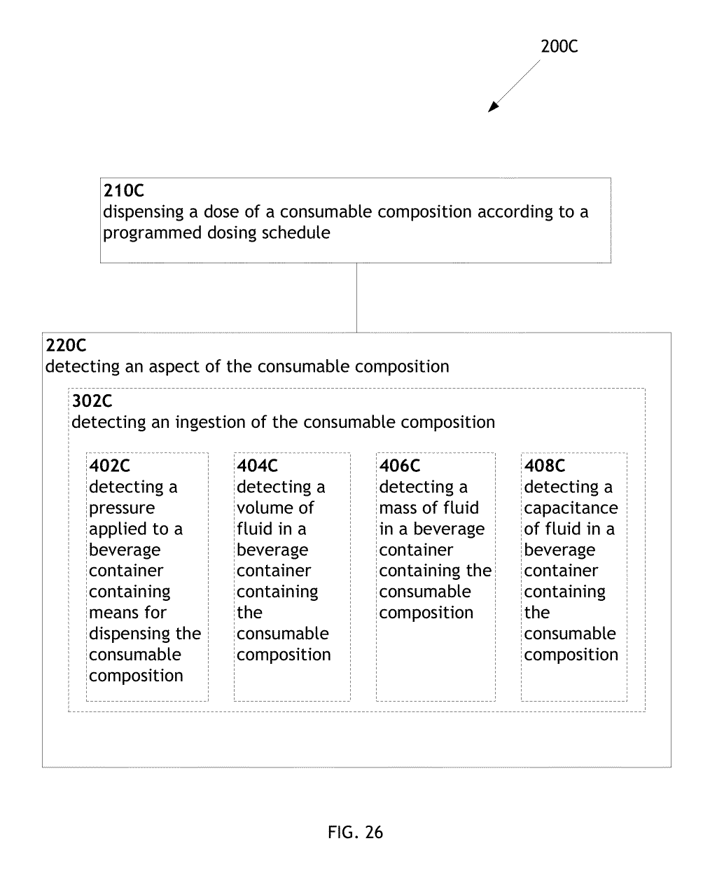

FIG. 26 illustrates alternative embodiments of the example operational flow 200C of FIG. 25. FIG. 26 illustrates example embodiments where the detecting operation 302C may include at least one additional operation. Additional operations may include an operation 402C, an operation 404C, an operation 406C, and/or an operation 408C.

At the operation 402C, detecting a pressure applied to a beverage container containing the consumable composition (e.g. fiber optic pressure detection of a user grasping the beverage container) may occur. For example, as shown in FIG. 1, the sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, and the like which senses a pressure applied to the beverage container 110.

At operation 404C, detecting a volume of fluid in a beverage container containing the consumable composition may occur (e.g. optical detection). For example, as shown in FIG. 1, the sensor module may include an optical or mechanical sensor which may sense a volume of the fluid in the beverage container 110.

At the operation 406C, detecting a mass of fluid in a beverage container containing the consumable composition may occur (e.g. mechanical deflection pressure detection). For example, as shown in FIG. 1, the sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, and the like which senses a mass of fluid contained in the beverage container 110.

At the operation 408C, detecting a capacitance of fluid in a beverage container containing the consumable composition may occur (e.g. chemical field effect transistor detection). For example, as shown in FIG. 1, the sensor module 150 may include a capacitive concentration sensor which may sense a concentration of the consumable composition present in the beverage container 110.

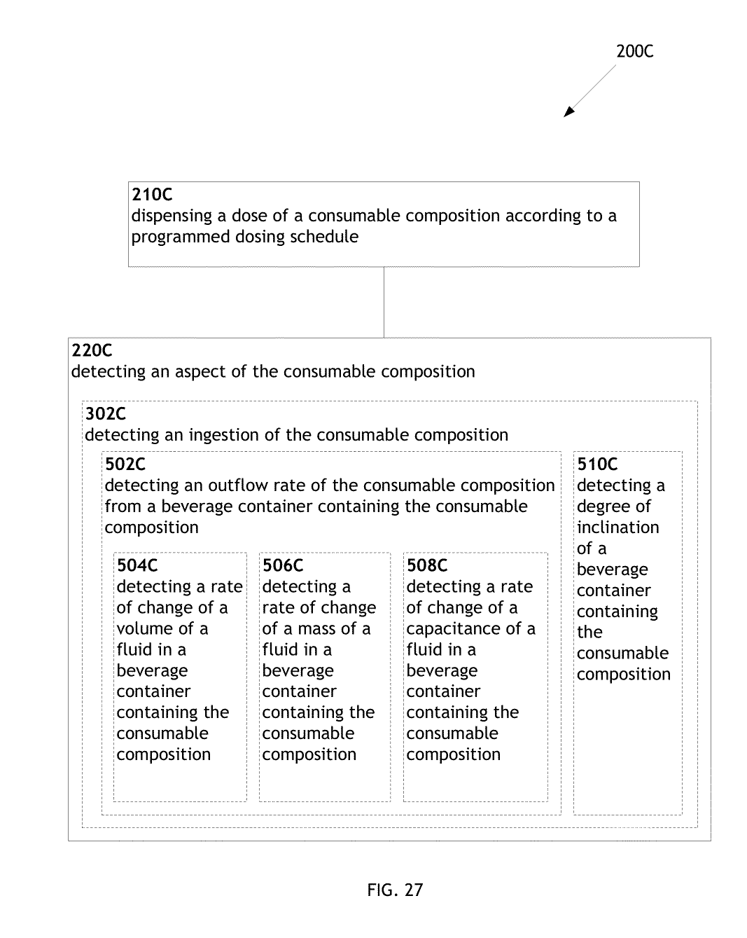

FIG. 27 illustrates alternative embodiments of the example operational flow 200C of FIG. 25. FIG. 27 illustrates example embodiments where the detecting operation 302C may include at least one additional operation. Additional operations may include an operation 502C, an operation 504C, an operation 506C, an operation 508C, and/or an operation 510C.

At the operation 502C, detecting an outflow rate of the consumable composition from a beverage container containing the consumable composition may occur (e.g. a rate at which a physical, chemical, electrical, or optical property changes). For example, as shown in FIG. 1, the sensor module 150 may include a fiber optic pressure/outflow sensor, mechanical deflection pressure/outflow sensor, strain gauge pressure/outflow sensor, piezoresistive pressure/outflow sensor, microelectromechanical (MEMS) pressure/outflow sensor, variable capacitance pressure/outflow sensor, flowmeters, and the like which sense an outflow from the beverage container 110 containing the consumable composition. Such an outflow may indicate a proper ingestion or an improper disposal of the consumable composition, depending on the outflow rate. For example, proper ingestion might be indicated by an outflow rate indicative of normal drinking, while improper disposal might be indicated by an outflow rate indicative of dumping the contents of the cup by upending the cup.

Further, at the operation 504C, detecting a rate of change of a volume of a fluid in a beverage container containing the consumable composition may occur (e.g. a magnetic flowmeter measuring volume outflow from the beverage container over time).

Further, at the operation 506C, detecting a rate of change of a mass of a fluid in a beverage container containing the consumable composition may occur (e.g. a piezoresistive pressure sensor measuring the change in the mass present in a beverage container over time).

Further, at the operation 508C, detecting a rate of change of a capacitance of a fluid in a beverage container containing the consumable composition may occur (e.g. a capacitive sensor measuring the change of capacitance of the fluid in the beverage container over time).

At the operation 510C, detecting a degree of inclination of a beverage container containing the consumable composition may occur (e.g. a mechanism may detect that a user is rotating the beverage container by a certain degree relative to its designed resting position so as to ingest its contents). For example, as shown in FIG. 1, the sensor module 150 may include an inclinometer and the like. The degree of incline of the beverage container 110 may indicate a proper ingestion or an improper disposal of the consumable composition, depending on the degree of incline.

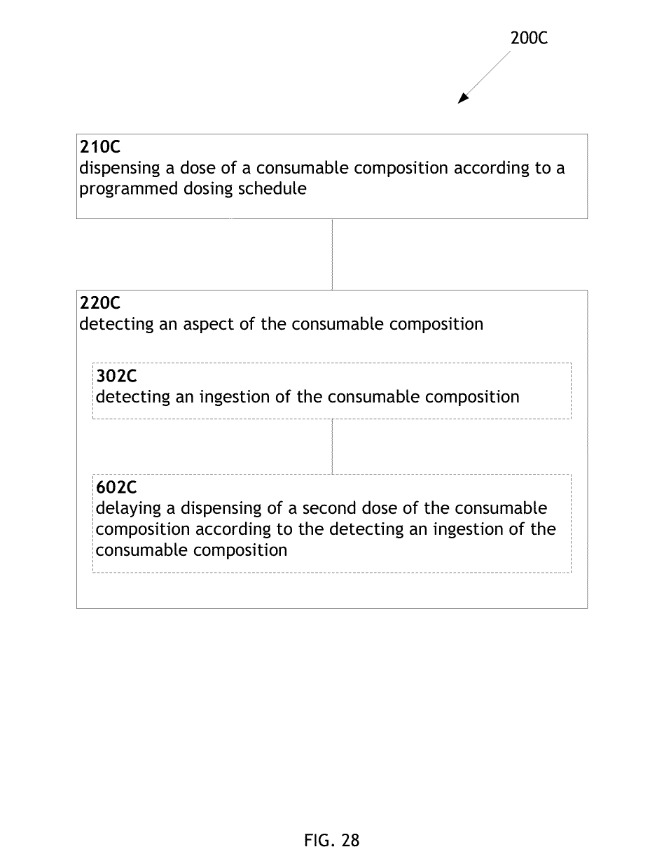

FIG. 28 illustrates alternative embodiments of the example operational flow 200C of FIG. 25. FIG. 28 illustrates example embodiments where the operational flow 200C may include at least one additional operation. Additional operations may include a delaying operation 602C.

At the operation 602C, delaying a dispensing of a second dose of the consumable composition according to the detecting the at least one ingestion of the consumable composition may occur (e.g. a mechanism delaying dispensing until the first dose will have been metabolized). For example, as shown in FIG. 1, the sensing logic 124 may provide data from the sensor module 150 regarding an amount of consumable composition ingested to the detecting logic 121. The dispensing logic 125 may delay a dispensation of a second dose of the consumable composition by the integrated consumable composition dispenser module 160, and/or the external consumable composition dispenser module 170 until the detecting logic 121 indicates of an ingestion of a previously dispensed dose of the consumable composition.

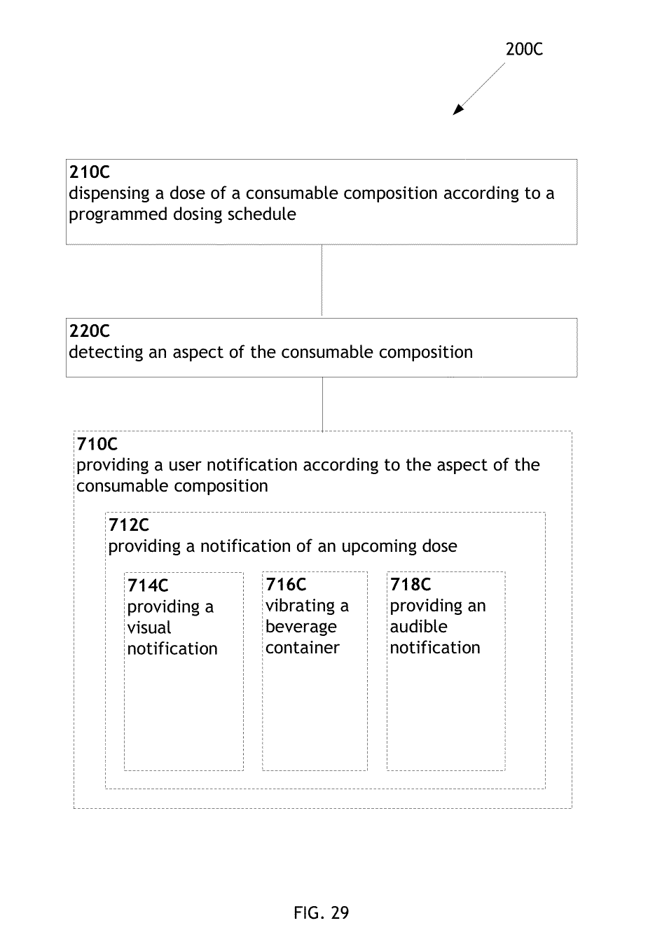

FIG. 29 illustrates example embodiments where the operational flow 200C of FIG. 24 may include at least one additional operation. Additional operations may include operations 710C, 712C, 71C4, 716C and/or 718C.

At operation 710C, providing a user notification according to the aspect of the consumable composition may occur (e.g. a notification of a dispensed dose of a consumable composition according to an amount of the consumable composition dispensed). For example, as shown in FIG. 1, the user interface logic 123 may cause the notification module 142 of the user interface 140 to provide a notification that an amount of consumable composition is about to be dispensed. The notification may include the identity of the consumable composition (e.g., a trade name and/or chemical composition of the consumable composition) and the timing of the dispensation (e.g. “20 minutes ago”).

FIG. 29 further illustrates alternative embodiments where the notification operation 710C may include at least one additional operation. Additional operations may include an operation 712C.

At the operation 712C, providing a notification of an upcoming dose may occur (e.g. a dose scheduled according to a programmed dosing schedule will be dispensed at a given time). For example, as shown in FIG. 1, the user interface logic 140 may cause the notification module 142 of the user interface 140 to provide a notification to the user 190.

FIG. 29 further illustrates example embodiments where the upcoming dose notification operation 712C may include at least one additional operation. Additional operations may include an operation 714C, an operation 716C, and/or an operation 718C.

At the operation 714C, providing a visual notification may occur (e.g. a graphical notice on a display screen). For example, as shown in FIG. 1, the notification module 142 of the user interface 140 may include a flashing LED, LCD display screen, and the like.

At the operation 716C, vibrating a beverage container may occur (e.g. movement of an asymmetrical mass). For example, as shown in FIG. 1, the notification module 142 may include an asymmetrical rotating mass operably coupled to a motor. Upon application of power to the motor, the mass may be rotated such that it induces vibration in the beverage container 110.

At the operation 718, providing an audible notification may occur (e.g. a simple beep or voice command). For example, as shown in FIG. 1, the notification module 142 of the user interface 140 may include a speaker assembly, and the like.

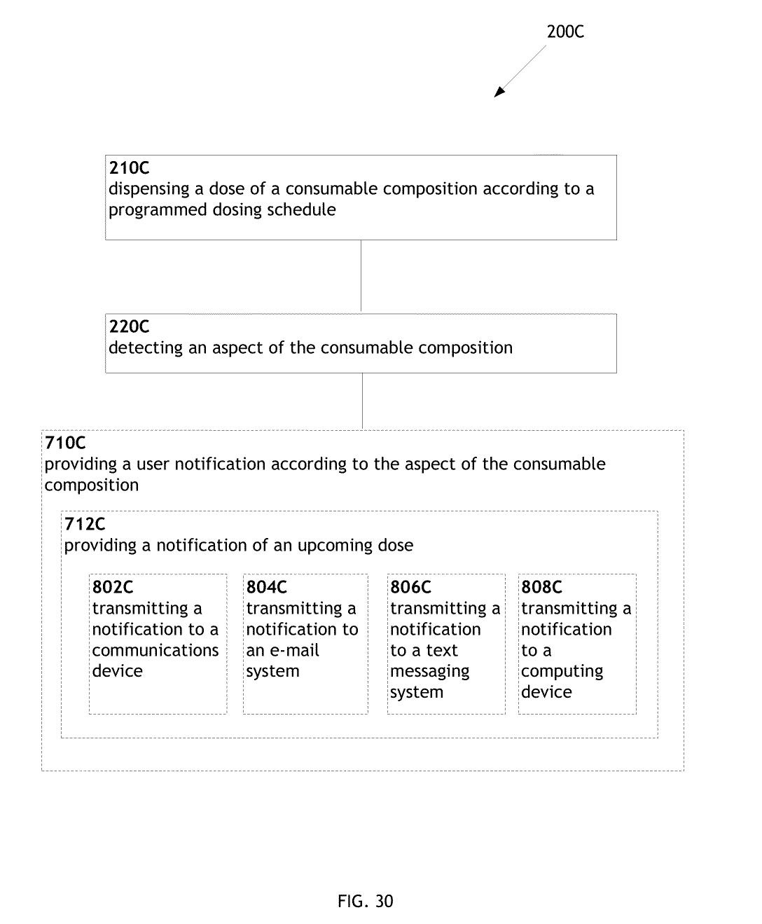

FIG. 30 illustrates alternative embodiments of the example operational flow 200C of FIG. 29. FIG. 8 illustrates example embodiments where the upcoming dose notification operation 712C may include at least one additional operation. Additional operations may include an operation 802C, an operation 804C, an operation 806C, and/or an operation 808C.

At the operation 802C, transmitting a notification to a communications device may occur (e.g. placing an automated call to a user's home phone). For example, as shown in FIG. 1, the communications module 130 may transmit a notification to a monitoring system 180 linked to a communications device 181. The communications device 181 may include a cell phone, satellite phone, Blackberry®, land-line phone, and the like.

At the operation 804C, transmitting a notification to an e-mail system may occur (e.g. an automated e-mail notice to a user's e-mail account). For example, as shown in FIG. 1, the communications module 130 may transmit a notification to a monitoring system 180 linked to an e-mail system 182 including an IMAP, POP3, SMTP, and/or HTTP e-mail server having an e-mail account associated with a user 190.

At the operation 806C, transmitting a notification to a text messaging system may occur (e.g. an automated text message to a user's cell phone). For example, as shown in FIG. 1, the communications module 130 may transmit a notification to a monitoring system 180 linked to a text messaging system 183, such as a SMS system in GSM.

At the operation 808C, transmitting a notification to a computing device may occur (e.g. an automated instant message to a user's computer). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like capable of receiving instant messages from IM providers such as Microsoft®.

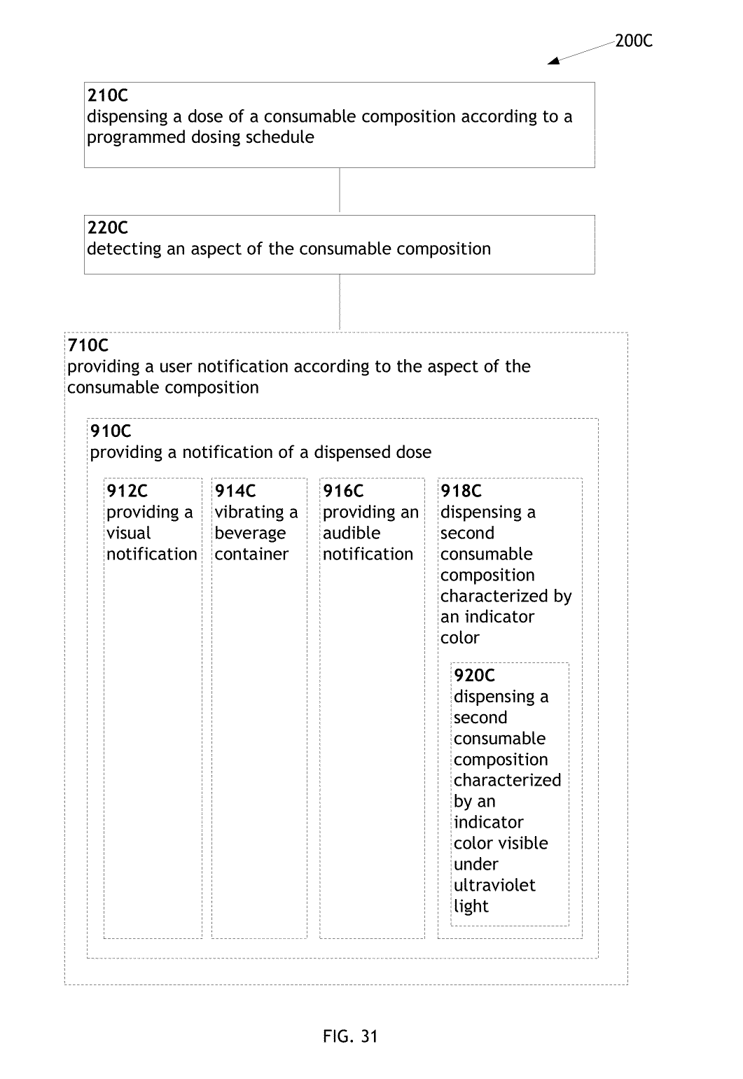

FIG. 31 illustrates alternative embodiments of the example operational flow 200C of FIG. 29. FIG. 31 illustrates an example embodiment where the user notification operation 710C may include at least one additional operation. Additional operations may include an operation 910C.

At operation 910C, providing a notification of a dispensed dose may occur (e.g. a dose scheduled according to a programmed dosing schedule has been dispensed at a given time). For example, as shown in FIG. 1, the user interface logic 123 may cause the notification module 142 of the user interface 140 to provide a notification that an amount of the consumable composition has been dispensed. The notification may include the identity of the consumable composition and the timing of the dispensation.

FIG. 31 further illustrates example embodiments where the dispensed dose notification operation 910C may include at least one additional operation. Additional operations may include an operation 912C, an operation 914C, an operation 916C, an operation 918C, and/or an operation 920C.

At the operation 912C, providing a visual notification may occur (e.g. an image of a beverage cup containing a consumable composition displayed on an LCoS display). For example, as shown in FIG. 1, the notification module 142 of the user interface 140 may include a flashing LED, an LCD or LCoS display screen, and the like.

At the operation 914C, vibrating a beverage container may occur (e.g. periodic movement of an oscillating mass). For example, as shown in FIG. 1, the beverage container 110 may include an asymmetrical rotating mass operably coupled to a motor. Upon application of power to the motor, the mass may be rotated such that it induces vibration in the beverage container 110.

At the operation 916C, providing an audible notification may occur (e.g. a vocal notification). For example, as shown in FIG. 1, the notification module 142 of the user interface 140 may include a speaker assembly, and the like, over which a notification may be transmitted. In some instances, the notification includes the dose dispensed and the material dispensed (e.g., “100 mg of Viagra was just dispensed into your cup”).

At the operation 918C, dispensing a second consumable composition characterized by an indicator color may occur (e.g. red, blue or green). For example, as shown in FIG. 1, the dispensing logic 125 may cause the integrated consumable composition dispenser module 160 and/or the external consumable composition dispenser module 170 to dispense a second consumable composition (e.g., Allura Red AC food coloring [2-naphthalenesulfonic acid]) which has a visible indicator color (e.g., red) different from the consumable composition (e.g., a white analgesic, such as acetylsalicylic acid). Further, at the operation 920, dispensing a second consumable composition characterized by an indicator color visible under ultraviolet light may occur (e.g. tonic water comprising quinine). Similarly, compositions visible under other electromagnetic radiation wavelength ranges, such as infrared, may be used.

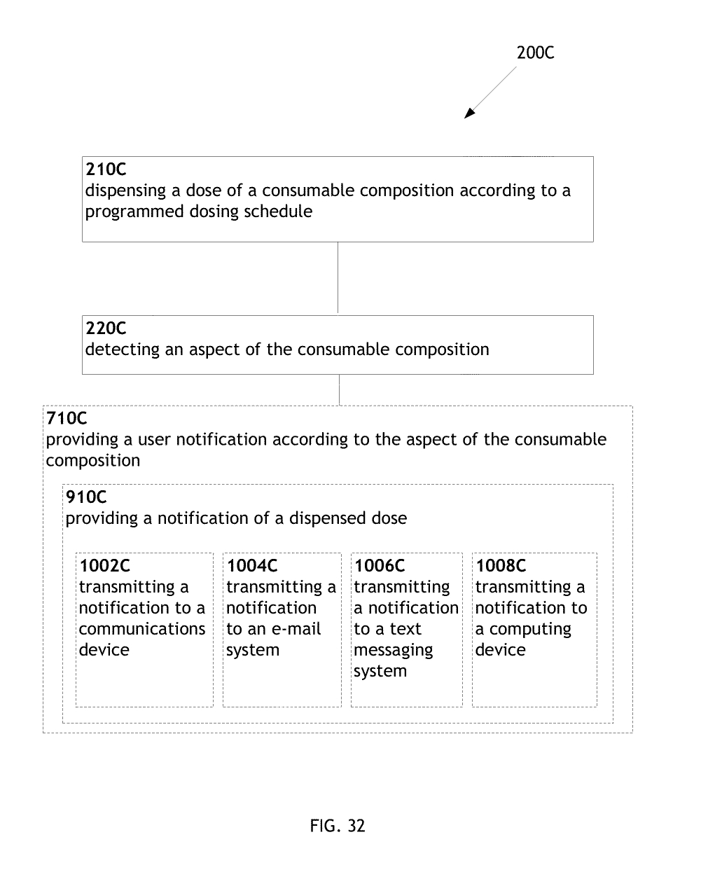

FIG. 32 illustrates alternative embodiments of the example operational flow 200C of FIG. 31. FIG. 32 illustrates example embodiments where the dispensed dose notification operation 910C may include at least one additional operation. Additional operations may include an operation 1002C, an operation 1004C, an operation 1006C, and/or an operation 1008C.

At the operation 1002C, transmitting a notification to a communications device may occur (e.g., sending a text message to a user's cell phone). For example, as shown in FIG. 1, the communications module 130 may transmit a notification to a monitoring system 180 linked to a communications device 181. The communications device 181 may include a cell phone, Blackberry®, land-line phone, and the like.

At the operation 1004C, transmitting a notification to an e-mail system may occur (e.g. sending an e-mail to an IMAP, POP3, SMTP, and/or HTTP e-mail server having an e-mail account associated with a user 190). For example, as shown in FIG. 1, the communications module 130 may transmit a notification to a monitoring system 180 linked to an e-mail system 182.

At the operation 1006C, transmitting a notification to a text messaging system may occur (e.g. sending text message to an SMS system in GSM). For example, as shown in FIG. 1, the communications module 130 may transmit a notification to a monitoring system 180 linked to a text messaging system 183.

At the operation 1008C, transmitting a notification to a computing device may occur (e.g. sending an instant message to a personal computer). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like.

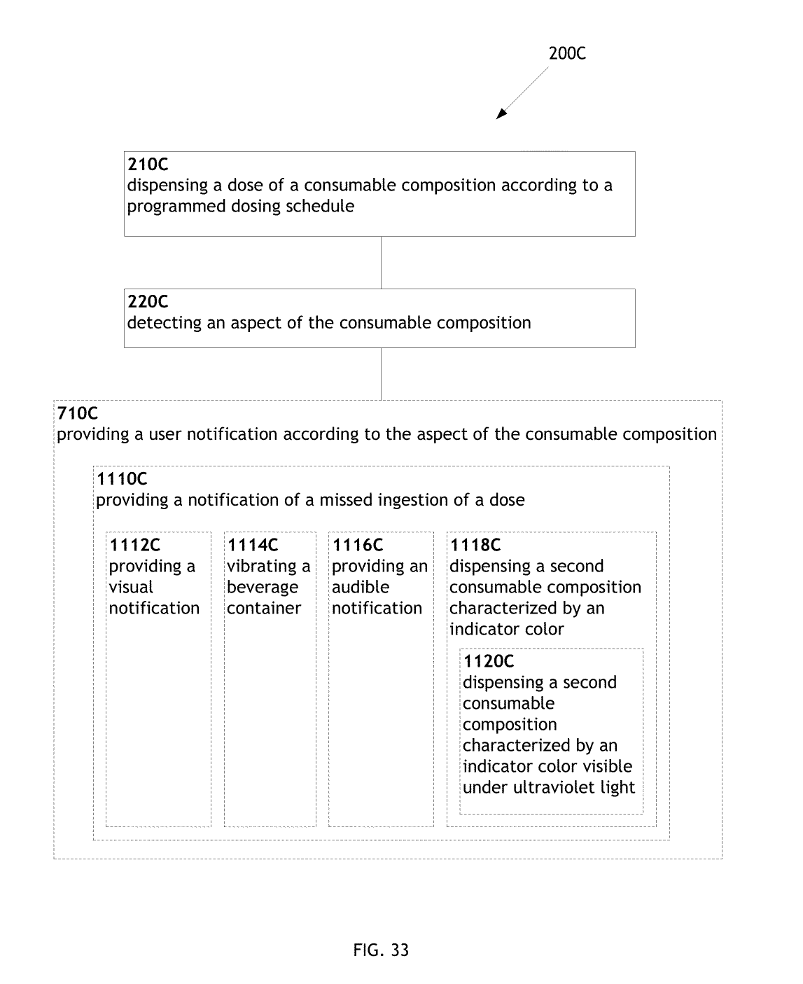

FIG. 33 illustrates alternative embodiments of the example operational flow 200C of FIG. 29. FIG. 33 illustrates an example embodiment where the user notification operation 710C may include at least one additional operation. Additional operations may include an operation 1110C.

At operation 1110C, providing a notification of a missed ingestion of a dose may occur (e.g. a dose dispensed according to a programmed dosing schedule has not been ingested). For example, as shown in FIG. 1, the user interface logic 123 may cause the notification module 142 of the user interface 140 to provide a notification that ingestion of the consumable composition has been missed. The notification may include the identity of the consumable composition and the timing of the dispensation (e.g., a dose of Percoset was dispensed at 3:00 pm).

FIG. 33 further illustrates alternative embodiments where the dispensed dose notification operation 1110C may include at least one additional operation. Additional operations may include an operation 1112C, an operation 1114C, an operation 1116C, an operation 1118C, and/or an operation 1120C.

At the operation 1112C, providing a visual notification may occur (e.g. an LED may change colors from green to red). For example, as shown in FIG. 1, the notification module 142 of the user interface 140 may include a flashing LED, LCD display screen, and the like.

At the operation 1114C, vibrating a beverage container may occur (e.g. rotation of an asymmetrical mass). For example, as shown in FIG. 1, the beverage container 110 may include an asymmetrical rotating mass operably coupled to a motor. Upon application of power to the motor, the mass may be rotated such that it induces vibration in the beverage container 110.

At the operation 1116C, providing an audible notification may occur (e.g. an audio broadcast of a ring tone). For example, as shown in FIG. 1, the notification module 142 of the user interface 140 may include a speaker assembly, and the like.

At the operation 1118C, dispensing a second consumable composition characterized by an indicator color may occur. For example, as shown in FIG. 1, the dispensing logic 125 may cause the integrated consumable composition dispenser module 160 and/or the external consumable composition dispenser module 170 to dispense a second consumable composition (e.g., Sunset Yellow FCF food coloring [disodium salt of 6-hydroxy-5-[(4-sulfophenyl)azo]-2-naphthalenesulfonic acid]) separate from the consumable composition (e.g., an antihistamine) which has a visible indicator color (e.g. yellow) different color than the consumable composition (e.g. white). Further, at the operation 1120, dispensing a second consumable composition characterized by an indicator color visible under ultraviolet light may occur (e.g. a solution containing Vitamin B-12).

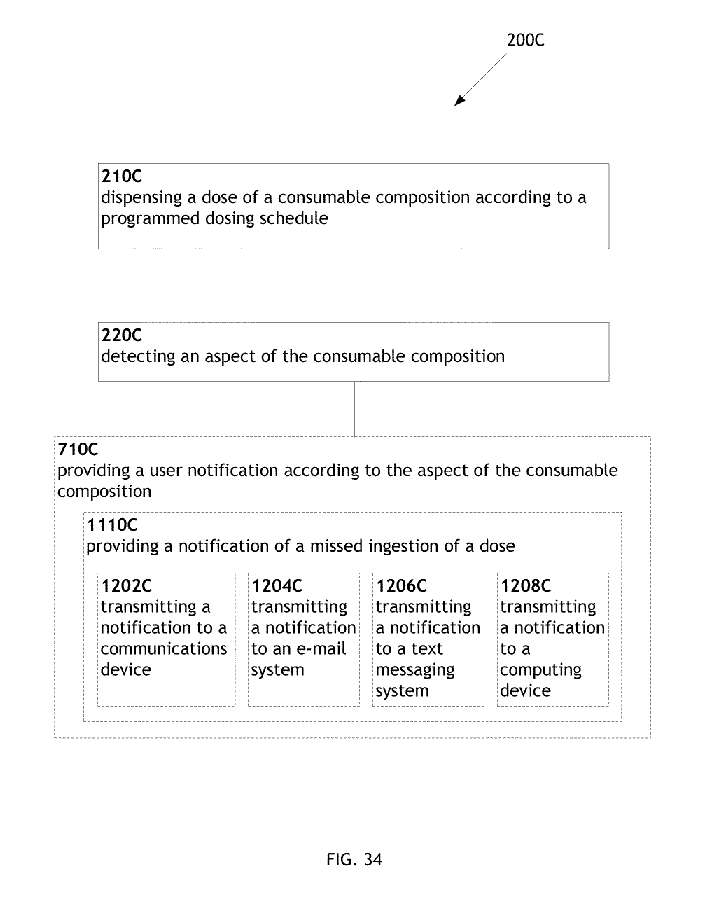

FIG. 34 illustrates alternative embodiments of the example operational flow 200C of FIG. 33. FIG. 34 illustrates example embodiments where the missed dose ingestion notification operation 1110C may include at least one additional operation. Additional operations may include an operation 1202C, an operation 1204C, an operation 1206C, and/or an operation 1208C.

At the operation 1202C, transmitting a notification to a communications device may occur (e.g. sending an instant message to a Blackberry® device). For example, as shown in FIG. 1, the communications module 130 may transmit a notification to a monitoring system 180 linked to a communications device 181. The communications device 181 may include a cell phone, Blackberry®, land-line phone, and the like.

At the operation 1204C, transmitting a notification to an e-mail system may occur (e.g. an e-mail to an IMAP, POP3, SMTP, and/or HTTP e-mail server having an e-mail account associated with a user 190). For example, as shown in FIG. 1, the communications module 130 may transmit a notification to a monitoring system 180 linked to an e-mail system 182.

At the operation 1206C, transmitting a notification to a text messaging system may occur (e.g. text message to an SMS system in GSM). For example, as shown in FIG. 1, the communications module 130 may transmit a notification to a monitoring system 180 linked to a text messaging system 183.

At the operation 1208C, transmitting a notification to a computing device may occur (e.g., an instant message via an online gaming system, such as the Xbox Live® system marketed by the Microsoft® Corporation). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like.

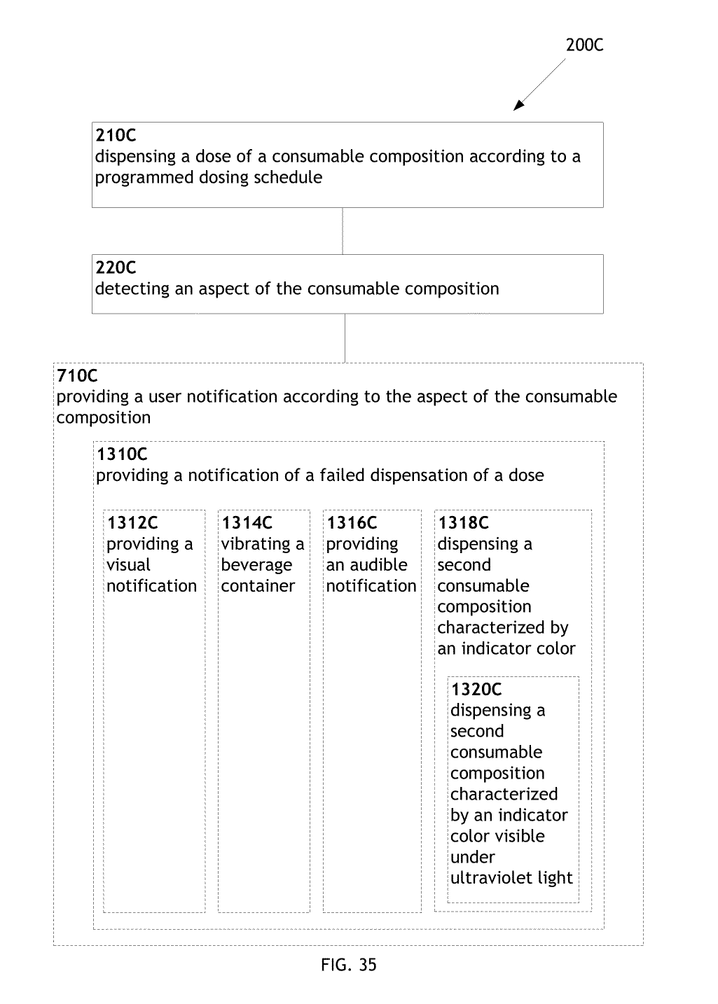

FIG. 35 illustrates alternative embodiments of the example operational flow 200C of FIG. 29. FIG. 35 illustrates an example embodiment where the user notification operation 710C may include at least one additional operation. Additional operations may include an operation 1310C.

At operation 1310C, providing a notification of a failed dispensation of a dose may occur (e.g. a dose scheduled to have been dispensed according to a programmed dosing schedule has not been dispensed). For example, as shown in FIG. 1, the user interface logic 123 may cause the notification module 142 of the user interface 140 to provide a notification that an amount of the consumable composition has failed to dispense (e.g., an audio notice stating “A dispensation of your Vicodin has failed.”) The notification may include the identity of the consumable composition and the timing of the dispensation.

FIG. 35 further illustrates alternative embodiments where the failed dispensation of a dose notification operation 1310 may include at least one additional operation. Additional operations may include an operation 1312C, an operation 1314C, an operation 1316C, an operation 1318C, and/or an operation 1320C.

At the operation 1312C, providing a visual notification may occur (e.g. a textual display on an LCD display). For example, as shown in FIG. 1, the notification module 142 of the user interface 140 may include a flashing LED, LCD display screen, and the like.

At the operation 1314C, vibrating a beverage container may occur (e.g. a spring-loaded mass may be released). For example, as shown in FIG. 1, the beverage container 110 may include an asymmetrical rotating mass operably coupled to a motor. Upon application of power to the motor, the mass may be rotated such that it induces vibration in the beverage container 110.

At the operation 1316C, providing an audible notification may occur (e.g. the mechanical ringing of a bell). For example, as shown in FIG. 1, the notification module 142 of the user interface 140 may include a speaker assembly, and the like.

At the operation 1318C, dispensing a second consumable composition characterized by an indicator color may occur. For example, as shown in FIG. 1, the dispensing logic 125 may cause the integrated consumable composition dispenser module 160 and/or the external consumable composition dispenser module 170 to dispense a second consumable composition (e.g., Brilliant Blue FCF) separate from the consumable composition (e.g., riboflavin) which has a visible indicator color (e.g., blue) distinct from that of the consumable composition (e.g. yellow). Further, at the operation 1320, dispensing a second consumable composition characterized by an indicator color visible under ultraviolet light may occur (e.g., chlorophyll extract).

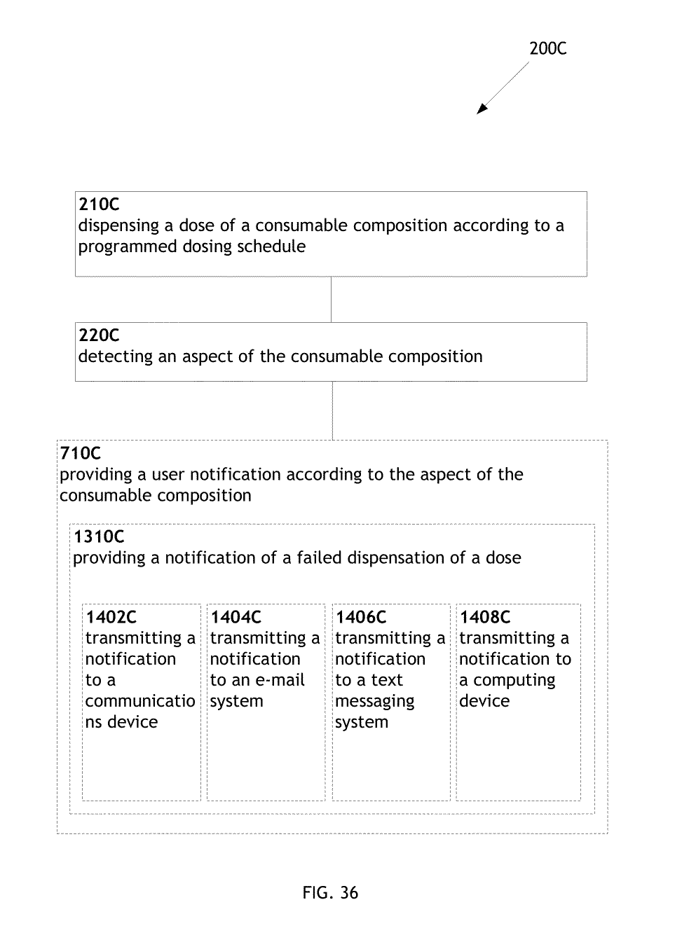

FIG. 36 illustrates alternative embodiments of the example operational flow 200C of FIG. 35. FIG. 36 illustrates example embodiments where the failed dispensation of a dose notification operation 1310C may include at least one additional operation. Additional operations may include an operation 1402C, an operation 1404C, an operation 1406C, and/or an operation 1408C.

At the operation 1402C, transmitting a notification to a communications device may occur (e.g., an automated voicemail sent to a cell phone and/or land line phone). For example, as shown in FIG. 1, the communications module 130 may transmit a notification to a monitoring system 180 linked to a communications device 181. The communications device 181 may include a cell phone, Blackberry®, land-line phone, and the like.

At the operation 1404C, transmitting a notification to an e-mail system may occur (e.g. an e-mail to an IMAP, POP3, SMTP, and/or HTTP e-mail server having an e-mail account associated with a user 190). For example, as shown in FIG. 1, the communications module 130 may transmit a notification to a monitoring system 180 linked to an e-mail system 182.

At the operation 1406C, transmitting a notification to a text messaging system may occur (e.g. text message to an SMS system in GSM). For example, as shown in FIG. 1, the communications module 130 may transmit a notification to a monitoring system 180 linked to a text messaging system 183.

At the operation 1408C, transmitting a notification to a computing device may occur (e.g., an instant message to a music player via a music download service, such as the iTunes® service marketed by Apple® Inc.). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like.

### Application Ser. No. 12/074,245 (0107A-002-005C-000000)

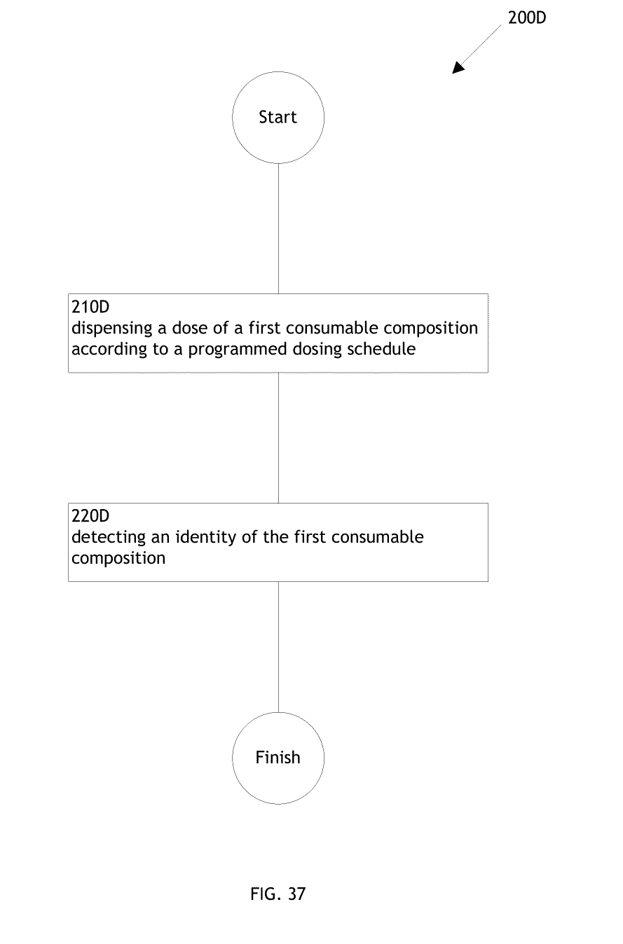

FIG. 37 illustrates an operational flow 200D representing example operations related to detecting chemical interactions between dispensed consumable compositions. In FIG. 37 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 20D0 moves to an operation 210D. Operation 210D depicts dispensing a dose of a first consumable composition according to a programmed dosing schedule (e.g. distributing a pharmaceutical composition in accordance with a user or physician-defined regimen). For example, as shown in FIG. 1, an integrated consumable composition dispenser module 160, and/or an external consumable composition dispenser module 170 may distribute one or more doses (e.g. 30 mg) of a consumable composition (e.g., an anti-depressant, such as Paroxotene) into a beverage container 110 (e.g., a drinking cup) according to a programmed dosing schedule (e.g. electronic data representing a physician-prescribed regimine of medication maintained in memory 126).

Then, operation 220D depicts detecting an identity of the first consumable composition (e.g. spectroscopic measurement of the composition of a biochemical). For example, as shown in FIG. 1, sensing logic 124 may cause sensor module 150 to detect an identity (e.g. a chemical composition) of a consumable composition. Sensor module 150 may include a chemical composition analysis mechanism (e.g. photoionization sensors, spectroscopic sensors, spectrometric sensors, crystallographic sensors, electrochemical sensors, calorimetric sensors). Identity data regarding the second consumable composition may be compared to consumable composition identification data 126-3 maintained in memory 126 so as to determine an identity of the second consumable composition.

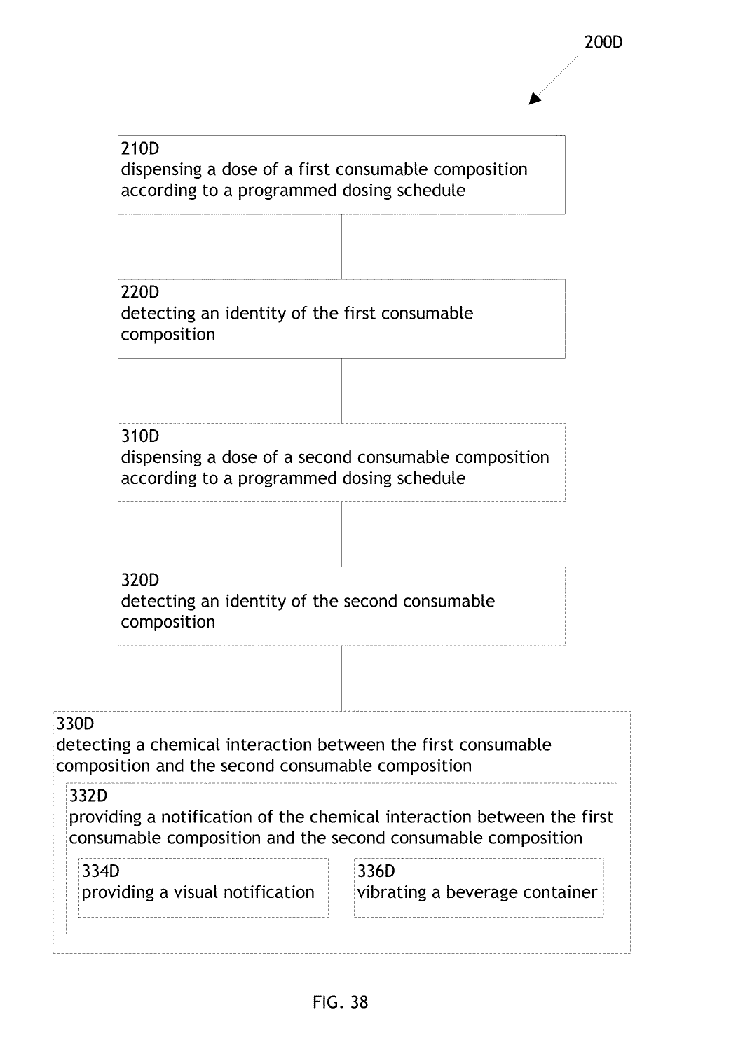

FIG. 38 illustrates an example embodiment where the example operational flow 200D of FIG. 37 may include at least one additional operation. Additional operations may include an operation 310D, an operation 320D, and/or an operation 330D.

Operation 310D illustrates dispensing a dose of a second consumable composition according to a programmed dosing schedule (e.g. distributing a neutraceutal composition in accordance with a homeopathic regimen). For example, as shown in FIG. 1, an integrated consumable composition dispenser module 160, and/or an external consumable composition dispenser module 170 may distribute one or more doses (e.g. 20 mg) of a consumable composition (e.g., a vitamin B-12 supplement) into a beverage container 110 according to a programmed dosing schedule (e.g. electronic data representing a user-defined regimine of maintained in memory 126).

Then, operation 320D illustrates detecting an identity of the second consumable composition (e.g. spectrometric measurement of the composition of a mineral). For example, as shown in FIG. 1, sensing logic 124 may cause sensor module 150 to detect an identity (e.g. a chemical composition) of a consumable composition. Identity data regarding the second consumable composition may be compared to consumable composition identification data 126-3 maintained in memory 126 so as to determine an identity of the second consumable composition.

Then, operation 330D illustrates detecting a chemical interaction between the first consumable composition and the second consumable composition (e.g. detecting a deactivation of a pharmaceutical consumable composition by a vitamin supplement). For example, as shown in FIG. 1, the identity of the first consumable composition and the second consumable composition may be compared to consumable composition identification data 126-3 for consumable compositions which may be chemically incompatible.

FIG. 38 further illustrates alternative embodiments of the example where the operation 330D may include at least one additional operation. Additional operations may include an operation 332D.

The operation 332D illustrates providing a notification of the chemical interaction between the first consumable composition and the second consumable composition (e.g a alerting a user that the ingestion of two consumable compositions will alter the medicinal or nutritional functionality of at least one of the consumable compositions). For example, as shown in FIG. 1, the user interface logic 140 may cause the notification module 142 of the user interface 140 to provide a notification to the user 190.

FIG. 38 further illustrates alternative embodiments of the example where the operation 332D may include at least one additional operation. Additional operations may include an operation 334D, and/or 336D.

Operation 334D illustrates providing a visual notification (e.g. an LED may change colors from green to red). For example, as shown in FIG. 1, the notification module 142 of the user interface 140 may include a flashing LED, LCD display screen, and the like.

Operation 336D illustrates vibrating a beverage container (e.g. movement of an asymmetrical mass). For example, as shown in FIG. 1, the notification module 142 may include an asymmetrical rotating mass operably coupled to a motor. Upon application of power to the motor, the mass may be rotated such that it induces vibration in the beverage container 110.

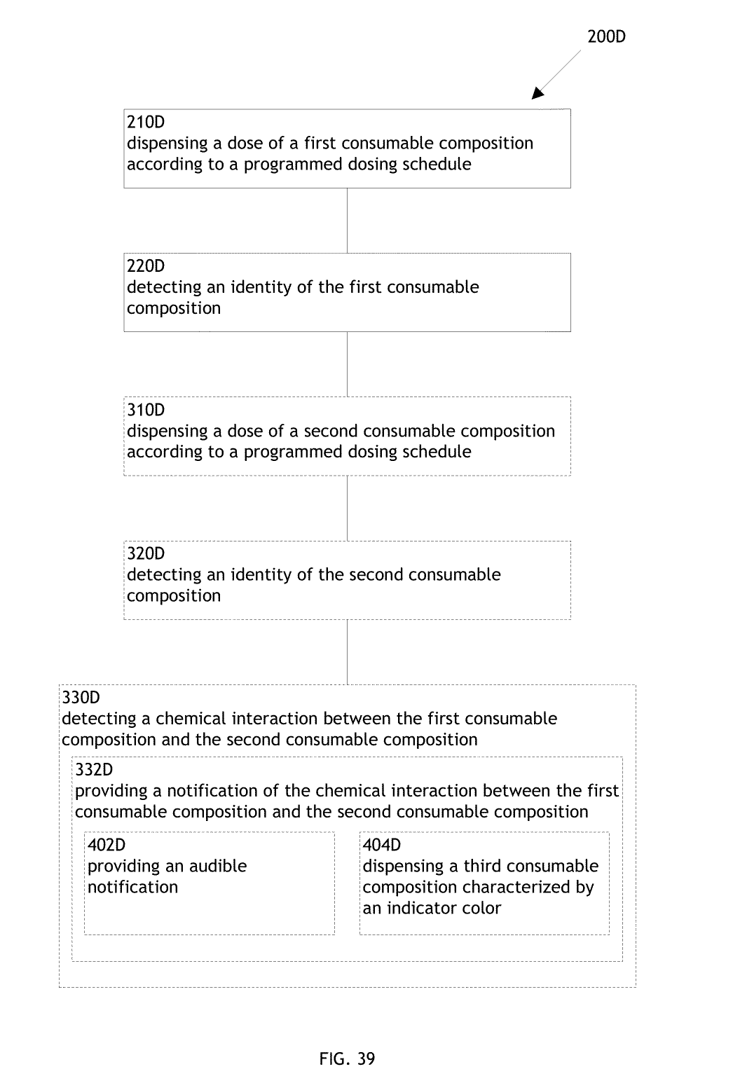

FIG. 39 illustrates alternative embodiments of the example operational flow 200D of FIG. 38 where the operation 332D may include at least one additional operation. Additional operations may include an operation 402D, and/or an operation 404D.

The operation 402 illustrates providing an audible notification (e.g. a simple beep or voice command). For example, as shown in FIG. 1, the notification module 142 of the user interface 140 may include a speaker assembly, and the like.

Operation 404D illustrates dispensing a third consumable composition characterized by an indicator color (e.g. red, blue or green). For example, as shown in FIG. 1, the dispensing logic 125 may cause the integrated consumable composition dispenser module 160 and/or the external consumable composition dispenser module 170 to dispense a third consumable composition (e.g., Allura Red AC food coloring [2-naphthalenesulfonic acid]) which has a visible indicator color (e.g., red) different from the consumable composition (e.g., a white analgesic, such as acetylsalicylic acid).

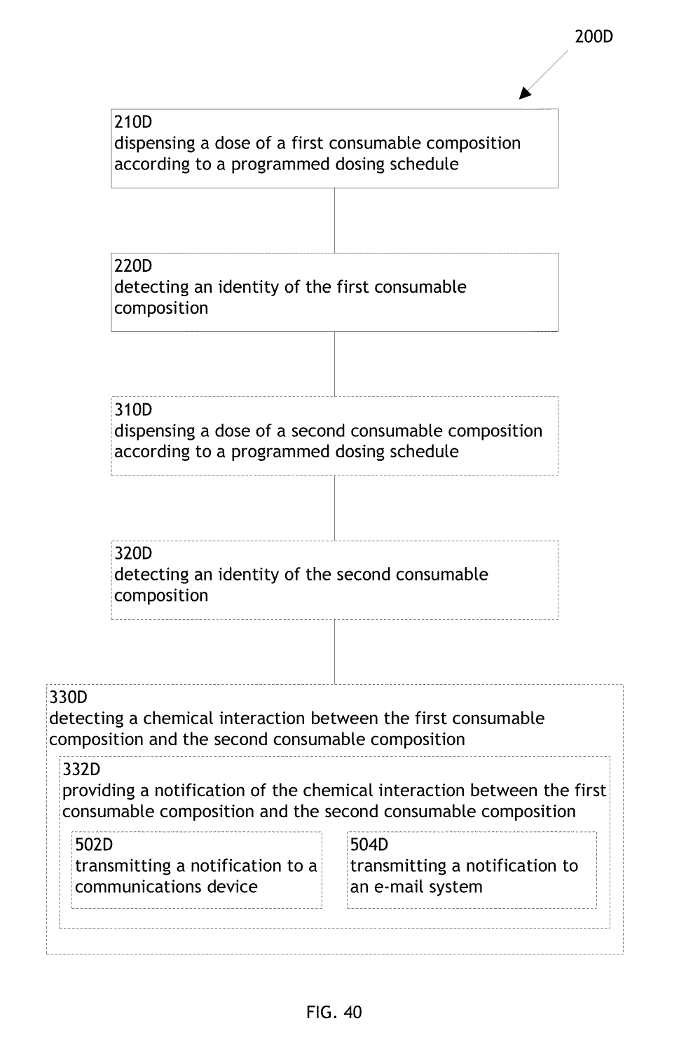

FIG. 40 illustrates alternative embodiments of the example operational flow 200D of FIG. 38 where the operation 332D may include at least one additional operation. Additional operations may include an operation 502D, and/or an operation 504D.

The operation 502D illustrates transmitting a notification to a communications device (e.g., placing an automated call to a user's cell phone). For example, as shown in FIG. 1, the communications module 130 may transmit a notification to a monitoring system 180 linked to a communications device 181. The communications device 181 may include a cell phone, Blackberry®, land-line phone, and the like.

Operation 504D illustrates transmitting a notification to an e-mail system (e.g. sending an e-mail to an IMAP, POP3, SMTP, and/or HTTP e-mail server having an e-mail account associated with a user 190). For example, as shown in FIG. 1, the communications module 130 may transmit a notification to a monitoring system 180 linked to an e-mail system 182.

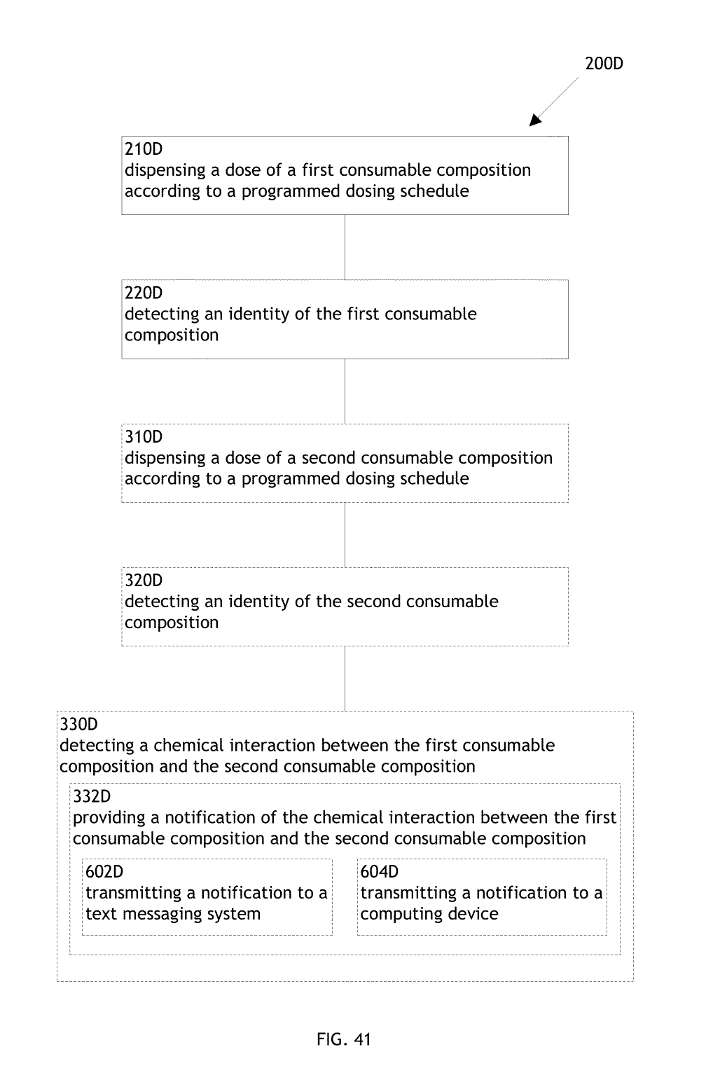

FIG. 41 illustrates alternative embodiments of the example operational flow 200D of FIG. 38 where the operation 332D may include at least one additional operation. Additional operations may include an operation 602D, and/or an operation 604D.

The operation 602D illustrates transmitting a notification to a text messaging system (e.g. sending text message to an SMS system in GSM). For example, as shown in FIG. 1, the communications module 130 may transmit a notification to a monitoring system 180 linked to a text messaging system 183.

Further, the operation 604D illustrates transmitting a notification to a computing device (e.g. sending an instant message to a personal computer). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like.

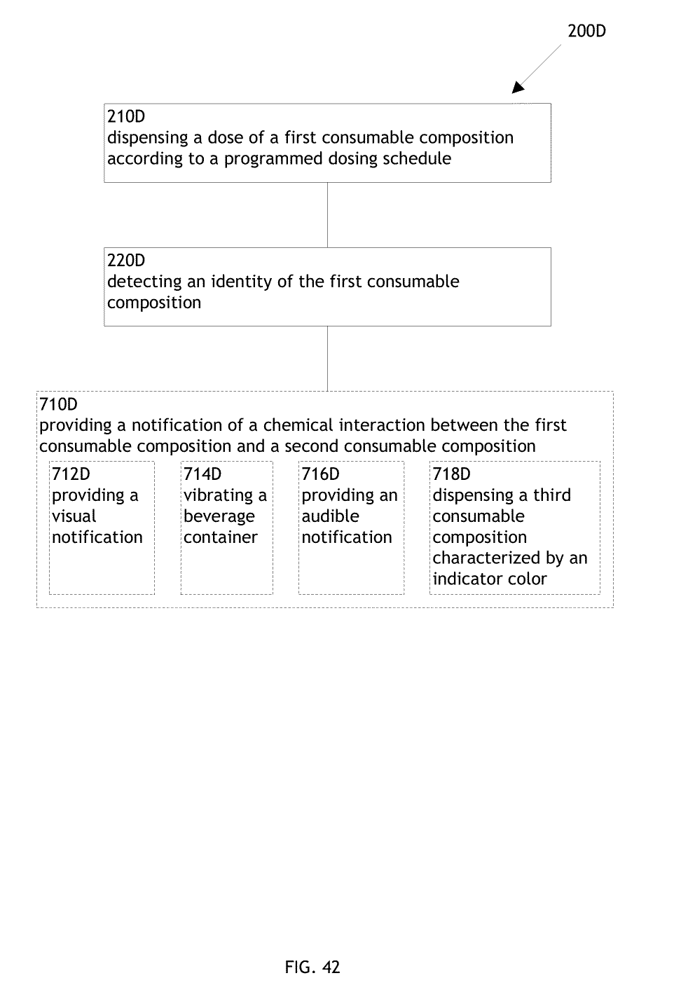

FIG. 42 illustrates alternative embodiments where the example operational flow 200D of FIG. 37 may include at least one additional operation. Additional operations may include an operation 710D.

The operation 710D illustrates providing a notification of the chemical interaction between the first consumable composition and a second consumable composition (e.g a alerting a user that the ingestion of two consumable compositions will alter the medicinal or nutritional functionality of at least one of the consumable compositions). For example, as shown in FIG. 1, the user interface logic 140 may cause the notification module 142 of the user interface 140 to provide a notification to the user 190.

FIG. 42 further illustrates alternative embodiments where the operation 710D may include at least one additional operation. Additional operations may include an operation 712D, 714D, 716D and/or 718D.

The operation 712D illustrates providing a visual notification (e.g. a graphical notice on a display screen listing consumable compositions which are chemically incompatible with a consumable composition which has been dispensed or is to be dispensed). For example, as shown in FIG. 1, the notification module 142 of the user interface 140 may include a LCD display screen, a LCoS display screen, and the like.

The operation 714D illustrates vibrating a beverage container (e.g. movement of an asymmetrical mass when programmed dosing schedules for incompatible consumable compositions overlap). For example, as shown in FIG. 1, the notification module 142 may include an asymmetrical rotating mass operably coupled to a motor. Upon detection of an overlap in dispensting programs 126-2 for incompatible consumable compositions, power may be applied to the motor and the mass may be rotated such that it induces vibration in the beverage container 110.

The operation 716D illustrates providing an audible notification (e.g. a voice reciting a list of consumable compositions which are chemically incompatible with a consumable composition which has been dispensed or is to be dispensed). For example, as shown in FIG. 1, the notification module 142 of the user interface 140 may include a speaker assembly, and the like.

The operation 718D illustrates dispensing a third consumable composition characterized by an indicator color (e.g. red, blue or green). For example, as shown in FIG. 1, the dispensing logic 125 may cause the integrated consumable composition dispenser module 160 and/or the external consumable composition dispenser module 170 to dispense a third consumable composition (e.g., Sunset Yellow FCF food coloring [disodium salt of 6-hydroxy-5-[(4-sulfophenyl)azo]-2-naphthalenesulfonic acid]) separate from the consumable composition which has a visible indicator color (e.g. yellow) different than the color or the consumable composition (e.g. a white antihistamine).

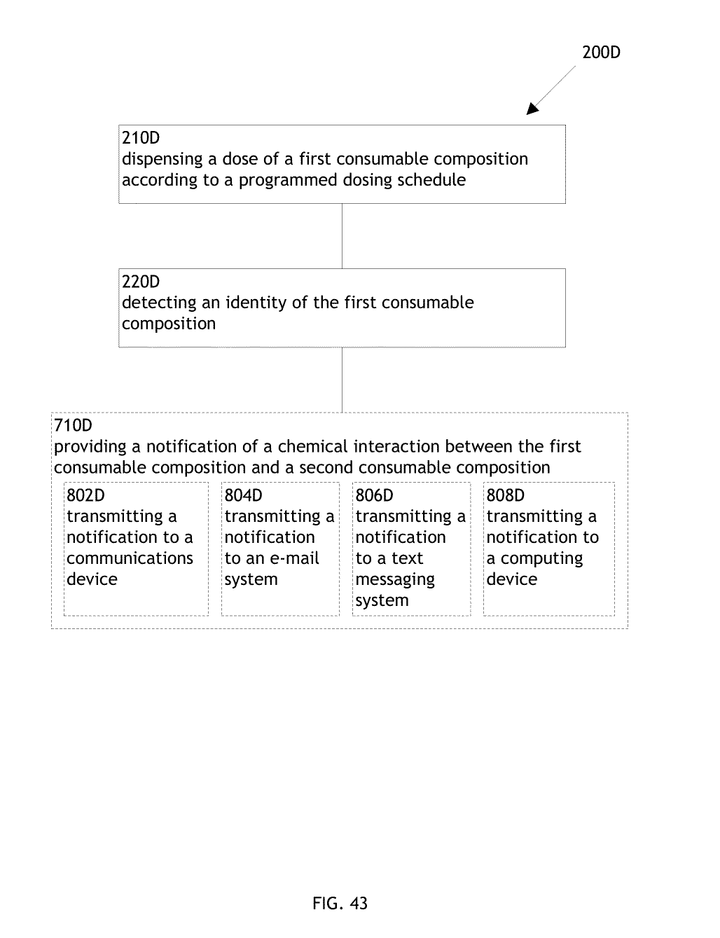

FIG. 43 further illustrates alternative embodiments where the operation 710D of FIG. 42 may include at least one additional operation. Additional operations may include an operation 802D, 804D, 806D and/or 808D.

The operation 802D illustrates transmitting a notification to a communications device (e.g. sending an instant message to a Blackberry® device). For example, as shown in FIG. 1, the communications module 130 may transmit a notification to a monitoring system 180 linked to a communications device 181. The communications device 181 may include a cell phone, Blackberry®, land-line phone, and the like.

The operation 804D illustrates transmitting a notification to an e-mail system (e.g. an e-mail to an IMAP, POP3, SMTP, and/or HTTP e-mail server having an e-mail account associated with a user 190). For example, as shown in FIG. 1, the communications module 130 may transmit a notification to a monitoring system 180 linked to an e-mail system 182.

The operation 806D illustrates transmitting a notification to a text messaging system (e.g. text message to an SMS system in GSM). For example, as shown in FIG. 1, the communications module 130 may transmit a notification to a monitoring system 180 linked to a text messaging system 183.

The operation 808D illustrates transmitting a notification to a computing device (e.g., an instant message to a PDA). For example, as shown in FIG. 1, the communications module 130 may transmit a notification to a monitoring system 180 linked to a computing device 184. The computing device 184 may include a personal digital assistant (PDA), personal computer, laptop, music player, gaming device, and the like.

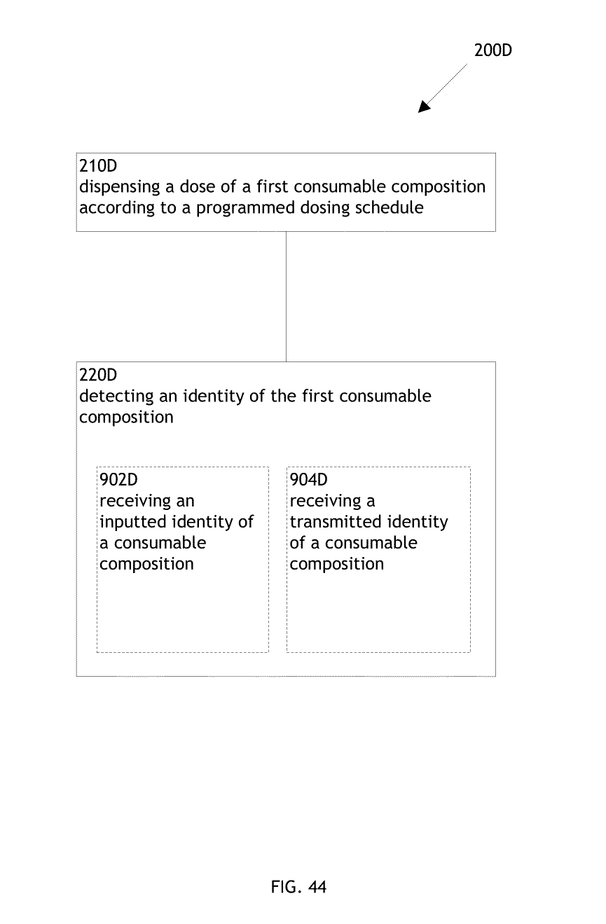

FIG. 44 illustrates alternative embodiments where the operation 220D of FIG. 37 may include at least one additional operation. Additional operations may include an operation 902D and/or an operation 904D.

The operation 902D illustrates receiving an inputted identity of a consumable composition (e.g. receipt of a user input identifying a consumable composition whose functionality may be affected by a second consumable composition). For example, as shown in FIG. 1, a user 190 may input an identity of a consumable composition via an input module 146 (e.g. a touch screen) of a user interface 140.

The operation 904D illustrates receiving a transmitted identity of a consumable composition (e.g. receipt of identification data from a physician identifying a consumable composition whose functionality may be affected by a second consumable composition). For example, as shown in FIG. 1, the communications module 130, may receive consumable composition identification data from a monitoring system 180 (e.g. a system associated with a physician, a system associated with a consumable composition supply entity, and the like).

### Application Ser. No. 12/217,121 (0107A-002-005D-000000)

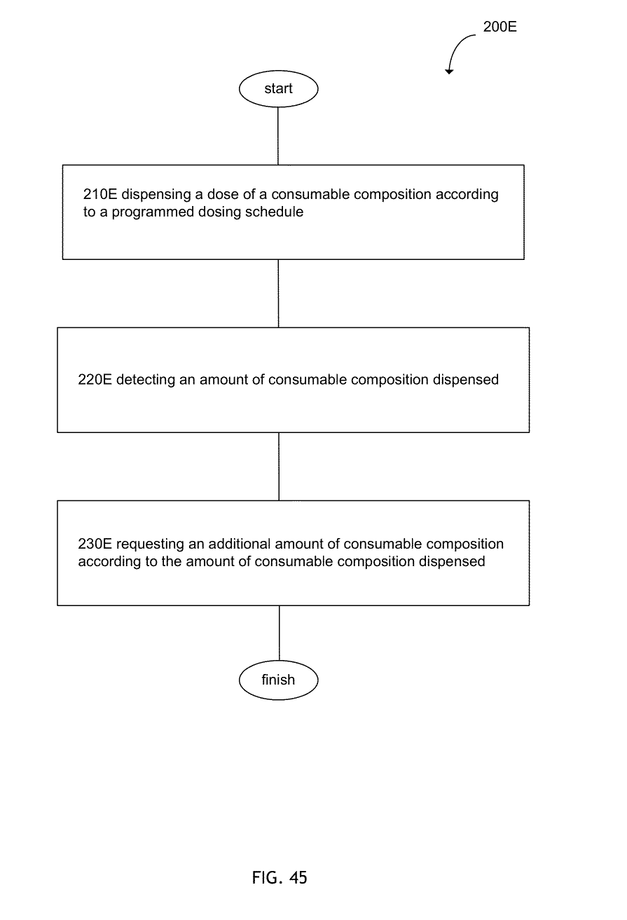

FIG. 45 illustrates an operational flow 200E representing example operations related to programmed dispensing of consumable compositions. In FIG. 44 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200E may move to operation 210E. Operation 210E depicts dispensing a dose of a consumable composition according to a programmed dosing schedule. For example, as shown in FIG. 1, internal consumable composition dispensing module 160 and/or external consumable composition dispensing module 170 may distribute doses of a consumable composition into a beverage container 110 according to a programmed dosing schedule (e.g. a dosing program 126-2 maintained in memory 126).

Then, operation 220E depicts detecting an amount of consumable composition dispensed. For example, as shown in FIG. 1, an amount of the consumable composition dispensed by the internal consumable composition dispenser module 160 and/or the external consumable composition dispenser module 170 may be detected by detection logic 121 receiving data from a sensing module 150 operably coupled to sensing logic 124.

Then, operation 230E depicts requesting an additional amount of consumable composition according to the amount of consumable composition dispensed. For example, once detection logic 121 has determined that a threshold amount of consumable composition has been dispensed, the communications module 130 may transmit an order for an additional amount of consumable composition to a monitoring system 180 associated with an outside entity (e.g. a consumable composition supply entity).

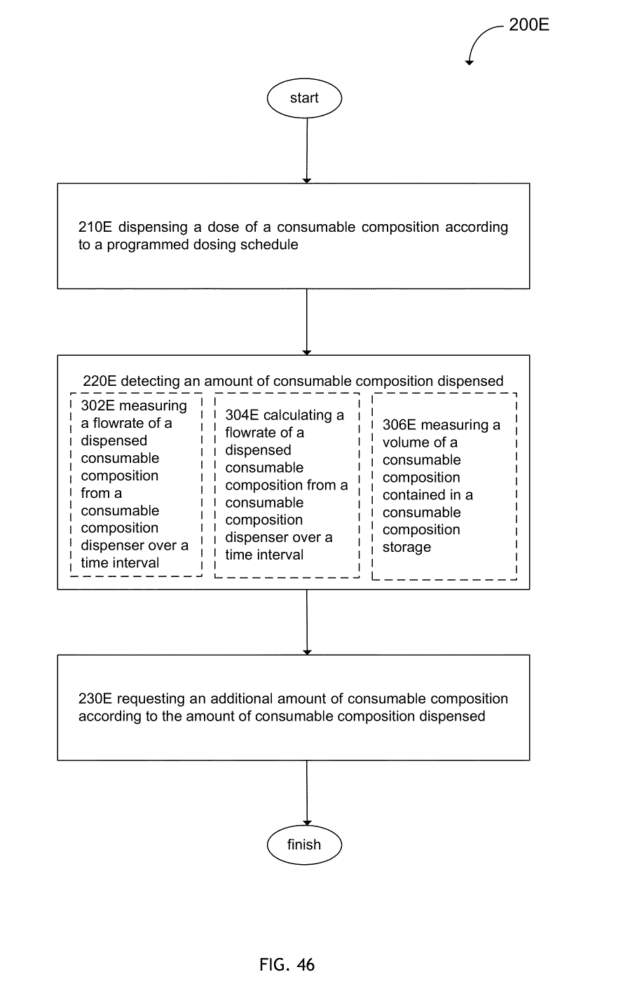

FIG. 46 illustrates alternative embodiments of the example operational flow 200E of FIG. 45 where the detecting operation 220E may include at least one additional operation. Additional operations may include an operation 302E, operation 304E and/or an operation 306E.

Operation 302E depicts measuring a flowrate of a dispensed consumable composition from a consumable composition dispenser over a time interval (e.g. a rate at which a physical, chemical, electrical, or optical property changes). For example, as shown in FIG. 1, the sensor module 150 may include a fiber optic pressure/outflow sensor, mechanical deflection pressure/outflow sensor, strain gauge pressure/outflow sensor, piezoresistive pressure/outflow sensor, microelectromechanical (MEMS) pressure/outflow sensor, variable capacitance pressure/outflow sensor, flowmeters, and the like which sense an outflow from the beverage container 110 containing the consumable composition. Such an outflow over a given period of time may be associated with a di disposal of the consumable composition, depending on the outflow rate. For example, proper ingestion might be indicated by an outflow rate indicative of normal drinking, while improper disposal might be indicated by an outflow rate indicative of dumping the contents of the cup by upending the cup.

Operation 304E depicts calculating a flowrate of a dispensed consumable composition from a consumable composition dispenser over a time interval. For example, as shown in FIG. 1, the sensor module 150 may detect a rate of change of a volume of consumable composition contained in consumable composition storage 165 (e.g. a magnetic flowmeter measuring volume outflow from the consumable composition storage 165 over time), a rate of change of a mass of consumable composition contained in consumable composition storage 165 (e.g. a piezoresistive pressure sensor measuring the change in the mass present in the consumable composition storage 165 over time), and/or a rate of change of capacitance of consumable composition contained in consumable composition storage 165 (e.g. a capacitive sensor measuring the change of capacitance of the fluid in the beverage container over time).

Operation 306E depicts measuring a volume of a consumable composition contained in a consumable composition storage (e.g. optical detection). For example, as shown in FIG. 1, the sensor module 150 may include an optical or mechanical sensor which may sense a volume of the consumable composition contained in the consumable composition storage 165.

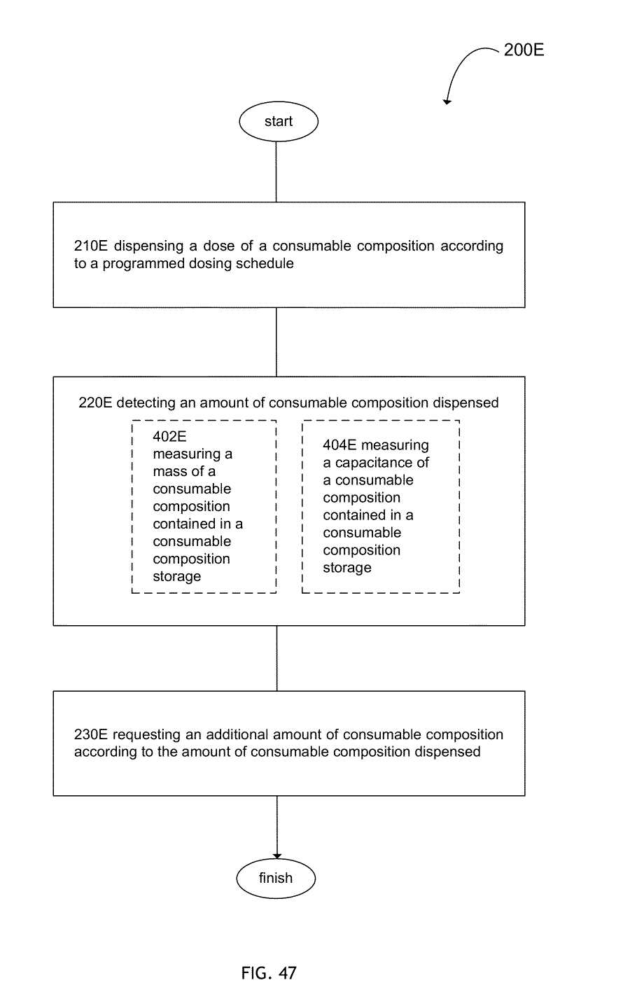

FIG. 47 illustrates alternative embodiments of the example operational flow 200E of FIG. 45 where the detecting operation 220E may include at least one additional operation. Additional operations may include an operation 402E and/or an operation 404E.

Operation 402E depicts measuring a mass of a consumable composition contained in a consumable composition storage (e.g. mechanical deflection pressure detection). For example, as shown in FIG. 1, the sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, and the like which may sense a mass of consumable composition contained in the consumable composition storage 165.

Operation 404E depicts measuring a capacitance of a consumable composition contained in a consumable composition storage (e.g. chemical field effect transistor detection). For example, as shown in FIG. 1, the sensor module 150 may include a capacitive concentration sensor which may sense a concentration of the consumable composition contained in the consumable composition storage 165.

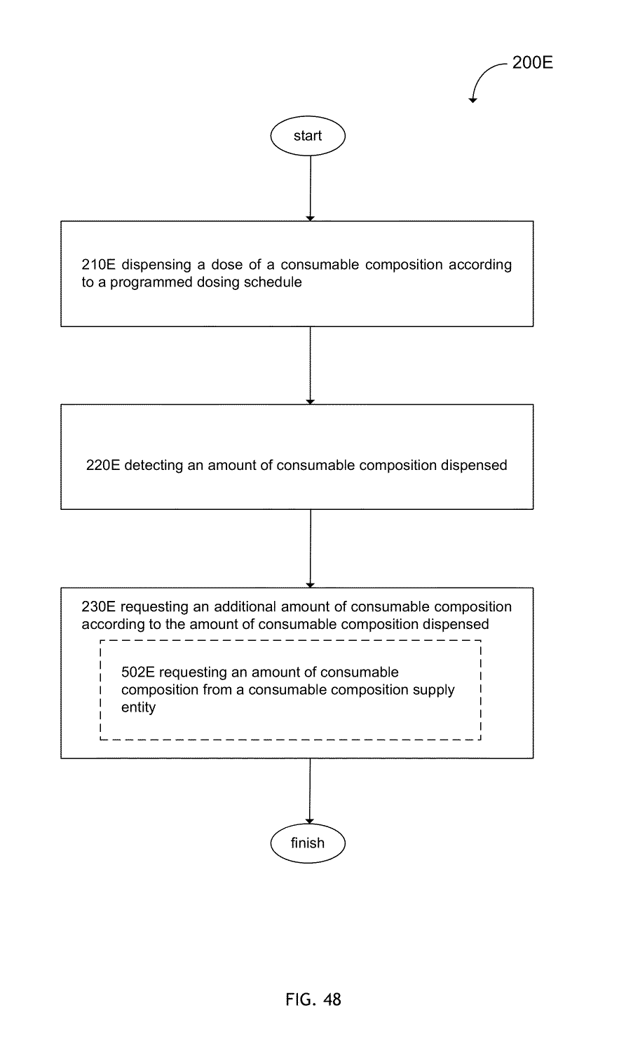

FIG. 48 illustrates alternative embodiments of the example operational flow 200 of FIG. 45 where the operation 230E may include at least one additional operation. Additional operations may include an operation 502E.

Operation 502E depicts requesting an additional amount of consumable composition from a consumable composition supply entity. For example, once detection logic 121 has determined that a threshold amount of consumable composition has been dispensed, the communications module 130 may transmit a request for an additional amount of consumable composition to a monitoring system 180 associated with an outside entity (e.g. a consumable composition supply entity).

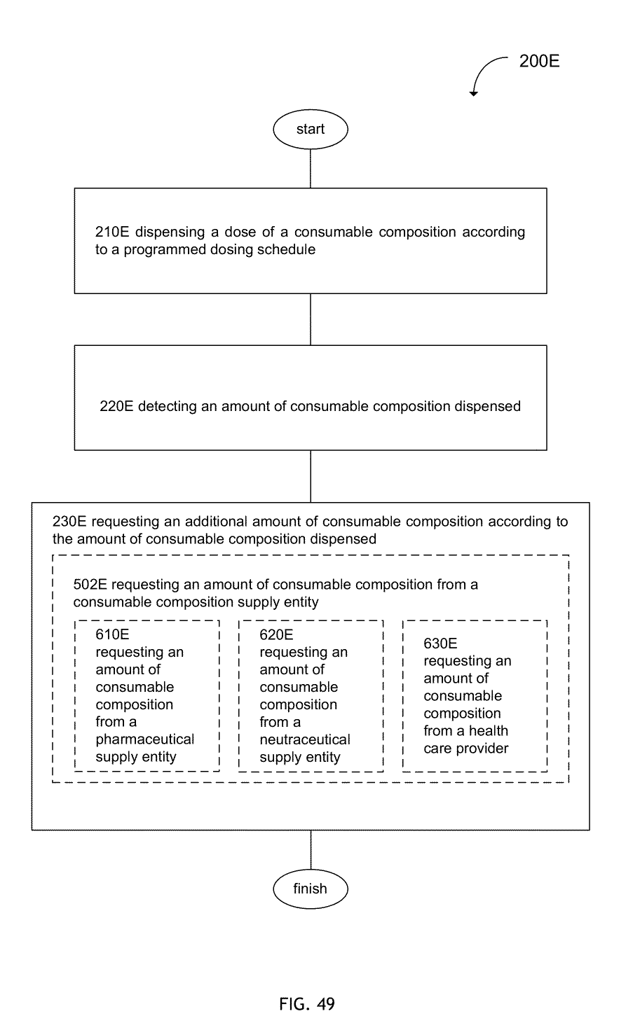

FIG. 49 illustrates alternative embodiments of the example operational flow 200E of FIG. 45 where the operation 230E may include at least one additional operation. Additional operations may include an operation 610E, an operation 620E and/or an operation 630E.

Operation 610E depicts requesting an amount of consumable composition from a pharmaceutical supply entity. For example, once detection logic 121 has determined that a threshold amount of a pharmaceutical composition has been dispensed, the communications module 130 may transmit a request for an additional amount of pharmaceutical composition to a monitoring system 180 associated with a pharmaceutical supply entity (e.g. an internet or telephonic ordering system for a pharmaceutical manufacturer or sales entity).

Operation 620E depicts requesting an amount of consumable composition from a pharmaceutical supply entity. For example, once detection logic 121 has determined that a threshold amount of a neutraceutical composition has been dispensed, the communications module 130 may transmit a request for an additional amount of neutraceutical composition to a monitoring system 180 associated with a neutraceutical supply entity (e.g. an internet or telephonic ordering system for a neutraceutical manufacturer or sales entity).

Operation 630E depicts requesting an amount of consumable composition from a health care provider. For example, once detection logic 121 has determined that a threshold amount of a neutraceutical composition has been dispensed, the communications module 130 may transmit a request for an additional amount of consumable composition to a monitoring system 180 associated with a health care provider (e.g. a nurses station for a hospital patient, a caregiver in an assisted living facility, a prescribing physician, and the like).

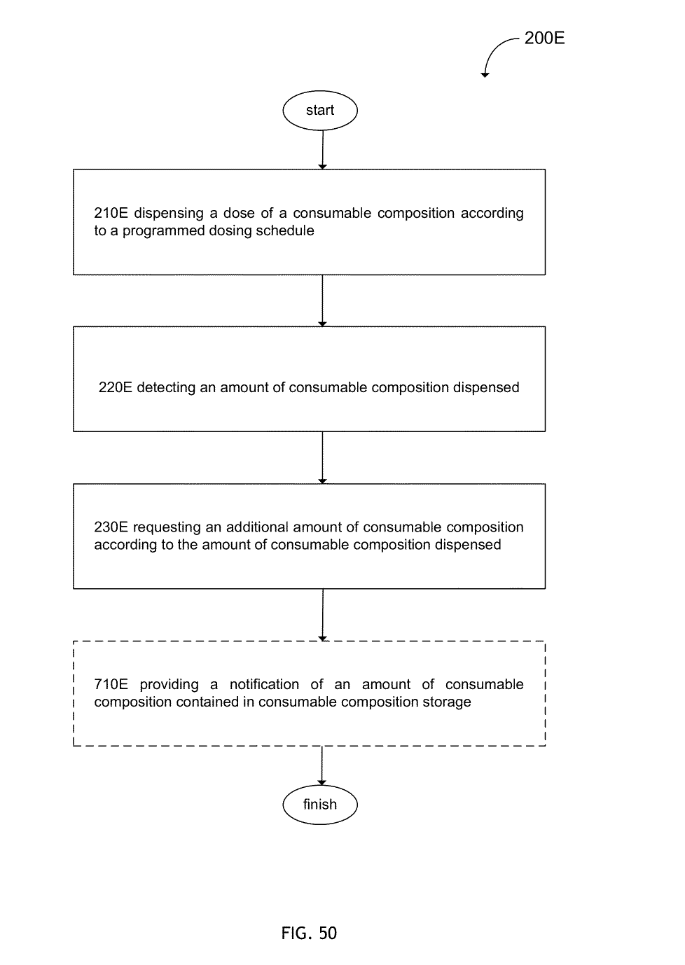

FIG. 50 illustrates an an example embodiment where the example operational flow 200E of FIG. 45 may include at least one additional operation. Additional operations may include an operation 702E.

Operation 702E depicts providing a notification of an amount of consumable composition dispensed. For example, as shown in FIG. 1, the user interface logic 123 may cause the notification module 142 of the user interface 140 to provide a notification of an amount of the consumable composition that has been dispensed. The notification may include a visual (e.g. flashing LED, LCD display screen, etc.), audible (e.g. speaker assembly), or tactile (e.g. vibratory) notification.

### Application Ser. No. 12/002,794 (0107A-002-005E1-000000) & Application Ser. No. 12/004,094 (0107A-002-005E2-000000)

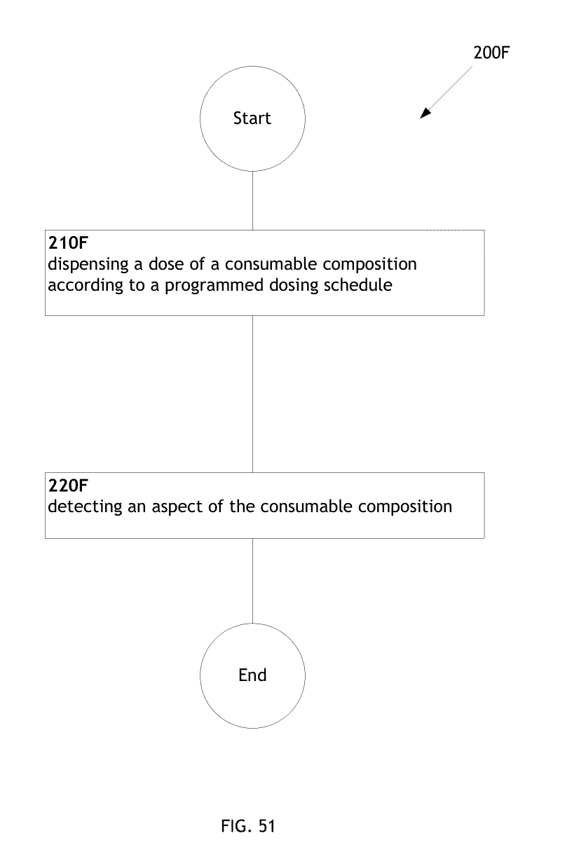

FIG. 51 illustrates an operational flow 200F representing example operations related to programmed dispensing of consumable compositions. In FIG. 51 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200F moves to a dispensing operation 210F, where dispensing a dose of a consumable composition according to a programmed dosing schedule may occur (e.g. distributing a pharmaceutical composition in accordance with a user or physician-defined regimen). For example, as shown in FIG. 1, integrated consumable composition dispenser module 160, and or external consumable composition dispenser module 170 may distribute doses (e.g. 30 mg) of a consumable composition (e.g. an anti-depressant, such as Paroxotene) into a beverage container 110 (e.g. a cup).

Then, in a detecting operation 220F, detecting an aspect of the consumable composition may occur (e.g. capacitive concentration detection). For example, as shown in FIG. 1, an aspect of the consumable composition may be detected by detection logic 121 receiving data from sensing logic 124 operably coupled to a sensor module 150, communications logic 122 operably coupled to a communications module 130, user interface logic 123 operably coupled to a user interface 140 or dispensing logic 125 operably coupled to a dispenser module 160, 170 and/or sterilization logic 188 operably coupled to a sterilization module 186, 187.

The aspect of the consumable composition may include, but is not limited to, an amount of consumable composition dispensed into the beverage container 110, an amount of consumable composition present in the beverage container 110, an amount of the composition removed from the beverage container 110, an identity of the consumable composition, an identity of a user 190, a user input, a programmed schedule for dispensing the consumable composition, and the like.

The aspect of the consumable composition may be communicated via the communication module 130 to an outside entity. The outside entity may be a monitoring system 180 or a controllable device 185 which may be controlled according to the aspect of the consumable composition.

Monitoring system 180 may also transmit a notification (e.g. a notification that a programmed dosing schedule has been transmitted to the system 100) to a communications device 181 (e.g. a cell phone, satellite phone, Blackberry®, and/or land-line phone), e-mail system 182 (e.g. an IMAP, POP3, SMTP, and/or HTTP e-mail server having an e-mail account associated with a user 190), text messaging system 183 (e.g. SMS system in GSM) and/or a computing system 184 (e.g. a personal digital assistant (PDA), personal computer, laptop, music player and/or gaming device).

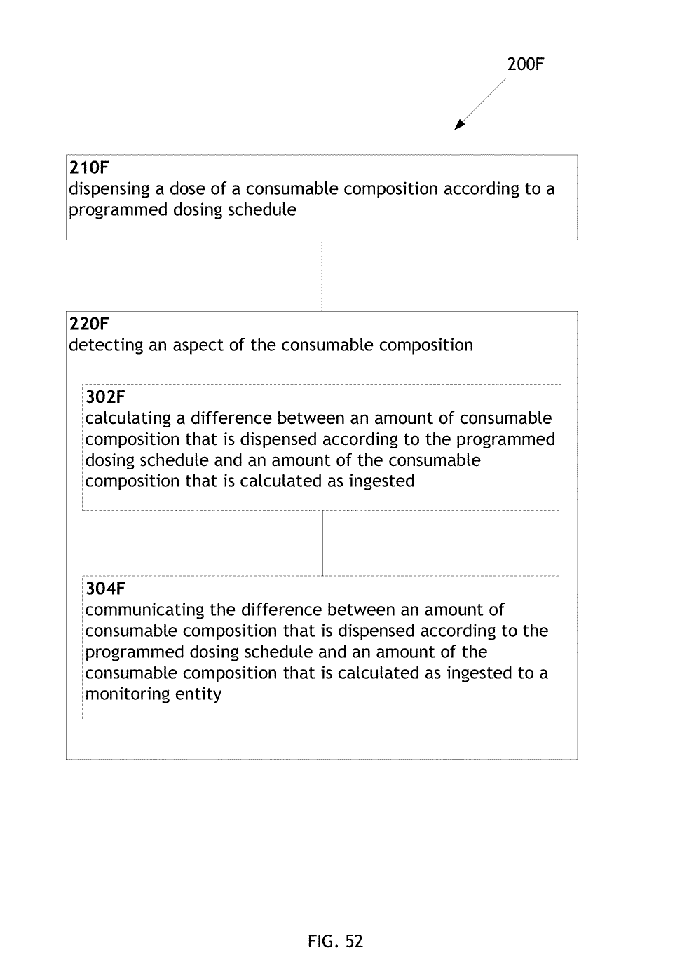

FIG. 52 illustrates alternative embodiments of the example operational flow 200 of FIG. 51 where the detecting operation 220F may include at least one additional operation. Additional operations may include an operation 302F, and/or an operation 304F.

At the operation 302F, calculating a difference between an amount of consumable composition that is dispensed according to the programmed dosing schedule and an amount of the consumable composition that is calculated as ingested may occur (e.g. 60 mg dispensed−40 mg calculated as ingested=20 mg not ingested). For example, as shown in FIG. 1, the sensor logic 124 may provide data regarding ingestion of the consumable composition obtained from the sensor module 150 to the detection logic 121. The detection logic may calculate an amount of consumable composition that may have been ingested. The dispensing logic 125 may provide the amount of consumable composition either previously dispensed by or currently remaining in the dispensing module 160, 170 to the detection logic 121. The detection logic 121 may compare the amount calculated to have been ingested to the amount dispensed or remaining to be dispensed so as to verify user 190 compliance with a programmed dosing schedule.

Further, at the operation 304F, communicating the difference between an amount of consumable composition that is dispensed according to the programmed dosing schedule and an amount of the consumable composition that is calculated as ingested to a monitoring entity may occur (e.g. 20 mg not ingested). For example, as shown in FIG. 1, the communications module 130 may transmit a notification to a monitoring system 180 when an amount of consumable composition calculated as ingested does not correspond to an amount dispensed, thereby indicating non-compliance with a programmed dosing schedule.

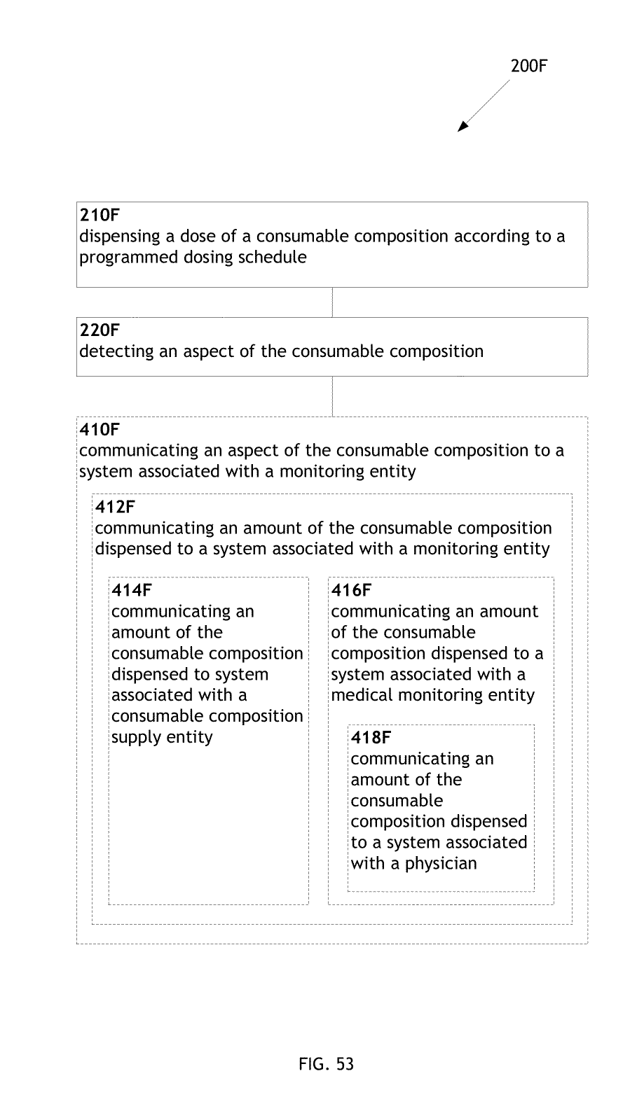

FIG. 53 illustrates an example embodiment where the example operational flow 200 of FIG. 51 may include at least one additional operation. Additional operations may include an operation 410F.

At operation 410F, communicating an aspect of the consumable composition to a system associated with a monitoring entity may occur (e.g. a users failure to ingest an amount of a pharmaceutical composition may be communicated to a physician). For example, as shown in FIG. 1, the communications module 130 may transmit data regarding an aspect of the consumable composition to a monitoring system 180.

FIG. 53 further illustrates an example embodiment where the example operation 410F may include at least one additional operation. Additional operations may include an an operation 412F, an operation 414F, an operation 416F, and/or an operation 418F.

At the operation 412F, communicating an amount of the consumable composition dispensed to a system associated with a monitoring entity may occur. Further, at the operation 414F, communicating an amount of the consumable composition dispensed to system associated with a consumable composition supply entity (e.g. an online ordering system for a pharmaceutical supply company). Further, at the operation 416F, communicating an amount of the consumable composition dispensed to a system associated with a medical monitoring entity may occur (e.g. a medical alert system for an assisted living facility). Further, at the operation 418F, communicating an amount of the consumable composition dispensed to a system associated with a physician may occur (e.g. a local area network (LAN) of a physician's clinic).

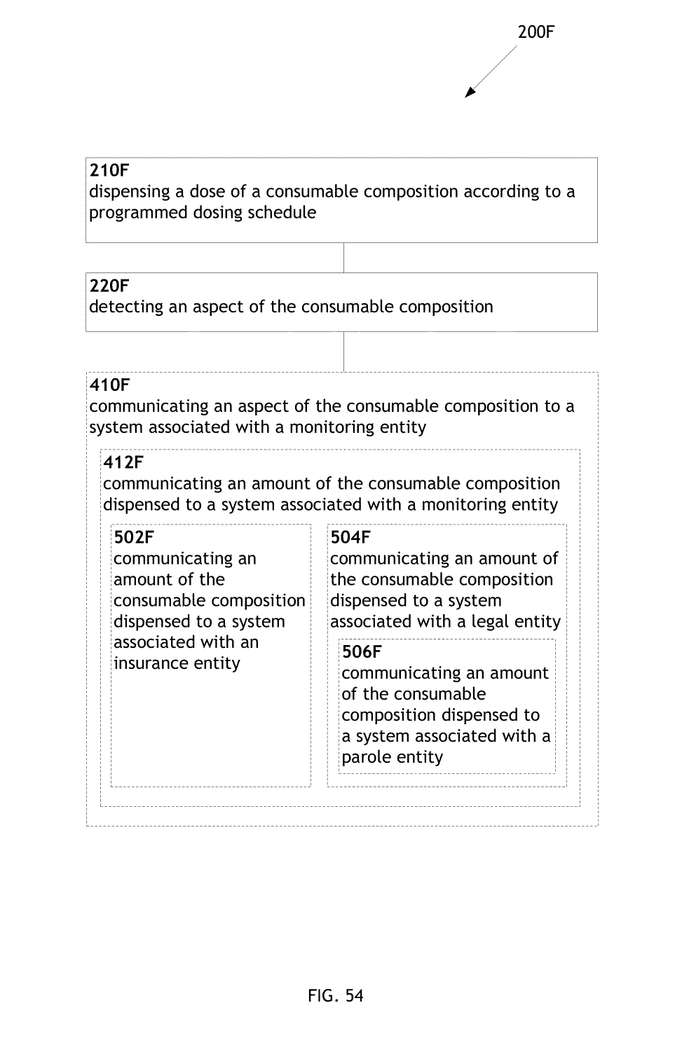

FIG. 54 illustrates alternative embodiments where the communicating operation 412F of FIG. 53 may include at least one additional operation. Additional operations may include an operation 502F, an operation 504F, and/or an operation 506F.

The operation 502F, communicating an amount of the consumable composition calculated as ingested to a system associated with an insurance entity may occur (e.g. a LAN of an insurance underwriting company). Further, at the operation 504F, communicating an amount of the consumable composition calculated as ingested to a system associated with a legal entity may occur (e.g. a court clerk). Further, at the operation 506F, communicating an amount of the consumable composition calculated as ingested to a system associated with a parole entity may occur (e.g. a parole officer).

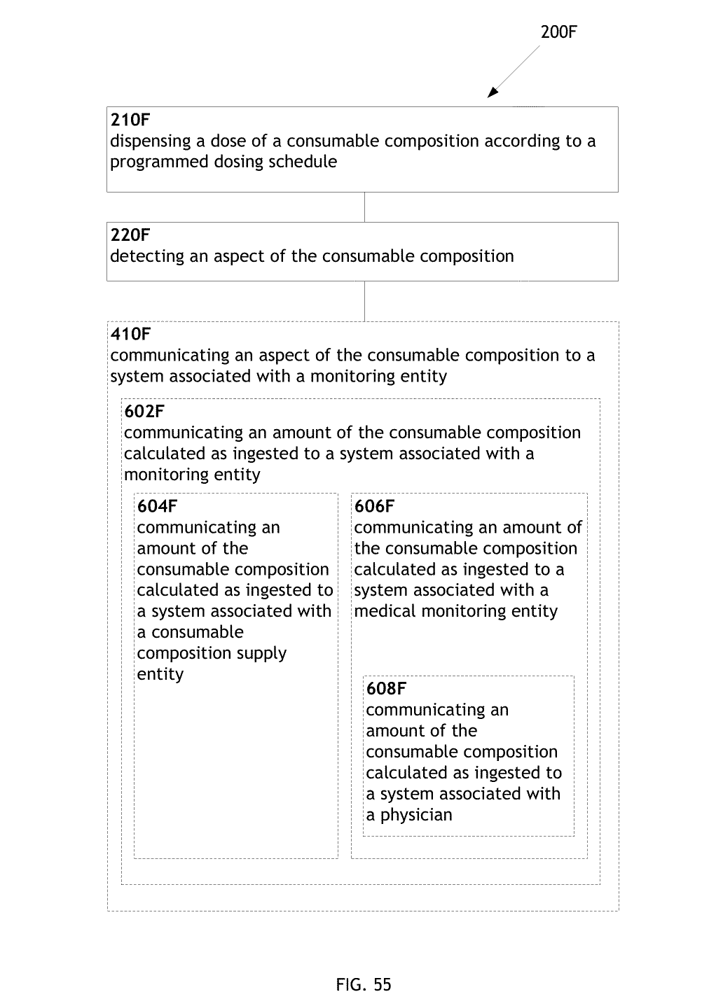

FIG. 55 illustrates alternative where the communicating operation 410F of FIG. 53 may include at least one additional operation. Additional operations may include an operation 602F, an operation 604F, an operation 606F, and/or an operation 608F.

At the operation 602F, communicating an amount of the consumable composition calculated as ingested to a system associated with a monitoring entity may occur (e.g. a user has complied with a programmed dosing schedule for the consumable composition). For example, as shown in FIG. 1, the sensing logic 124 may be operably coupled to a sensor module 150 and may provide sensor data to detection logic 121. Sensor module 150 may include a biometric sensor which senses the presence of saliva, perspiration, sebum and the like, either on the surface of the beverage container 110 or as a component of the contents therein. Sensor module 150 may include an accelerometer, inertial motion sensor and the like, which may sense the movement of the beverage container 110. Sensor module 150 may include a a fiber optic pressure sensor, mechanical deflection pressure sensor, strain gauge pressure sensor, piezoresistive pressure sensor, microelectromechanical (MEMS) pressure sensor, variable capacitance pressure sensor, and the like which senses a pressure applied to the beverage container 110. Sensor module 150 may include a capacitive concentration sensor which may sense a concentration of the consumable composition present in the beverage container 110. Sensor module 150 may include an inclinometer and the like. The degree of incline of the beverage container 110 may indicate a proper ingestion or an improper disposal of the consumable composition, depending on the degree of incline.

Further, at the operation 604F, communicating an amount of the consumable composition calculated as ingested to a system associated with a consumable composition supply entity may occur. Further, at the operation 606F, communicating an amount of the consumable composition calculated as ingested to a system associated with a medical monitoring entity may occur. Further, at the operation 608F, communicating an amount of the consumable composition calculated as ingested to a system associated with a physician may occur.

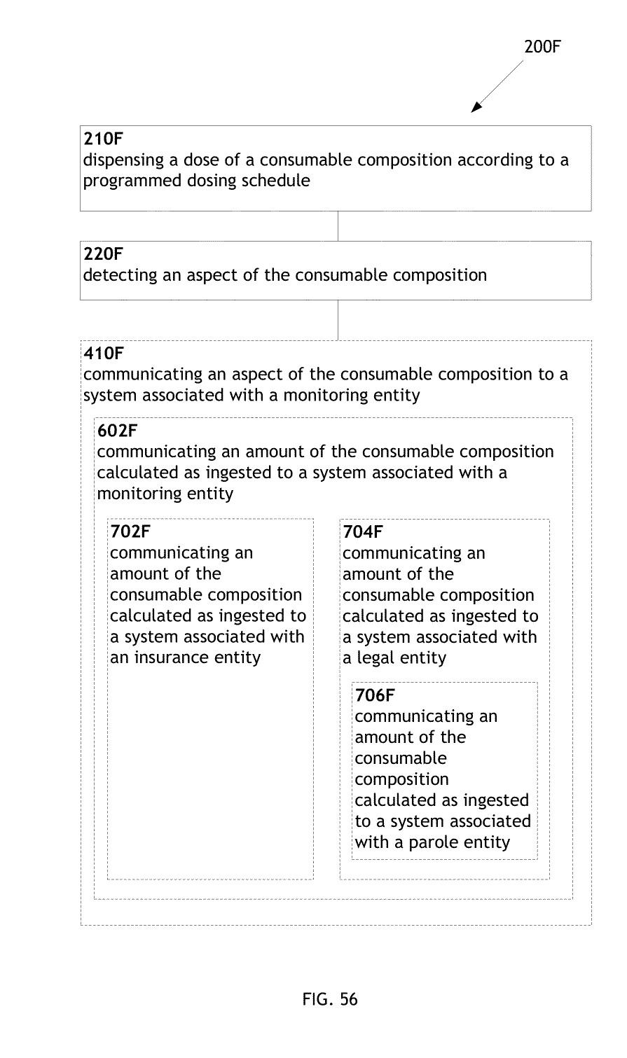

FIG. 56 illustrates alternative embodiments where the communicating operation 410F of FIG. 53 may include at least one additional operation. Additional operations may include an operation 702F, an operation 704F and/or an operation 706F.

At the operation 702F, communicating an amount of the consumable composition calculated as ingested to a system associated with an insurance entity may occur. Further, at the operation 704F, communicating an amount of the consumable composition calculated as ingested to a system associated with a legal entity may occur. Further, at the operation 706F, communicating an amount of the consumable composition calculated as ingested to a system associated with a parole entity may occur.

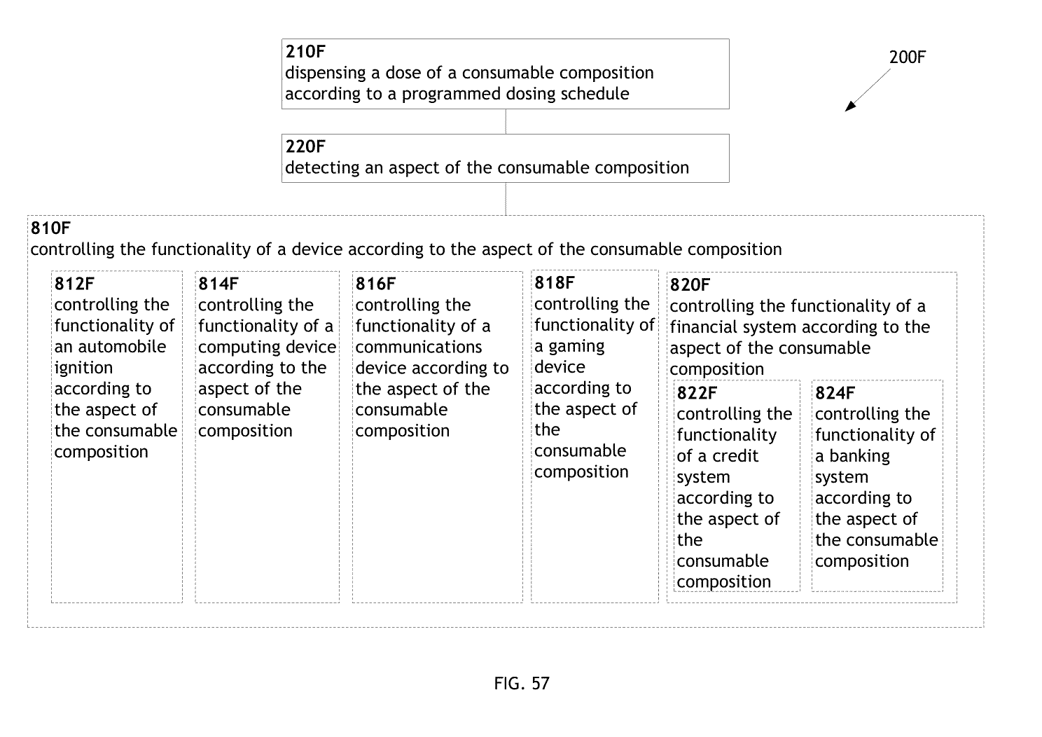

FIG. 57 illustrates an example embodiment where the example operational flow 200F of FIG. 51 may include at least one additional operation. Additional operations may include an operation 810F.

At an operation 810F, controlling the functionality of a device according to an aspect of the consumable composition may occur (e.g. controlling the functionality of an automobile ignition according to an amount of consumable composition ingested). For example, as shown in FIG. 1, the communications module 130 may transmit control data to a controllable device 185 according to an aspect of the consumable composition.

FIG. 57 further illustrates an example embodiment where the example operation 810F may include one or more additional operations. Additional operations may include an operation 812F, an operation 814F, an operation 816F, an operation 818F, an operation 820F, an operation 822F, and/or an operation 824F.

At the operation 812F, controlling the functionality of an automobile ignition according to the aspect of the consumable composition may occur (e.g. automobile will not start unless an amount of the consumable composition has been ingested). At the operation 814, controlling the functionality of a computing device according to the aspect of the consumable composition may occur (e.g. a personal computer may prevent logging on unless an amount of a consumable composition has been calculated as ingested). For example, as shown in FIG. 1, the controllable device 185 may include a personal digital assistant (PDA), personal computer, laptop, and the like.

At the operation 816F, controlling the functionality of a communications device according to the aspect of the consumable composition may occur (e.g. a cell phone may prevent outgoing calls unless an amount of a consumable composition has been calculated as ingested). For example, as shown in FIG. 1, the controllable device 185 may include a cell phone, satellite phone, Blackberry®, land-line phone, and the like.

At the operation 818F, controlling the functionality of a gaming device according to the aspect of the consumable composition may occur (e.g. a gaming system will not power on unless an amount of a consumable composition has been calculated as ingested). For example, as shown in FIG. 1, the controllable device 185 may include gaming devices such as those manufactured by Sony®, Microsoft®, Nintendo®, and the like.

At the operation 820F, controlling the functionality of a financial system according to the aspect of the consumable composition may occur (e.g. access to a banking network may be denied unless an amount of a consumable composition is calculated as ingested). Further, at the operation 822F, controlling the functionality of a credit system according to the aspect of the consumable composition may occur (e.g. a credit card may be disabled from making purchases unless an amount of a consumable composition has been calculated as ingested). For example, as shown in FIG. 1, the controllable device 185 may include a credit card, online credit account, and the like. Further, at the operation 824F, the controlling the functionality of a banking system according to the aspect of the consumable composition may occur (e.g. a debit card may be disabled from making purchases unless an amount of a consumable composition has been calculated as ingested). For example, as shown in FIG. 1, the controllable device 185 may include a bank debit card, an automatic teller machine (ATM), an online bank account, and the like.

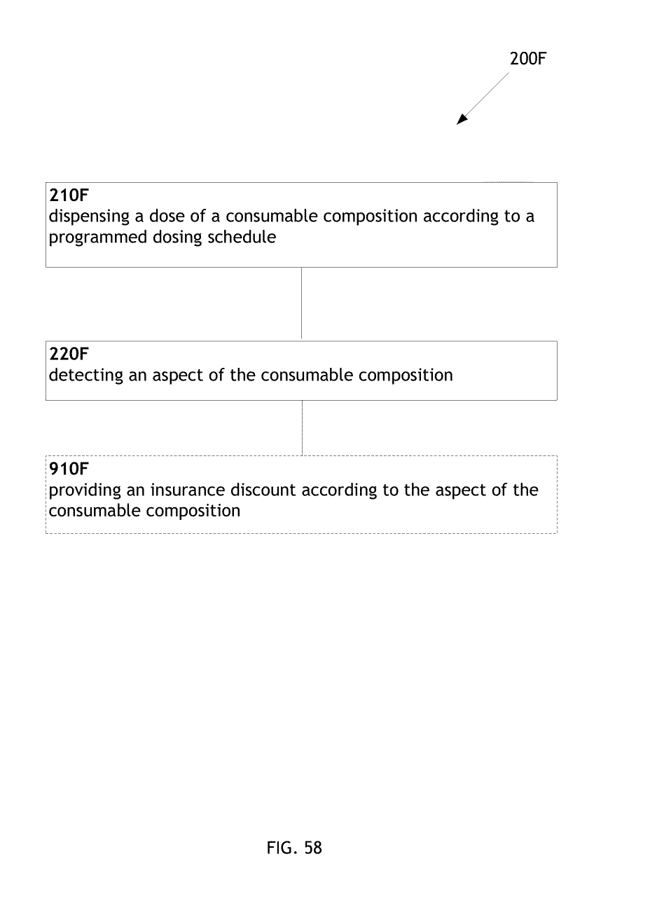

FIG. 58 illustrates an example embodiment where the operational flow 200F of FIG. 51 may include at least one additional operation. Additional operations may include an operation 910F.

At operation 910F, providing an insurance discount according to the aspect of the consumable composition may occur (e.g. a reduced health insurance premium may be provided when a consistent record of ingesting a consumable composition is maintained). For example, as shown in FIG. 1, the monitoring system 180 may be associated with an insurance entity. The communications module 130 may communicate an aspect of the consumable composition (e.g. dispensation or ingestion of the consumable composition by a user 190) to the monitoring system 180 associated with the insurance entity. The insurance entity may then provide an insurance discount to the user.

### Application Ser. No. 12/006,252 (0107A-002-005F1-000000)

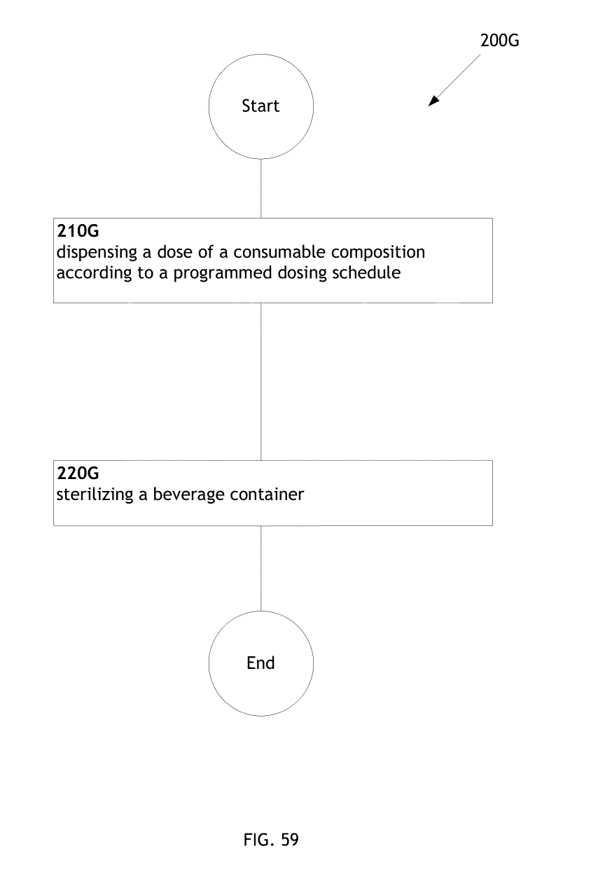

FIG. 59 illustrates an operational flow 200G representing example operations related to programmed dispensing of consumable compositions. In FIG. 59 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200G moves to a dispensing operation 210G, where dispensing a dose of a consumable composition according to a programmed dosing schedule may occur (e.g. distributing a pharmaceutical composition in accordance with a user or physician-defined regimen). For example, as shown in FIG. 1, integrated consumable composition dispenser module 160, and/or external consumable composition dispenser module 170 may distribute doses (e.g. 30 mg) of a consumable composition (e.g. Paxil) into a beverage container 110 (e.g. a cup).

Then, in a sterilization operation 220G, sterilizing at least a portion of a beverage container may occur (e.g. the extermination or deactivation of at least one transmissible agent such as fungi, bacteria, viruses, prions, spores, and the like from the surface or contents of the beverage container 110). For example, as shown in FIG. 1, an integrated sterilization module 187 may be operably coupled to the beverage container 110. Further, the beverage container 110 may be placed in proximity to an external sterilization module 186. The integrated sterilization module 187 and/or the external sterilization module 186 may be operably coupled to sterilization logic 188 which may be configured to cause the integrated sterilization module 187 and/or the external sterilization module 186 to sterilize the beverage container. Further, the external sterilization module 186 may be controlled internally and independent from the sterilization logic 188. The manner, duration, and/or scheduling of the sterilization may be selected according to a sterilization parameter such as: a time interval since a prior sterilization (e.g. sterilize every 3 hours), a user input (e.g. a “sterilize” input from user input 146), an amount of consumable composition in a consumable composition dispenser (e.g. sterilize when internal consumable composition dispenser module 160 is empty), a time interval in which the beverage container 110 remains in a substantially stationary position (e.g. sterilize with a ultraviolet sterilization when an accelerometer sensor in sensor module 150 indicates the beverage container has not be moved for 5 hours and sterilize with chemical sterilization when the beverage container 110 has not been moved for 10 hours), an identity of a first consumable composition previously dispensed into the beverage container 110 (e.g. sterilize for 10 seconds for solid based consumable compositions and sterilize for 30 seconds for liquid-based consumable compositions), an identity of a second consumable to be dispensed into the beverage container 110 in the future (sterilize for 5 minutes prior to dispensing a second consumable composition which is contraindicated for a previously dispensed consumable composition), a geographic location (e.g. multiple sterilizations when beverage container is determined to be in an undeveloped geographic region), ambient environmental conditions (e.g. extended sterilization when temperature, pressure, and humidity conditions are conducive to transmissible agents), programmed sterilization schedule (e.g. sterilize according to programmed consumable composition dosing schedule), and/or a user identity (e.g. sterilize between uses by different users).

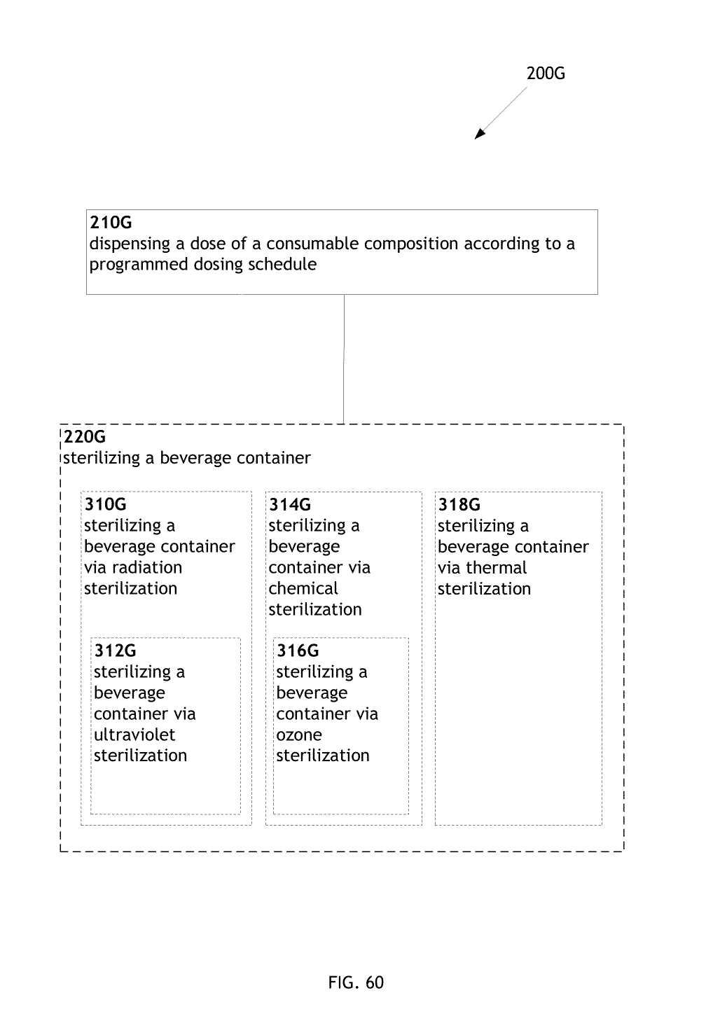

FIG. 60 illustrates alternative embodiments where the sterilizing operation 220G may include at least one additional operation. Additional operations may include an operation 310G, an operation 312G, an operation 314G, an operation 316G, and/or an operation 318G.

At the operation 310G, sterilizing a beverage container via radiation sterilization may occur (e.g. irradiating the beverage container 110 with a dose of gamma-ray radiation). For example, the integrated sterilization module 187 and/or the external sterilization module 186 may be a radiation sterilization module that may generate non-ionizing radiation (e.g. ultraviolet, visible light, infrared), ionizing radiation (e.g. x-rays, gamma rays) and/or sub-atomic particle radiation (e.g. alpha radiation, beta radiation, neutron radiation). The sterilization logic 188 may cause the integrated sterilization module 187 and/or the external sterilization module 186 to irradiate the beverage container 110.

At the operation 312G, sterilizing a beverage container via ultraviolet sterilization may occur (e.g., illumination of an ultraviolet lamp). For example, as shown in FIG. 1, the integrated sterilization module 187 and/or the external sterilization module 186 may be an ultraviolet sterilization module. Sterilization logic 188 may cause the integrated sterilization module 187 and/or the external sterilization module 186 to emit a dose of ultraviolet radiation towards at least a portion of the beverage container 110.

At the operation 314G, sterilizing a beverage container via chemical sterilization may occur (e.g. immersion of the beverage container 110 in a solution containing a surfactant). For example, the integrated sterilization module 187 and/or the external sterilization module 186 may be a chemical sterilization module that may dispense a chemical sterilization agent (e.g. ozone, ethylene oxide, chlorine bleach, surfactants, glutaraldehyde, formaldehyde, ortho-phthalaldehyde, hydrogen peroxide, iodine, sodium hydroxide). The chemical sterilization agent may be allowed to contact at least a portion of the surface of the beverage container 110. Further, the external sterilization module 186 may comprise a liquid bath or gas chamber which may receive the beverage container 110. The sterilization logic 188 may cause the integrated sterilization module 187 and/or the external sterilization module 186 to dispense the chemical sterilization agent.

At the operation 316G, sterilizing a beverage container via ozone sterilization may occur (e.g. dispensing an amount of ozone gas into a gas chamber containing a beverage container). For example, as shown in FIG. 1, the integrated sterilization module 187 and/or the external sterilization module may be an ozone sterilization module. Sterilization logic 188 may cause the integrated sterilization module 187 and/or the external sterilization module 186 to generate and/or dispense a quantity of ozone.

At the operation 318G, sterilizing a beverage container via thermal sterilization may occur (e.g. forced-ventilation dry heating of a beverage container). For example, as shown in FIG. 1, the integrated sterilization module 187 and/or the external sterilization module 186 may be a thermal sterilization module and may comprise a heating element (e.g. ceramic coated wire, heat lamp, positive thermal coefficient (PTC) ceramics) which may irradiate at least a portion of the beverage container 110 with thermal energy. Further, the integrated sterilization module 187 and/or the external sterilization module 186 may comprise a steam generation mechanism (e.g. an autoclave) which may generate and/or dispense steam which may contact at least a portion of the beverage container. The integrated sterilization module 187 and/or the external sterilization module 186 may comprise a pressurization mechanism such that at least a portion of the beverage container may be maintained at an elevated pressure before, during, and/or after thermal sterilization.

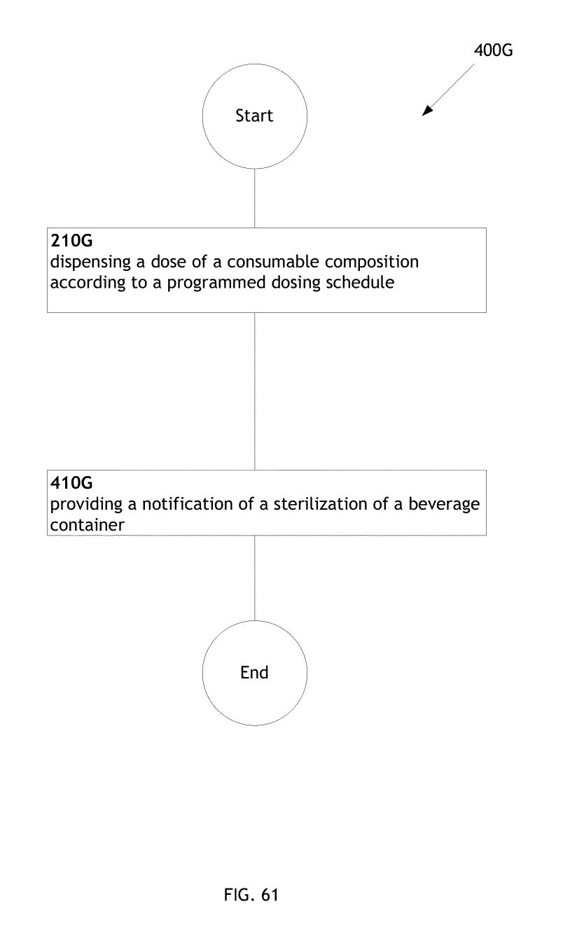

FIG. 61 illustrates an operational flow 400G representing example operations related to programmed dispensing of consumable compositions.

At operations 210G, dispensing a dose of a consumable composition according to a programmed dosing schedule may occur (e.g. distributing a pharmaceutical composition in accordance with a user or physician-defined regimen). For example, as shown in FIG. 1, integrated consumable composition dispenser module 160, and/or external consumable composition dispenser module 170 may distribute doses (e.g. 30 mg) of a consumable composition (e.g. Paxil) into a beverage container 110 (e.g. a cup).

At operation 410G where providing a notification of a sterilization of a beverage container may occur (e.g. illuminating a green LED upon detection of a thermal sterilization). For example, as shown in FIG. 1, sterilization logic 188 may provide sterilization data to detection logic 121. Detection logic 121 may provide notification data to user interface logic 123. User interface logic 123 may cause the notification module 142 of the user interface 140 to provide a notification of a sterilization of the beverage container 110 to a user 190.

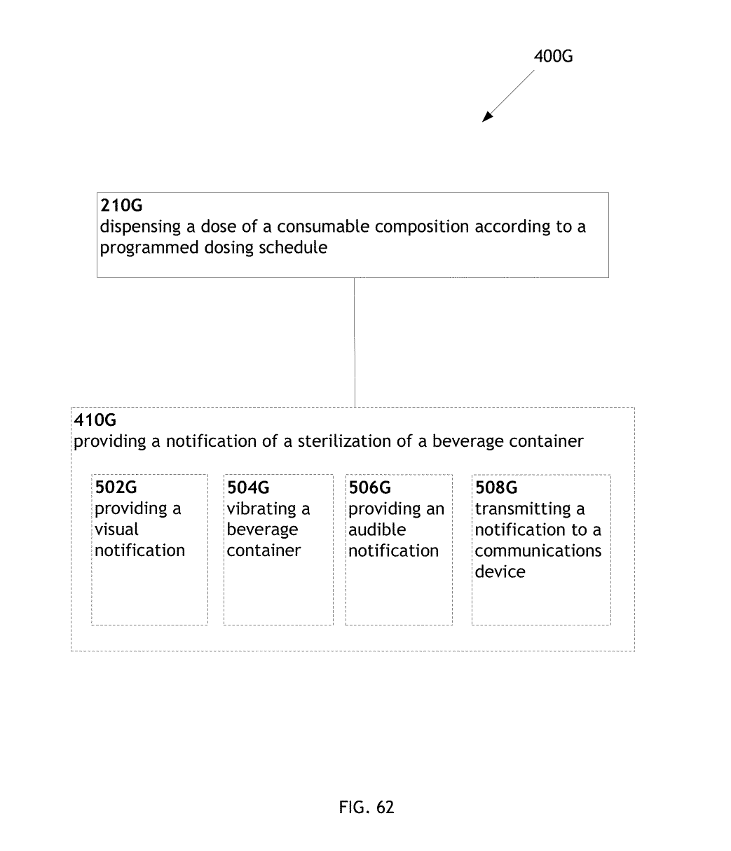

FIG. 62 illustrates alternative embodiments of the example operational flow 400G of FIG. 61 where the notification operation 410G may include at least one additional operation. Additional operations may include an operation 502G, an operation 504G, an operation 506G and/or an operation 508G.

At the operation 502G, providing a visual notification may occur (e.g. a graphical notice on a display screen). For example, as shown in FIG. 1, the notification module 142 of the user interface 140 may be a visual notification module and may include illuminated LEDs, an LCD or LCoS display screen displaying text, images and/or icons, and the like.

At the operation 504G, vibrating a beverage container may occur (e.g. movement of an asymmetrical mass). For example, as shown in FIG. 1, the notification module 142 of the user interface 140 may be a vibrating notification module and may include an asymmetrical rotating mass operably coupled to a motor. Upon application of power to the motor by user interface logic 123, the mass may be rotated such that it induces vibration in the beverage container 110. Further, the notification module 142 of the user interface 140 may include a periodically oscillating mass operably coupled to a spring mechanism. The user interface logic may cause a spring support (e.g. a lever) to retract allowing for the oscillation of the mass.

At the operation 506G, providing an audible notification may occur (e.g. an audio broadcast of a ring tone). For example, as shown in FIG. 1, the notification module 142 of the user interface 140 may be an audible notification module and may include a speaker assembly, and the like. The user interface logic 123 may cause the notification module 142 to emit an audible notification (e.g. a mechanical ringing of a bell, a synthesized or recorded vocal notification such as “Your beverage container has been sterilized by ozone sterilization”, an electronic beep).

At the operation 508G, transmitting a notification to a communications device may occur (e.g. placing an automated call to a user's home phone). For example, as shown in FIG. 1, the communications module 130 may transmit a sterilization notification (e.g. a text message, an instant message, an automated voicemail, an automated phone call) to a monitoring system 180 linked to a communications device 181. The communications device 181 may include a cell phone, satellite phone, Blackberry®, land-line phone, and the like.

Monitoring system 180 may relay a notification (e.g. a notification that a sterilization of the beverage container 110 has occurred) received from communications module 130 to a communications device 181 (e.g. a cell phone, satellite phone, Blackberry®, and/or land-line phone), e-mail system 182 (e.g. an IMAP, POP3, SMTP, and/or HTTP e-mail server having an e-mail account associated with a user 190), text messaging system 183 (e.g. SMS system in GSM) and/or a computing device 184 (e.g. a personal digital assistant (PDA), personal computer, laptop, music player and/or gaming device).

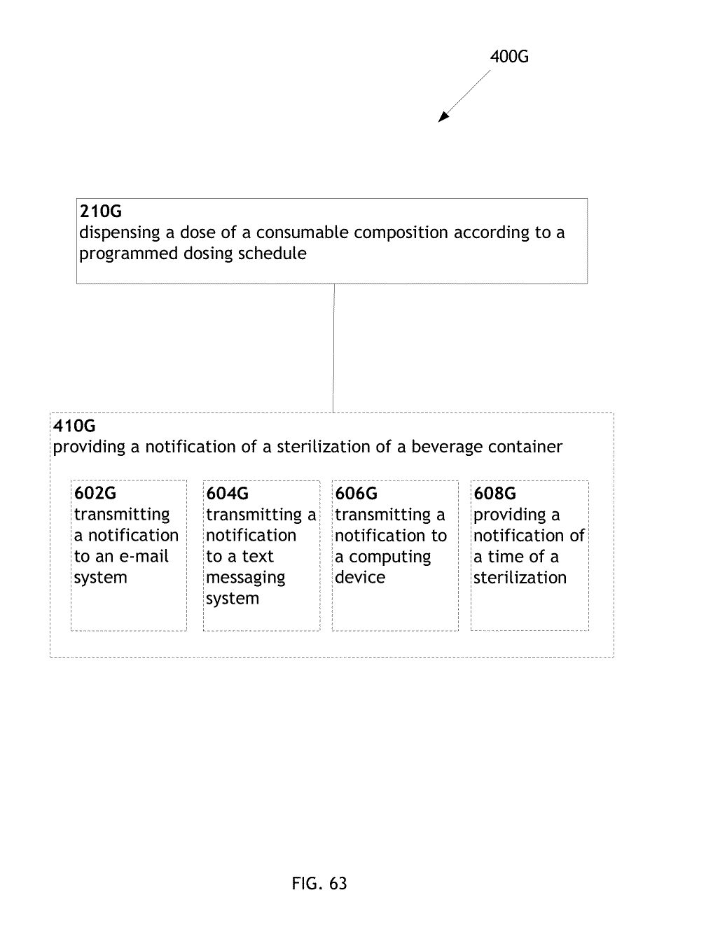

FIG. 63 illustrates alternative embodiments of the example operational flow 400G of FIG. 61 where the notification operation 410G may include at least one additional operation. Additional operations may include an operation 602G, an operation 604G, an operation 606G, and/or an operation 608G.

At the operation 602G, transmitting a notification to an e-mail system may occur (e.g an e-mail to an IMAP, POP3, SMTP, and/or HTTP e-mail server having an e-mail account associated with a user 190). For example, as shown in FIG. 1, the communications module 130 may transmit a sterilization notification to a monitoring system 180 linked to an e-mail system 182.

At the operation 604G, transmitting a notification to a text messaging system may occur (e.g. an automated text message to a user's cell phone). For example, as shown in FIG. 1, the communications module 130 may transmit a notification to a monitoring system 180 linked to a text messaging system 183 such as an SMS system in GSM.

At the operation 606G, transmitting a notification to a computing device may occur (e.g. an automated instant message to a user's computer). For example, as shown in FIG. 1, the communications module 130 may transmit a notification (e.g. an instant message to a personal computer, an instant message via an online gaming system, such as the Xbox Live® system marketed by the Microsoft® Corporation, an instant message to a music player via a music download service, such as the iTunes® service marketed by Apple® Inc.) to a monitoring system 180 linked to a computing device 184. The computing device 184 may include a personal digital assistant (PDA), personal computer, laptop, music player, gaming device, and the like capable of receiving instant messages from IM providers such as Microsoft®.

At the operation 608G, providing a notification of a time of a sterilization may occur (e.g. a broadcasted audible notification that “A thermal sterilization occurred at 3:30 pm). For example, as shown in FIG. 1, the user interface logic 123 may cause the notification module 142 of the user interface 140 to provide a notification of a time of sterilization of the beverage container 110. The notification module 142 may provide a time interval (e.g. 1 hour, 15 minutes) since the most recent sterilization or until an upcoming sterilization. The notification module may further provide a notification if a time interval in excess of a threshold sterilization window has elapsed where another sterilization of the beverage container 110 is required before its reuse.

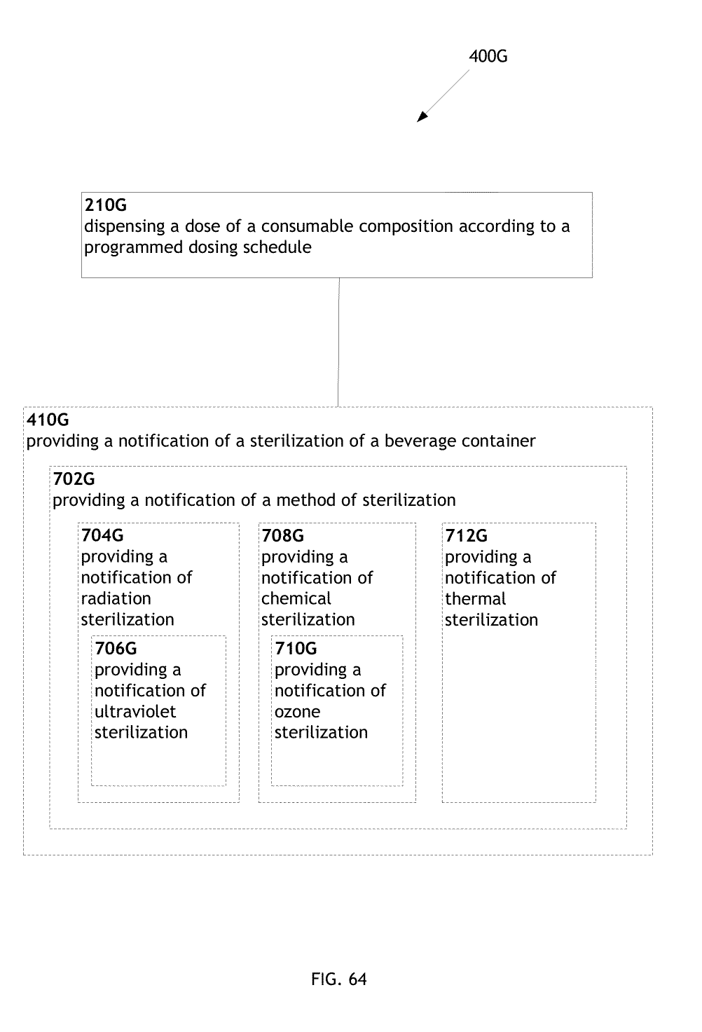

FIG. 64 illustrates alternative embodiments of the example operational flow 400G of FIG. 61 where the notification operation 410G may include at least one additional operation. Additional operations may include an operation 702G, an operation 704G, an operation 706G, an operation 708G, and/or an operation 710G.

At the operation 702G, providing a notification of a method of sterilization may occur (e.g. an LCD display presenting a text based message stating “An ultraviolet sterilization has been completed”). For example, as shown in FIG. 1, the user interface logic 123 may cause the notification module 142 of the user interface 140 to provide a notification of a method of sterilization of the beverage container 110 to a user 190. Further, the communications logic 122 may cause the communications module 130 to transmit a notification that a sterilization has been detected by the sensor module 150 to the monitoring system 180.

Further, at the operation 704G, providing a notification of radiation sterilization may occur (e.g. an e-mail to an e-mail account associated with a user 190 indicating that an ultraviolet sterilization of the beverage container 110 has occurred). For example, user interface logic 123 may cause the notification module 142 of the user interface 140 to provide a notification that radiation sterilization of the beverage container 110 has occurred. Further, the communications logic 122 may cause the communications module 130 to transmit a notification that radiation sterilization of the beverage container 110 has occurred.

Further, at the operation 706G, providing a notification of ultraviolet sterilization may occur (e.g. a UV-sensitive indicator patch on the beverage container 110 changes color). For example, user interface logic 123 may cause the notification module 142 of the user interface 140 to provide a notification that the integrated sterilization module 187 has emitted a dose of ultraviolet radiation. Further, the communications logic 122 may cause the communications module 130 to transmit a notification to the monitoring system 180 that an exposure of the beverage container 110 to ultraviolet radiation from the external sterilization module 186 has been detected by the sensor module 150 (e.g. a radiation sensor module).

Further, at the operation 708G, providing a notification of chemical sterilization may occur (e.g. an audible ring tone from a speaker assembly that a chemical composition has been dispensed into the beverage container 110). For example, user interface logic 123 may cause the notification module 142 of the user interface 140 to provide a notification that a chemical sterilization of the beverage container 110 has occurred. Further, the communications logic 122 may cause the communications module 130 to transmit a notification that chemical sterilization of the beverage container 110 has occurred.

Further, at the operation 710G, providing a notification of ozone sterilization may occur (e.g. an automated voice mail transmitted to a home phone of a user 190 stating that the beverage container 110 has been exposed to a given concentration of ozone for a threshold period of time). For example, user interface logic 123 may cause the notification module 142 of the user interface 140 to provide a notification that the integrated sterilization module 187 has dispensed a dose of ozone. Further, the communications logic 122 may cause the communications module 130 to transmit a notification to the monitoring system 180 that an exposure of the beverage container 110 to ozone dispensed from the external sterilization module 186 has been detected by the sensor module 150 (e.g. a chemical sensor module).

Further, at the operation 712G, providing a notification of thermal sterilization may be provided (e.g. a text message that at least a portion of the beverage container 110 has been maintained at a given temperature for a threshold time interval). For example, user interface logic 123 may cause the notification module 142 of the user interface 140 to provide a notification that the integrated sterilization module 187 has heated the interior of the beverage container for a period of time. Further, the communications logic 122 may cause the communications module 130 to transmit a notification to the monitoring system 180 that an exposure of the beverage container 110 to heat generated by the external sterilization module 186 has been detected by the sensor module 150 (e.g. a thermal sensor module).

### Application Ser. No. 12/012,500 (0107A-002-005F2-000000)

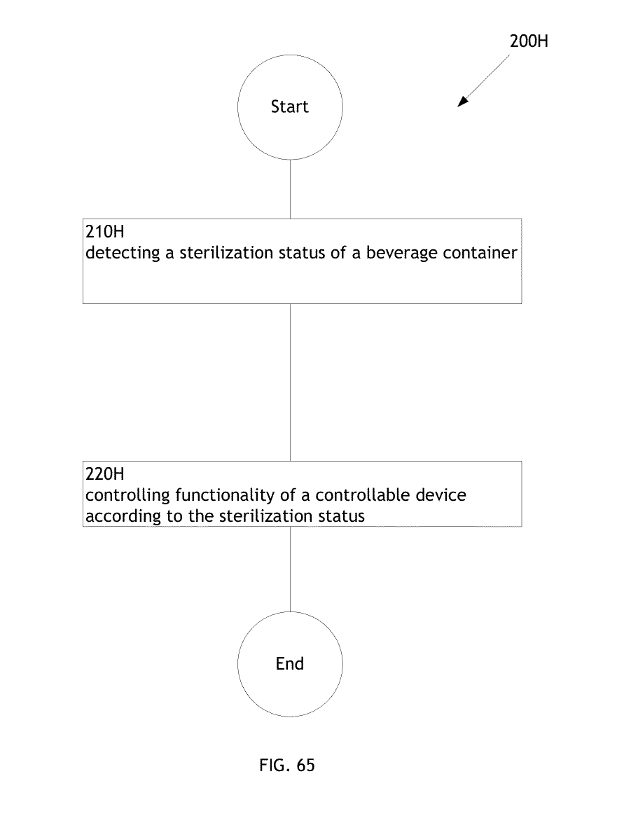

FIG. 65 illustrates an operational flow 200H representing example operations related to sterilizing a beverage container. In FIG. 65 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200H moves to a detecting operation 210H, where detecting a sterilization status of a beverage container may occur (e.g. determining whether a chemical sterilization has occurred within the previous three hours). For example, as shown in FIG. 1, the detection logic 121 may receive sterilization data from sterilization logic 188 operably coupled to the integrated sterilization module 187 or the external sterilization module 186. Upon receipt of sterilization data from the sterilization logic 188 indicating that a sterilization has occurred (e.g. a radiation, chemical or thermal sterilization), the detection logic 121 may update a sterilization status to reflect the sterilization.

In an alternate embodiment, detection logic 121 may receive sensor data from sensing logic 124 operably coupled to a sensor module 150. The sensor module 150 (e.g. a radiation sensor module, chemical sensor module, thermal sensor module) may detect a sterilization by the integrated sterilization module 187 or the external sterilization module 186. Upon receipt of sensor data from the sensing logic 124 indicating that a sterilization has occurred, the detection logic 121 may update a sterilization status to reflect the sterilization. Alternatively, the detection logic 121 may receive sensor data from sensing logic 124 indicating that one or more conditions indicate a sterile/unsterile condition (e.g., presence/absence of one or more bacteria, viruses, contaminants, etc.)

Then, in a controlling operation 220H, controlling functionality of a controllable device according to the sterilization status may occur (e.g. opening an actuated aperture of the beverage container 110 to allow for the ingestion of its contents). For example, as shown in FIG. 1, the dispensing logic 125 may cause the integrated consumable composition dispenser 160 and/or the external consumable composition dispenser 170 to dispense a dose of consumable composition according to the sterilization status (e.g. the dispenser will only dispense a dose if a sterilization has occurred within a threshold amount of time).

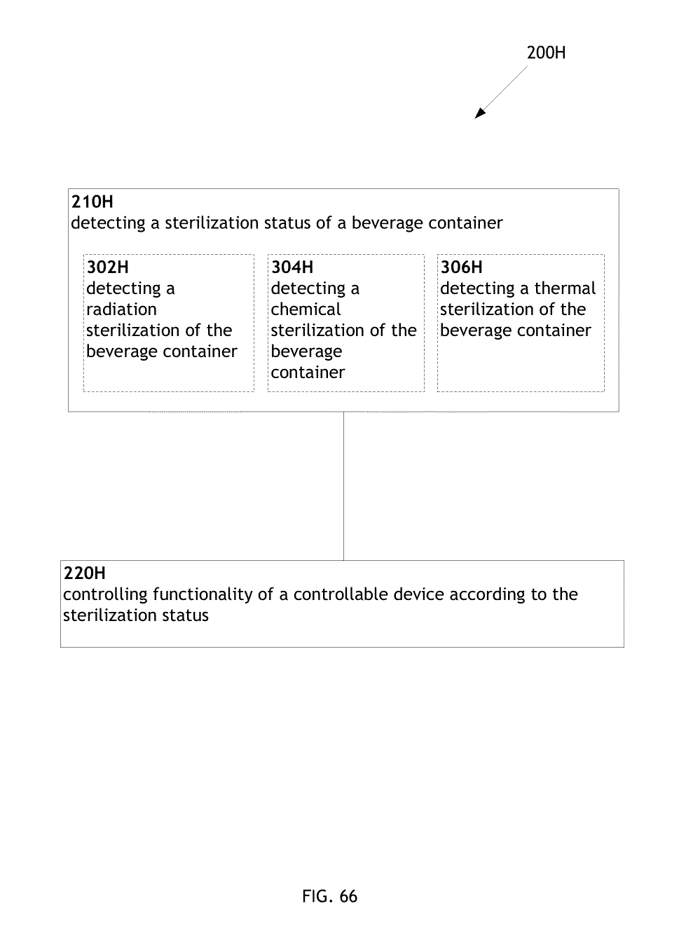

FIG. 66 illustrates alternative embodiments where the detecting operation 210H of FIG. 63 may include at least one additional operation. Additional operations may include an operation 302H, an operation 304H, and/or an operation 306H.

At the operation 302H, detecting a radiation sterilization of the beverage container may occur (e.g. an ultraviolet sterilization). For example, as shown in FIG. 1, the sensor module 150 may be a radiation sensor module (e.g. an ultraviolet sensor). Upon detection of a radiation sterilization by the sensor module 150, the sensing logic 124 may provide sensor data to detection logic 121 so as to update a sterilization status of the beverage container 110.

At the operation 304H, detecting a chemical sterilization of the beverage container may occur (e.g. an ozone sterilization). For example, as shown in FIG. 1, the integrated sterilization module 187 and/or the external sterilization module 186 may be chemical sterilization modules (e.g. ozone sterilization modules). Upon a chemical sterilization by the integrated sterilization module 187 and/or the external sterilization module 186, sterilization logic 188 may provide sterilization data to detection logic 121 so as to update a sterilization status of the beverage container.

At the operation 306H, detecting a thermal sterilization of the beverage container may occur (e.g. heating via a heating element). For example, as shown in FIG. 1, the integrated sterilization module 187 and/or the external sterilization module 186 may be thermal sterilization modules (e.g. an autoclave). Upon a thermal sterilization by the integrated sterilization module 187 and/or the external sterilization module 186, sterilization logic 188 may provide sterilization data to detection logic 121 so as to update a sterilization status of the beverage container.

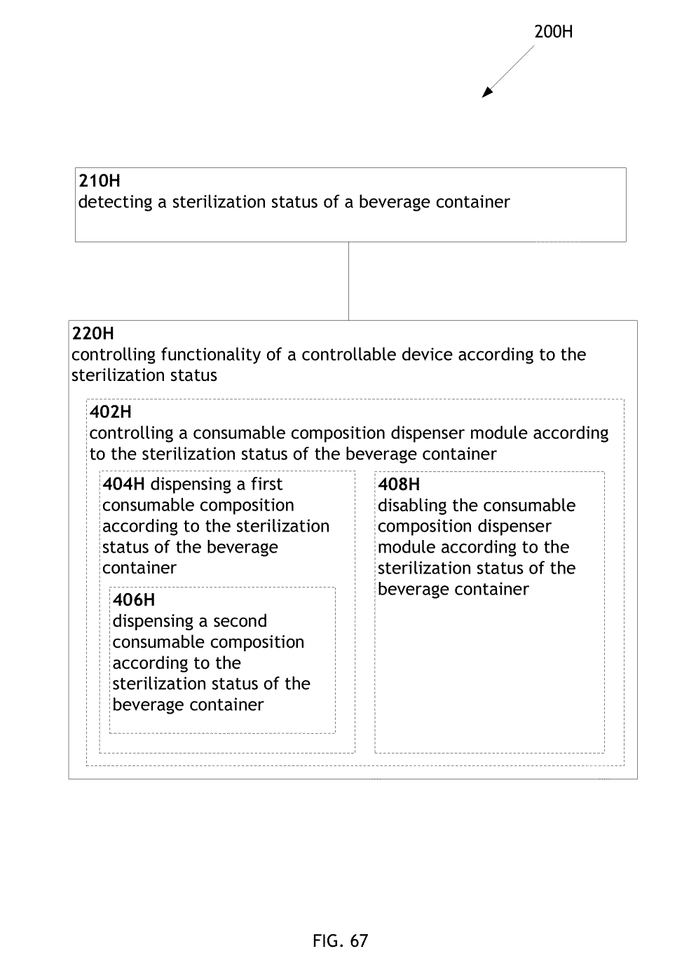

FIG. 67 illustrates alternative embodiments where operation 220H of FIG. 63 may include at least one additional operation. Additional operations may include an operation 402H, an operation 404H, an operation 406H, and/or an operation 408H.

At the operation 402H, controlling a consumable composition dispenser module according to the sterilization status of the beverage container may occur (e.g. providing power to an actuated dispensing mechanism). For example, as shown in FIG. 1, the dispensing logic 125 may cause the integrated consumable composition dispenser module 160 and/or the external consumable composition dispenser module 170 to dispense a dose of a consumable composition according to the sterilization status of the beverage container.

Further, at the operation 404H, dispensing a first consumable composition according to the sterilization status of the beverage container may occur (e.g. dispensing a dose of an analgesic when the beverage container has been sterilized). For example, as shown in FIG. 1, the integrated consumable composition dispenser module 160 and/or the external consumable composition dispenser module 170 may dispense a dose of a consumable composition when sterilization logic 188 indicates that integrated sterilization module 187 or external sterilization module 186 has completed a sterilization.

Further, at the operation 406H, dispensing a second consumable composition according to the sterilization status of the beverage container may occur (e.g. dispensing a dose of composition having an indicator color). For example, as shown in FIG. 1, the integrated consumable composition dispenser module 160 and/or the external consumable composition dispenser module 170 may dispense a dose of a second consumable composition (e.g. a dye, a neutralizing agent for a first consumable composition) when sterilization logic 188 indicates that a sterilization by the integrated sterilization module 187 or external sterilization module 186 has not been completed or has failed.

Further, at the operation 408, disabling at least a portion of the consumable composition dispenser module according to the sterilization status of the beverage container may occur (e.g. removing power from a consumable composition injection mechanism when a sterilization has not occurred). For example, as shown in FIG. 1, the dispensing logic 125 may cause the integrated consumable composition dispenser module 160 and/or the external consumable composition dispenser module 170 to withhold dispensation of a dose of a consumable composition when sensing logic 124 indicates that a sterilization by the integrated sterilization module 187 or external sterilization module 186 has not been completed or has failed.

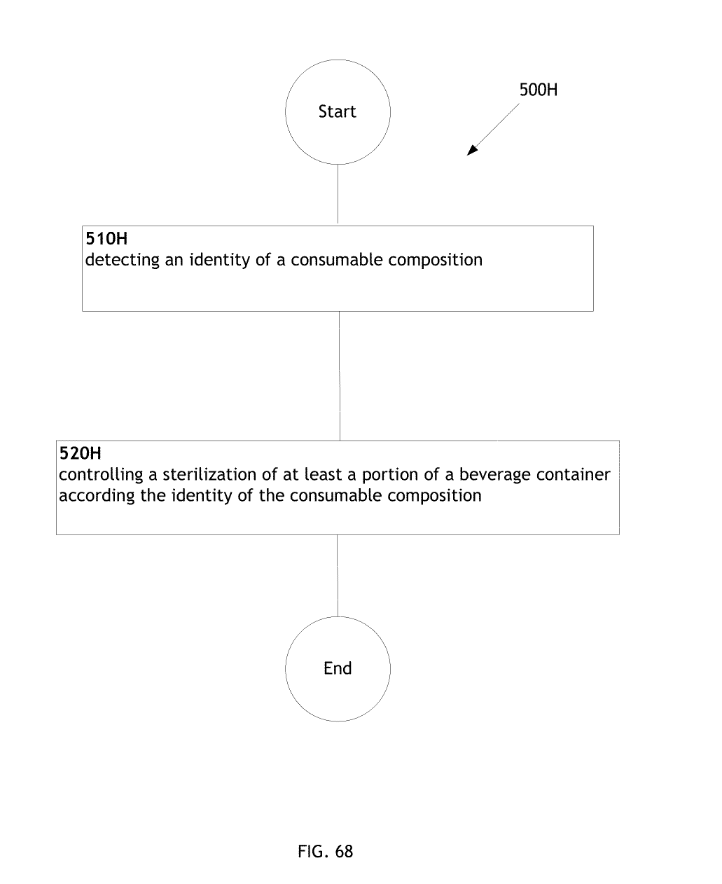

FIG. 68 illustrates an operational flow 500H representing example operations related to sterilizing a beverage container.

After a start operation, the operational flow 500H moves to a detecting operation 510H, where detecting an identity of a consumable composition may occur (e.g. spectroscopic measurement of the composition of a biochemical). For example, as shown in FIG. 1, the sensing logic 124 may cause sensor module 150 to detect an identity (e.g. a chemical composition) of a consumable composition. Sensor module 150 may include a chemical composition analysis mechanism (e.g. photoionization sensors, spectroscopic sensors, spectrometric sensors, crystallographic sensors, electrochemical sensors, calorimetric sensors).

Then, in a controlling operation 520H, controlling a sterilization of at least a portion of a beverage container according to the identity of the consumable composition may occur (e.g. deactivating one or more radiation sources in a radiation sterilization module when a radiation-sensitive consumable composition is dispensed). For example, as shown in FIG. 1, the sterilization logic 188 may cause the integrated sterilization module 187 and/or the external sterilization module 186 to sterilize selected portions of the beverage container according to an identity of a consumable composition.

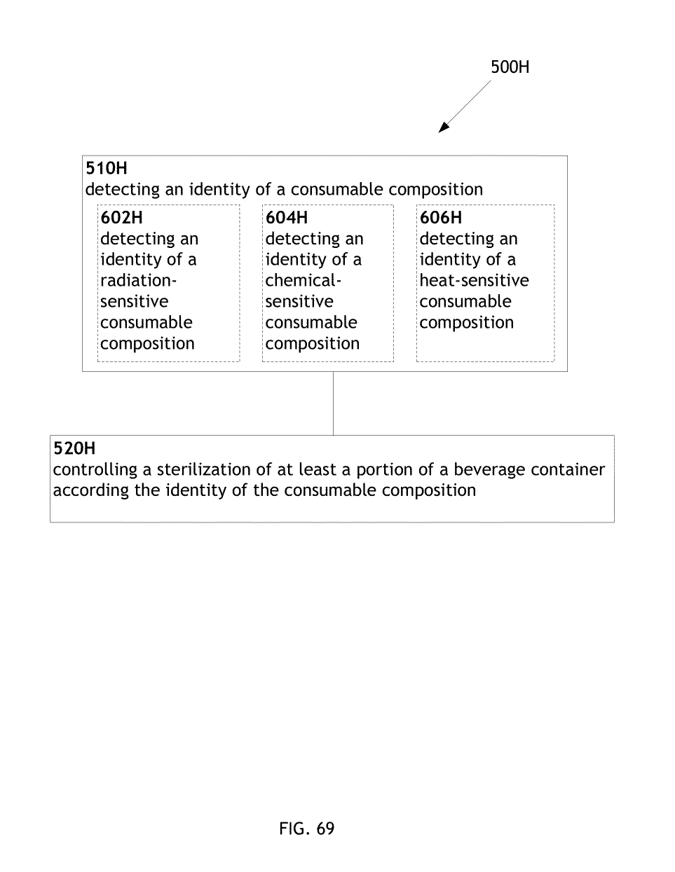

FIG. 69 illustrates alternative embodiments where the detecting operation 510H of FIG. 68 may include at least one additional operation. Additional operations may include an operation 602H, an operation 604H, and/or an operation 606H.

At the operation 602H, detecting an identity of a radiation-sensitive consumable composition may occur (e.g. electrochemical detection of a consumable composition whose functionality may be affected by radiation sterilization). For example, as shown in FIG. 1, the sensor module 150 may detect a chemical composition of a radiation sensitive consumable composition which may be compared to consumable composition identification data 126-3 maintained in memory 126. Radiation sensitive consumable compositions may include, but are not limited to, substituted (e.g. sulfonic acid or sulfonate substituted) aminotriarylacetonitrile compositions, microencapsulated activator-drug precursor pairs, psoralen and psoralen derivatives, and the like, which may be sensitive to ultraviolet, x-ray and/or gamma ray radiation.

At the operation 604H, detecting an identity of a chemical-sensitive consumable composition may occur (e.g. photoionization detection of a consumable composition whose functionality may be affected by chemical sterilization. For example, as shown in FIG. 1, the sensor module 150 may detect a chemical composition of a chemical-sensitive consumable composition which may be compared to consumable composition identification data 126-3 maintained in memory 126. Chemical-sensitive consumable compositions may include, but are not limited to, drug/carrier complexes having acid-sensitive spacers between the drug and carrier enabling the release of an active drug from the carrier in the presence of an acid.

At the operation 606H, detecting an identity of a heat-sensitive consumable composition may occur (e.g. crystalographic detection of a consumable composition whose functionality may be affected by thermal sterilization. For example, as shown in FIG. 1, the sensor module 150 may detect a chemical composition of a heat-sensitive consumable composition which may be compared to consumable composition identification data 126-3 maintained in memory 126. A heat sensitive consumable composition may include heat-sensitive retrovirals (e.g. Ritonavir), epinephrine, diazepam, naloxone, and the like.

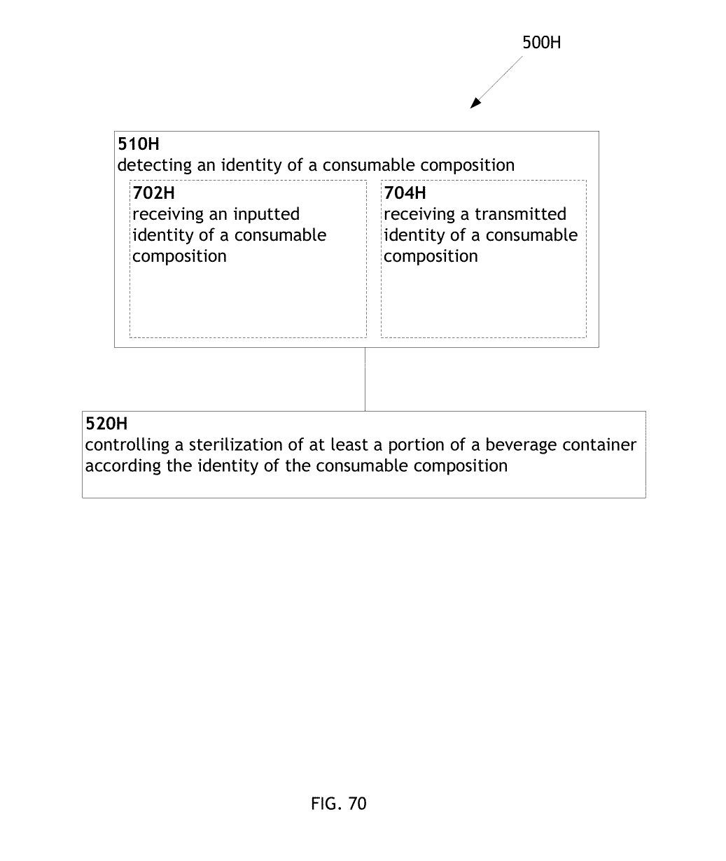

FIG. 70 illustrates alternative embodiments where the detecting operation 510H of FIG. 68 may include at least one additional operation. Additional operations may include an operation 702H, an operation 704H, and/or an operation 606H.

At the operation 702H, receiving an inputted identity of a consumable composition may occur (e.g. receipt of a user input identifying a consumable composition whose functionality may be affected by a chemical sterilization agent). For example, as shown in FIG. 1, a user 190 may input an identity of a chemical-sensitive consumable composition via an input module 146 (e.g. a touch screen) of a user interface 140.

At operation 704H, receiving a transmitted identity of a consumable composition may occur (e.g. receipt of identification data from a physician identifying a consumable composition whose functionality may be affected by thermal sterilization). For example, as shown in FIG. 1, the communications module 130, may receive consumable composition identification data from a monitoring system 180 (e.g. a system associated with a physician, a system associated with a consumable composition supply entity, and the like).

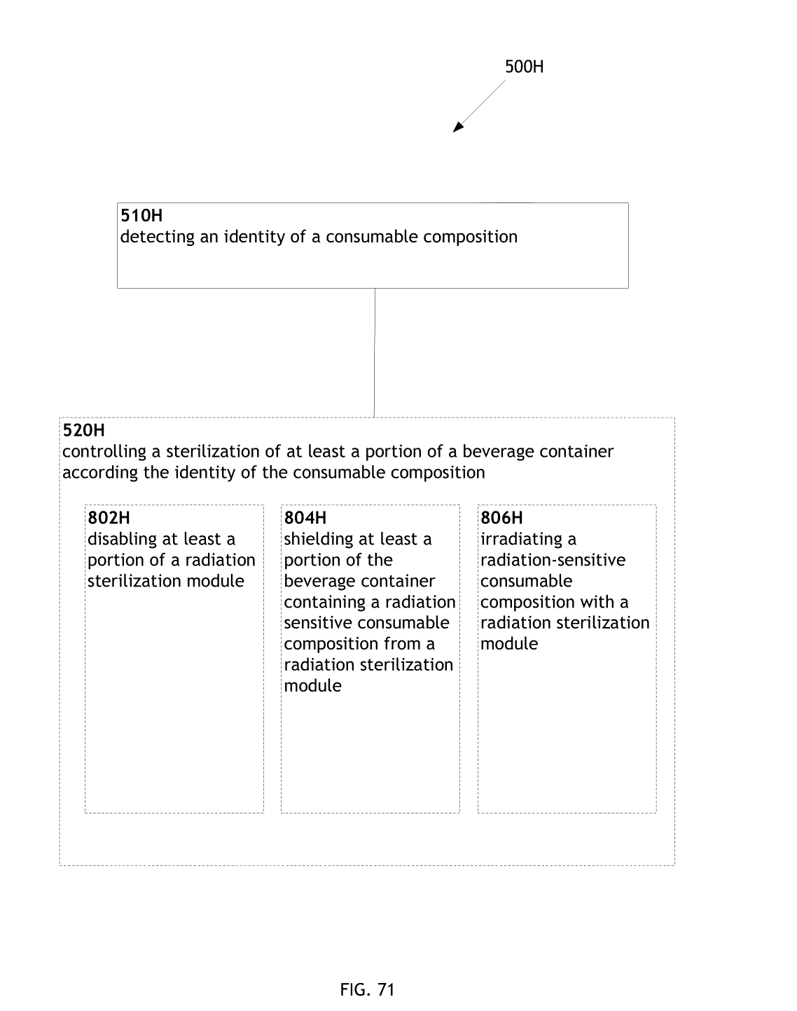

FIG. 71 illustrates alternative embodiments where the operation 520H of FIG. 68 may include at least one additional operation. Additional operations may include an operation 802H, an operation 804H and an operation 806H.

At the operation 802H, disabling at least a portion of a radiation sterilization module may occur (e.g. removing power from one or more radiation sources). For example, as shown in FIG. 1, the sterilization logic 188 may cause the integrated sterilization module 187 and/or the external sterilization module 186 to forgo scheduled or requested radiation sterilization if a consumable composition previously dispensed or to be dispensed is adversely sensitive to radiation.

At the operation 804H, shielding at least a portion of the beverage container containing a radiation sensitive consumable composition from a radiation sterilization module may occur (e.g. disposing a radiation-absorbing material between a radiation source and a consumable composition which may be damaged or deactivated by radiation). For example, as shown in FIG. 1, a portion of the beverage container 110 containing a consumable composition for which radiation may have a detrimental effect may be partitioned from a portion of the beverage container 110 to be sterilized by a radiation absorbing material.

At the operation 806H, irradiating a radiation-sensitive consumable composition with a radiation sterilization module may occur (e.g. exposure of a consumable composition whose functionality is activated by radiation). For example, as shown in FIG. 1, sterilization logic 188 may cause the integrated sterilization module 187 and/or the external sterilization module 186 to irradiate at least a portion of the beverage container 110, the integrated consumable composition dispenser module 160 and/or the external consumable composition dispenser module 170 containing a consumable composition having functionality that is activated by radiation.

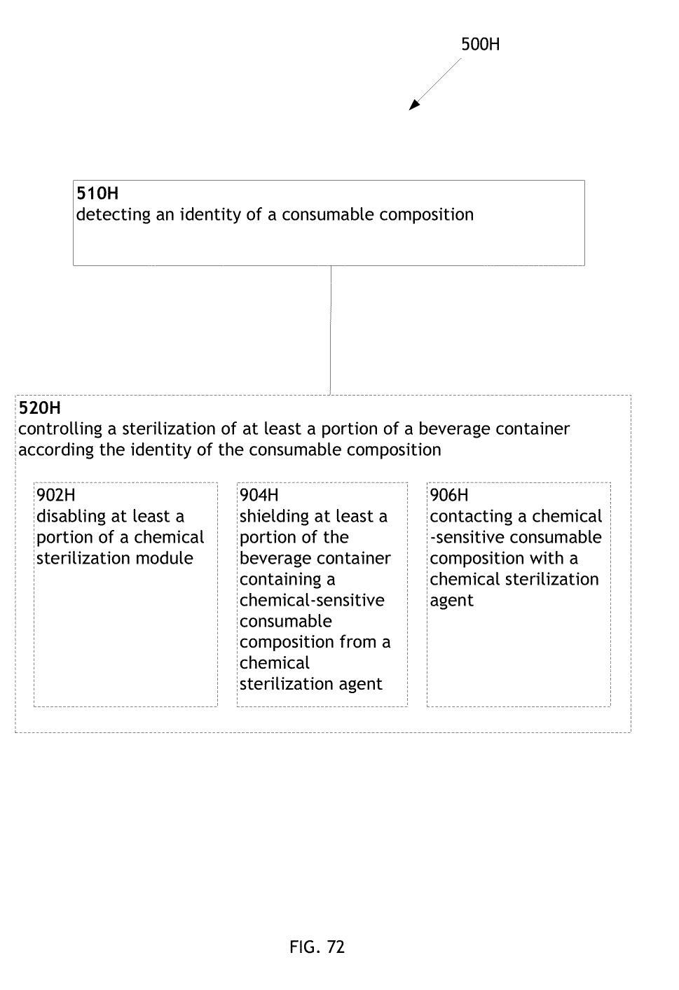

FIG. 72 illustrates alternative embodiments where the operation 520H of FIG. 68 may include at least one additional operation. Additional operations may include an operation 902H, an operation 904H and an operation 906H.

At the operation 902H, disabling at least a portion of a chemical sterilization module may occur (e.g. removing power to at least one chemical sterilization agent dispenser). For example, as shown in FIG. 1, the sterilization logic 188 may cause the integrated sterilization module 187 and/or the external sterilization module 186 to forgo scheduled or requested chemical sterilization if a consumable composition previously dispensed or to be dispensed has functionality that may be affected (e.g. modified, inhibited) by a chemical sterilization agent.

At the operation 904H, shielding at least a portion of the beverage container containing a chemical-sensitive consumable composition from a chemical sterilization module may occur (e.g. retaining a chemical-sensitive consumable composition in an gas-impermeable or liquid-impermeable microcapsule). For example, as shown in FIG. 1, the dispensing logic 188 may cause the integrated consumable composition dispenser module 160 and/or the external consumable composition dispenser module 170 to dispense a microencapsulated version of a consumable composition when the base consumable composition has functionality that may be affected (e.g. modified, inhibited) by a chemical sterilization agent.

At the operation 906H, contacting a chemical-sensitive consumable composition with a chemical sterilization agent may occur (e.g. dispensing a drug/carrier complex having acid-sensitive spacers between the drug and carrier and an acid composition). For example, as shown in FIG. 1, the dispensing logic 188 may cause the integrated consumable composition dispenser module 160 and/or the external consumable composition dispenser module 170 to dispense a an acid composition and an acid-sensitive consumable composition which has functionality that may be affected (e.g. activated, modified, enhanced) by a chemical ster chemical ilization agent.

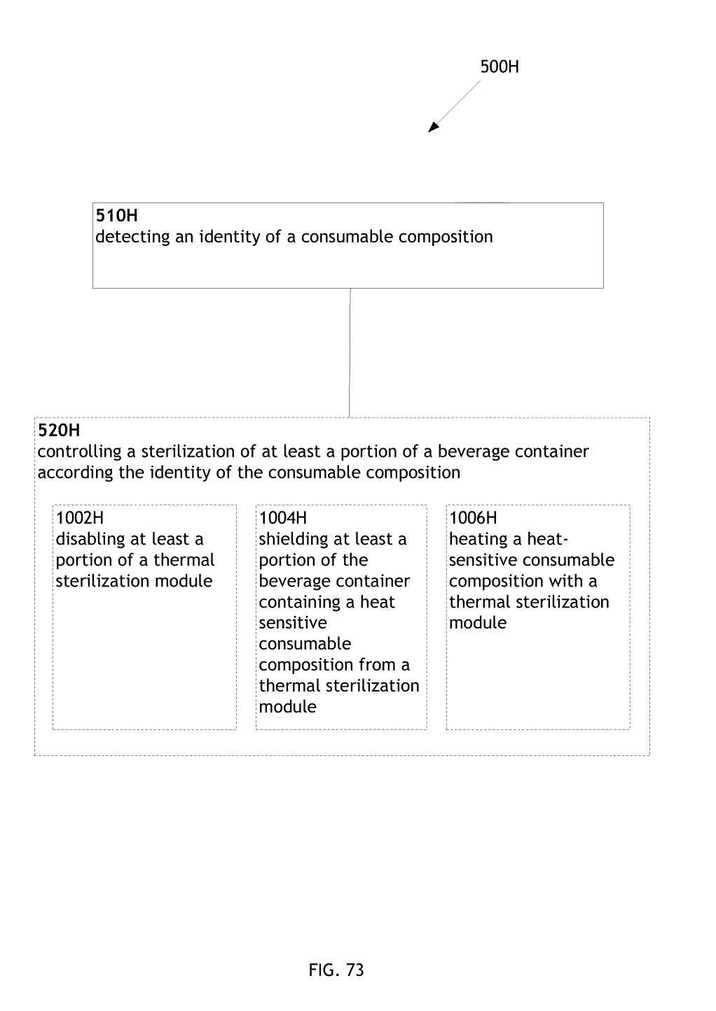

FIG. 73 illustrates alternative embodiments where the controlling operation 520H of FIG. 68 may include at least one additional operation. Additional operations may include an operation 1002H, an operation 1004H, and/or an operation 1006H.

At the operation 1002H, disabling at least a portion of a thermal sterilization module may occur (e.g. removing power to at least one heating element). For example, as shown in FIG. 1, the sterilization logic 188 may cause the integrated sterilization module 187 and/or the external sterilization module 186 to forgo scheduled or requested thermal sterilization if a consumable composition previously dispensed or to be dispensed has functionality that may be affected (e.g. modified, inhibited) by exposure to thermal energy.

At the operation 1004H, shielding at least a portion of the beverage container containing a heat sensitive consumable composition from a thermal sterilization module may occur (e.g. disposing a heat-absorbing material between a radiation source and a consumable composition which may be damaged or deactivated by thermal sterilization). For example, as shown in FIG. 1, a portion of the beverage container 110 containing a consumable composition for which thermal sterilization may have a detrimental effect may be partitioned from a portion of the beverage container 110 to be sterilized by a radiation absorbing material.

At the operation 1006H, heating a heat-sensitive consumable composition with a thermal sterilization module may occur (e.g. exposure of a consumable composition whose functionality is activated by heat). For example, as shown in FIG. 1, sterilization logic 188 may cause the integrated sterilization module 187 and/or the external sterilization module 186 to heat at least a portion of the beverage container 110, the integrated consumable composition dispenser module 160 and/or the external consumable composition dispenser module 170 containing a consumable composition having functionality which is activated and/or enhanced by heating.

### Application Ser. No. 12/383,458 (0107A-002-005G-000000)

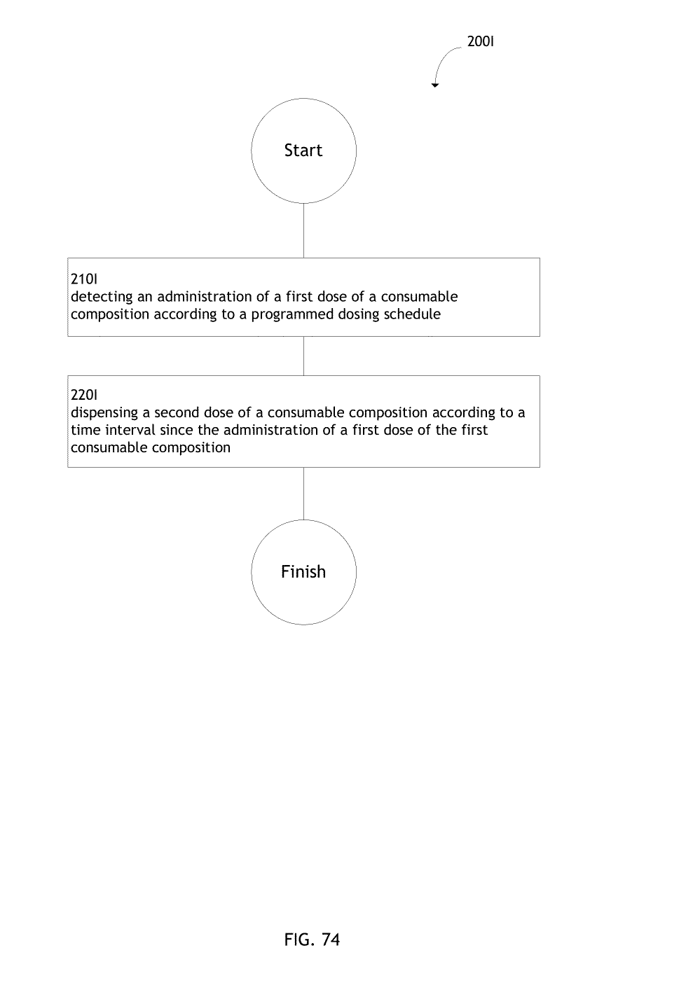

FIG. 74 illustrates an operational flow 200I representing example operations related to programmed dispensing of consumable compositions. In FIG. 74 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

Operation 210I depicts detecting an administration of a first dose of a consumable composition according to a programmed dosing schedule. For example, as shown in FIG. 1, an administration (e.g. a dispensation of a dose of a consumable composition by the integrated consumable composition dispenser module 160 and/or the external consumable composition dispenser module 170; an ingestion of the consumable composition by user 190) of a consumable composition according to a programmed dosing schedule (e.g. a dosing regimen stored as consumable composition dispensing programs 126-2) may be detected by detection logic 121 receiving data from dispensing logic 125 operably coupled to dispensing logic 125 and/or sensing module 150 operably coupled sensing logic 124. The detection of an administration of a consumable composition may cause the detection logic 121 to store a current time value maintained by clock logic 121-1 as consumable composition administration history data 126-4 in memory 126.

Operation 220I depicts dispensing a second dose of a consumable composition according to a time interval since the administration of a first dose of the first consumable composition (e.g. distributing a pharmaceutical composition in accordance with a timed regimen). For example, as shown in FIG. 1, the detection logic may detect a time interval that has elapsed since an administration of a dose of a consumable composition by comparing a current time as maintained by the clock logic 121-1 with consumable composition administration history data 126-4. The detection logic 121 may compare the time interval to recommended timings of doses of one or more consumable compositions (e.g. consumable composition dispensing programs 126-2) or time-dependent interactions of one or more consumable compositions (e.g. contraindication data stored as consumable composition identification data 126-3) and cause the dispensing logic 125 to cause the integrated consumable composition dispenser module 160, and/or an external consumable composition dispenser module 170 to distribute one or more doses (e.g. 30 mg) of a consumable composition (e.g., an anti-depressant, such as Paroxotene) into the beverage container 110 (e.g., a drinking cup) according to the time interval. It should be noted that the second dose of a consumable composition may include a consumable composition different than the first dose of a consumable composition and/or a second dose of the first consumable composition.

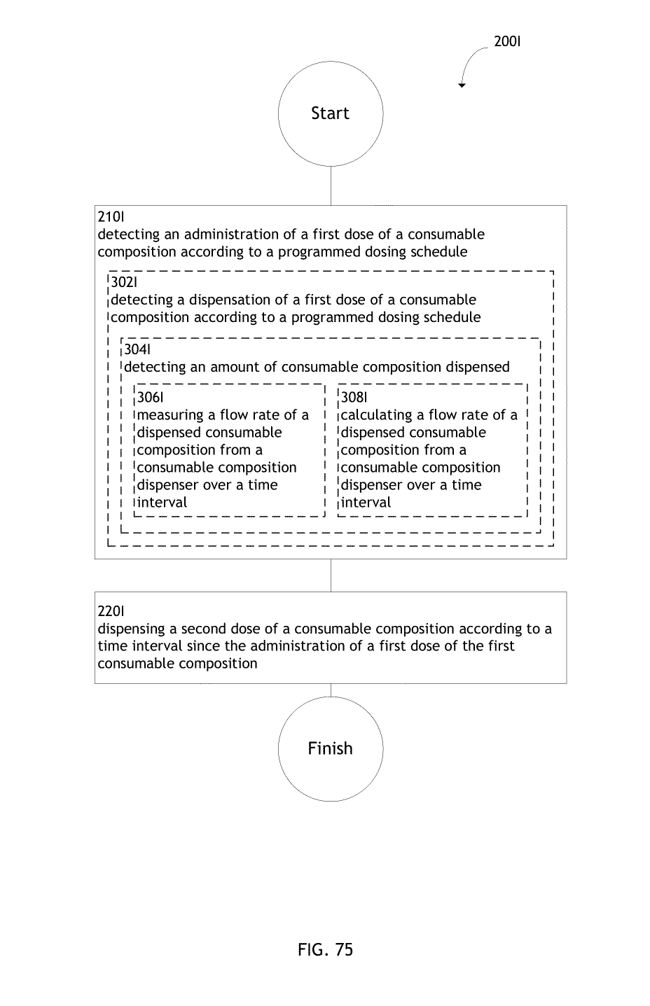

FIG. 75 illustrates an example embodiment where the operation 210I of the example operational flow 200I of FIG. 73 may include at least one additional operation. Additional operations may include an operation 302I.

Operation 302I illustrates detecting a dispensation of a first dose of a consumable composition according to a programmed dosing schedule. For example, as shown in FIG. 1, a dispensation of a dose of a consumable composition may be detected (e.g. detection of a logical flag set by dispensing logic 125 upon dispensation of a consumable composition) by detection logic 121 receiving data from the integrated consumable composition dispenser module 160 and/or the external consumable composition dispenser module 170 operably coupled to dispensing logic 125. A detected dispensation of a consumable composition may cause the detection logic 121 to store a current time value maintained by clock logic 121-1 as consumable composition administration history data 126-4 in memory 126.

FIG. 74 further illustrates an example embodiment where the operation 302I may include at least one additional operation. Additional operations may include an operation 304I.

Operation 304I illustrates detecting an amount of consumable composition dispensed (e.g. detecting a flow rate, mass, volume, concentration, and the like, of a consumable composition). For example, as shown in FIG. 1, an amount of the consumable composition dispensed by the integrated consumable composition dispenser module 160 and/or the external consumable composition dispenser module 170 may be detected by detection logic 121 receiving data from a sensing module 150 operably coupled to sensing logic 124. The dispensation detected in Operation 302 may be used in detecting an administration of a first dose of a consumable composition (Operation 210). For instance, a detected dispensation may be indicative of a completion of an administration of a dose of consumable composition and the consumable composition dispensing system 100 may then proceed to subsequent administrations.

FIG. 74 further illustrates an example embodiment where the operation 304I may include at least one additional operation. Additional operations may include an operation 306I and/or 308I.

Operation 306I illustrates measuring a flow rate of a dispensed consumable composition from a consumable composition dispenser over a time interval (e.g. a rate at which a physical, chemical, electrical, or optical property changes). For example, as shown in FIG. 1, an amount of consumable composition dispensed by the integrated consumable composition dispenser module 160 and/or the external consumable composition dispenser module 170 may be detected by measuring a flow rate of the consumable composition dispensed over a period of time with the sensor module 150 (e.g. a fiber optic pressure/outflow sensor, mechanical deflection pressure/outflow sensor, strain gauge pressure/outflow sensor, piezoresistive pressure/outflow sensor, microelectromechanical (MEMS) pressure/outflow sensor, variable capacitance pressure/outflow sensor, flow meters, and the like). The flow rate measured in Operation 306 may be used in detecting an amount of consumable composition dispensed (Operation 304). For instance, the product of the measured flow rate and the time interval may be computed so as to detect an amount of consumable composition dispensed.

Operation 308I illustrates calculating a flow rate of a dispensed consumable composition from a consumable composition dispenser over a time interval. For example, as shown in FIG. 1, the sensor module 150 may detect a volumetric flow rate of consumable composition contained in consumable composition storage 165 (e.g. a magnetic flow meter measuring volume outflow from the consumable composition storage 165 over time), a mass flow rate of consumable composition contained in consumable composition storage 165 (e.g. a piezoresistive pressure sensor measuring the change in the force associated with the mass present in the consumable composition storage 165 over time), and the like. The flow rate calculated in Operation 308 may be used in detecting an amount of consumable composition dispensed (Operation 304). For instance, the product of the calculated flow rate and the time interval may be computed so as to detect an amount of consumable composition dispensed.

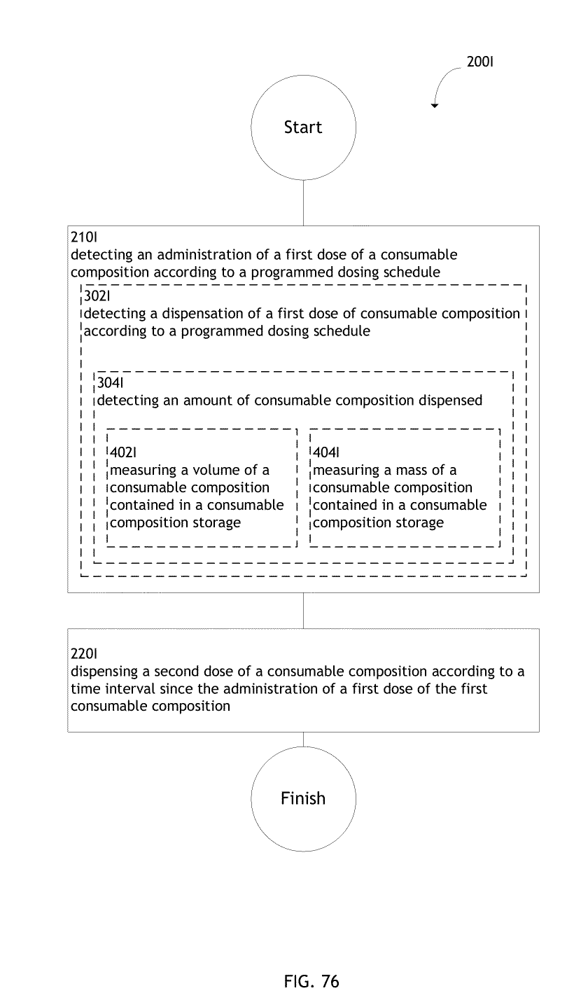

FIG. 76 illustrates an example embodiment where the operation 304I of FIG. 75 may include at least one additional operation. Additional operations may include an operation 402I and/or 404I.

Operation 402I illustrates measuring a volume of a consumable composition contained in a consumable composition storage (e.g. optical and/or acoustical detection of a level of a consumable composition within a container). For example, as shown in FIG. 1, the sensor module 150 may be an optical and/or acoustical sensor module. The optical and/or acoustical sensor module 150 may emit one or more forms of electromagnetic radiation (EMR) and/or acoustical waves which may be reflected by one or more surfaces of the consumable composition maintained within the consumable composition storage 165. The transmit/receive time of the reflected EMR and/or acoustical waves may be translated into a distance the surface of consumable composition is away from the sensor module 150. A known positional relationship of the sensor 150 with respect to the consumable composition storage 165 and the dimensions of the consumable composition storage 165 may allow for the calculation of the volume of the consumable composition contained in the consumable composition storage 165. The volume of consumable composition measured in Operation 402 may be used in detecting an amount of consumable composition dispensed (Operation 304). For instance, the volume of the consumable composition within the composition storage 165 and the physical characteristics of the consumable composition (e.g. density data, concentration data, and the like, maintained as consumable composition identification data 126-3) may allow for the calculation of an amount of consumable composition.

Operation 404I illustrates measuring a mass of a consumable composition contained in a consumable composition storage (e.g. mechanical deflection pressure detection). For example, as shown in FIG. 1, the sensor module 150 (e.g. a fiber optic pressure sensor, mechanical deflection pressure sensor, strain gauge pressure sensor, piezoresistive pressure sensor, microelectromechanical (MEMS) pressure sensor, variable capacitance pressure sensor, and the like) may detect a force exerted by the mass of a consumable composition within the consumable composition storage 165. The force exerted by the consumable composition as measured in Operation 404 may be used in detecting an amount of consumable composition dispensed (Operation 304). For instance, the sensing logic 124 may receive the force data and calculate an associated mass of the consumable composition contained in the consumable composition storage 165 based on the force data and known physical properties of the consumable composition as maintained in consumable composition identification data 126-3.

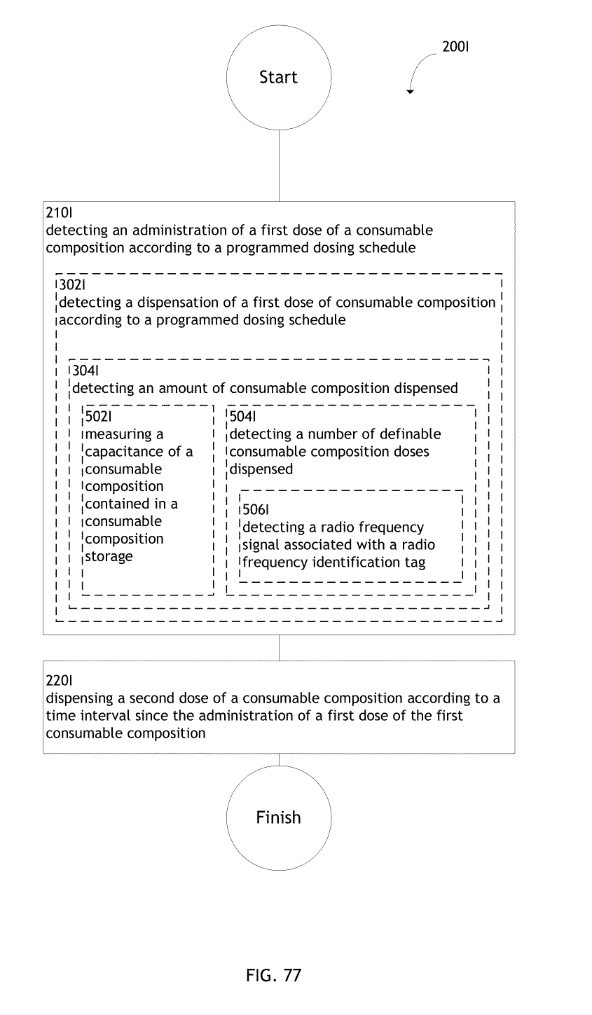

FIG. 77 illustrates an example embodiment where the operation 304I of FIG. 75 may include at least one additional operation. Additional operations may include an operation 502I and/or 504I.

Operation 502I illustrates measuring a capacitance of a consumable composition contained in a consumable composition storage (e.g. calculating a concentration of a consumable composition from a detection of a capacitance of a consumable composition). For example, as shown in FIG. 1, a chemical field effect transistor sensor module 150 may sense a capacitance of a consumable composition maintained in the consumable composition storage 165. The capacitance may be correlated to a corresponding concentration (e.g. a lookup table relating a detected capacitance to a concentration and maintained as consumable composition identification data 126-3). The concentration of consumable composition measured in Operation 502 may be used in detecting an amount of consumable composition dispensed (Operation 304). For instance, detection logic 121 may calculate an amount of consumable composition dispensed by looking up capacitance and a known capacitance/concentration correlation (e.g. consumable composition identification data 126-3 representing a capacitance/concentration correlations) to detect a concentration of the consumable composition contained in the consumable composition storage 165.

Operation 504I illustrates detecting a number of definable consumable composition doses dispensed (e.g. detecting a number of pills dispensed). For example, as shown in FIG. 1, the sensor module 150 may sense (e.g. motion sensing) a dispensation of a consumable composition formulated in a defined structure having a known dosage amount (e.g. a pill-type structure) by the integrated consumable composition dispenser module 160 and/or the external consumable composition dispenser module 170. The number of definable doses of consumable composition detected in Operation 504 may be used in detecting an amount of consumable composition dispensed (Operation 304). For instance, the detection logic 121 may calculate an amount of consumable composition dispensed by computing a product of the dosage amount of each pill (e.g. consumable composition identification data 126-3) and a number of pills detected as having been dispensed.

FIG. 77 further illustrates an example embodiment where the operation 504I may include at least one additional operation. Additional operations may include an operation 506I.

Operation 506 illustrates detecting a radio frequency signal associated with a radio frequency identification tag (e.g. detecting a presence and/or absence of a passive, semi-passive and/or active RFID tag). For example, as shown in FIG. 1, the sensor module 150 may include a radio frequency (RF) sensor which may transceive RF signals. The radio frequency signal associated with the RFID tag detected in Operation 506 may be used in detecting a number of definable consumable composition doses dispensed (Operation 504). For instance, the sensor module 150 may sense dispensation of a consumable composition formulated in a definable dose (e.g. a pill-type structure) having a known dosage amount (e.g. as maintained as consumable composition identification data 126-3) by the integrated consumable composition dispenser module 160 and/or the external consumable composition dispenser module 170 by monitoring the presence and/or absence of RF signals associated with an RFID tag (e.g. a passive, semi-passive and/or active RFID tag) included in the consumable composition.

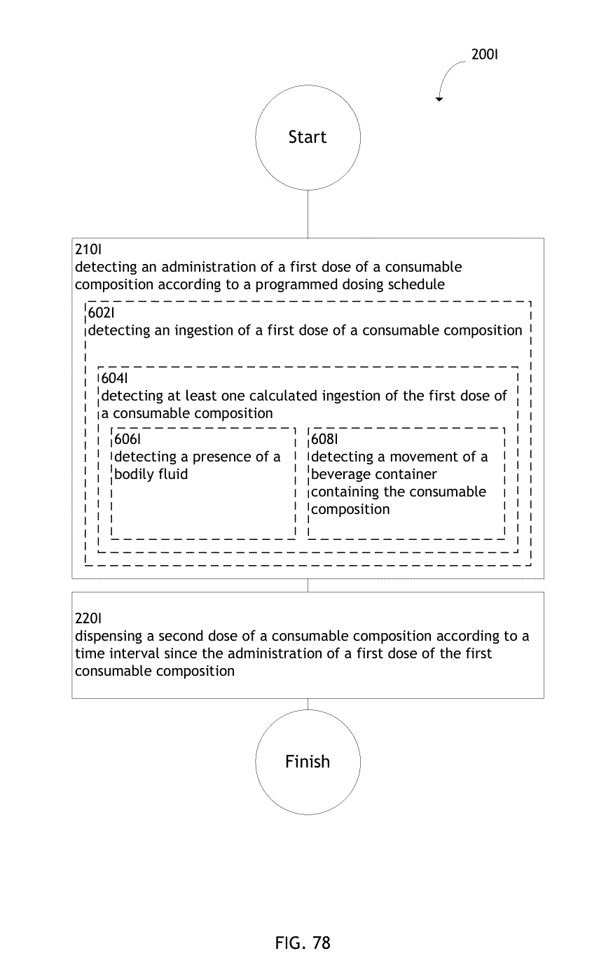

FIG. 78 illustrates an example embodiment where the operation 210I of FIG. 74 may include at least one additional operation. Additional operations may include an operation 602I.

Operation 602I illustrates means for detecting an ingestion of a first dose of a consumable composition. For example, as shown in FIG. 1, an ingestion of a dose of a consumable composition may be detected by detection logic 121 receiving data from a sensing module 150 (e.g. a biometric sensor) operably coupled to sensing logic 124. An indicated ingestion detected by sensing module 150 may cause detection logic 121 to store a current time value (e.g. a time maintained by clock logic 121-1) associated with the ingestion as consumable composition administration history data 126-4. The stored timer value may be compared to a current timer value maintained by clock logic 121-1 so as to calculate and elapsed time interval following an ingestion. The ingestion detected in Operation 602 may be used in detecting an administration of a first dose of a consumable composition (Operation 210). For instance, a detected ingestion may be indicative of a completion of an administration of a dose of consumable composition and the consumable composition dispensing system 100 may then proceed to subsequent administrations.

FIG. 78 further illustrates an example embodiment where the operation 602I may include at least one additional operation. Additional operations may include an operation 604I.

Operation 604I illustrates detecting at least one calculated ingestion of the first dose of a consumable composition (e.g. detecting that one or more events have occurred indicating a likelihood that a user has complied with a programmed dosing schedule for the consumable composition by swallowing the consumable composition). For example, as shown in FIG. 1, the sensing logic 124 may be operably coupled to sensor module 150. The sensor module 150 may detect environmental conditions (e.g. movement of a consumable composition within a beverage container 110, chemical compositions present within the consumable composition or on the beverage container 110, and the like). The calculated ingestion of the consumable composition and the second consumable composition as detected in Operation 604 may be used in detecting an ingestion of a consumable composition (Operation 602). For instance, the detected environmental conditions may indicate a likelihood of an ingestion of a consumable composition by the user 190, rather than directly detecting characteristics of the consumable composition itself.

FIG. 78 further illustrates an example embodiment where the operation 604I may include at least one additional operation. Additional operations may include an operation 606I and/or 608I.

Operation 606I illustrates detecting a presence of a bodily fluid (e.g. biometric detection). For example, as shown in FIG. 1, the sensor module 150 may include a biometric sensor (e.g. an amperometric glucose sensor) which senses the presence of saliva, perspiration, sebum and the like, either on the surface of the beverage container 110 or as a component of the contents therein. The presence of a bodily fluid measured in Operation 606 may be used in detecting a calculated ingestion of a consumable composition (Operation 604). For instance, the presence of biological material may indicate a likelihood that the beverage container 110 has been physically contacted by user 190 (e.g. the mouth of user 190) indicating an ingestion of a consumable composition.

Operation 608I illustrates detecting a movement of a beverage container containing the consumable composition (e.g. accelerometric detection of a user-initiated movement). For example, as shown in FIG. 1, the sensor module 150 may include an accelerometer, inertial motion sensor and the like, which may sense the movement of the beverage container 110. The movement of a beverage container as measured in Operation 608 may be used in detecting a calculated ingestion of a consumable composition (Operation 604). The movement of the beverage may be correlated to movement required to positioning of the beverage container 110 into a position indicative of a likely ingestion of the consumable composition by user 190 (e.g. a drinking position).

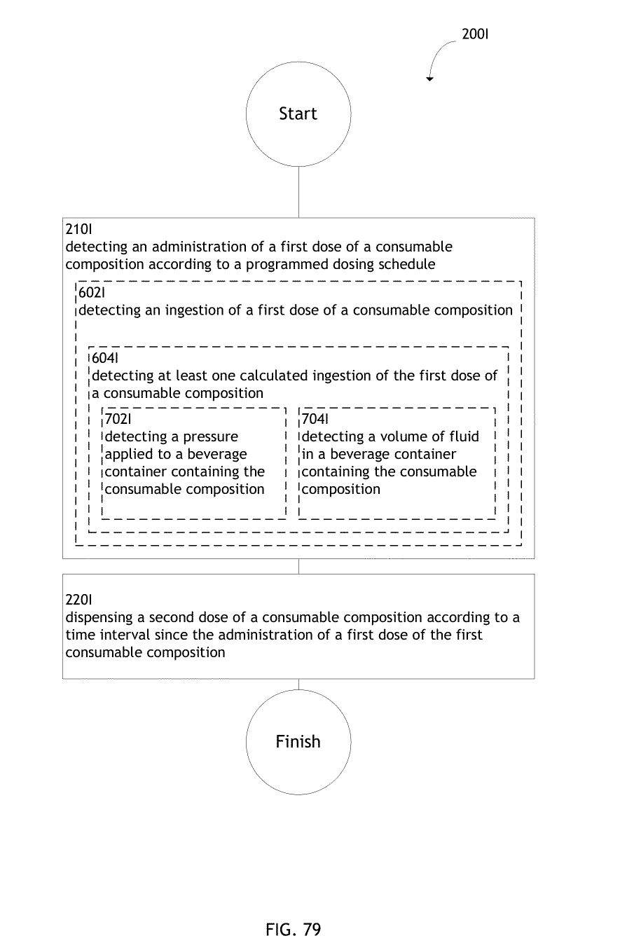

FIG. 79 illustrates an example embodiment where the operation 604 of FIG. 78 may include at least one additional operation. Additional operations may include an operation 702I, and/or an operation 704I.

Operation 702I illustrates detecting a pressure applied to a beverage container containing the consumable composition (e.g. fiber optic pressure detection of a user grasping the beverage container). For example, as shown in FIG. 1, the sensor module 150 may include a fiber optic pressure sensor, mechanical deflection pressure sensor, strain gauge pressure sensor, piezoresistive pressure sensor, microelectromechanical (MEMS) pressure sensor, variable capacitance pressure sensor, and the like which senses a pressure applied to the beverage container 110. The pressure applied to the beverage container 110 as measured in Operation 702 may be used in detecting a calculated ingestion of a consumable composition (Operation 604). For instance, a detected pressure applied to the beverage container 110 may be correlated to a pressure required to grip the beverage container 110 such that the consumable composition may be ingested by user 190, thereby indicating a likelihood of ingestion.

Operation 704I illustrates detecting a volume of fluid in a beverage container containing the consumable composition (e.g. optical and/or acoustical detection of a level of a consumable composition within a container). For example, as shown in FIG. 1, the sensor module may include an optical and/or acoustical sensor module. The sensor module may emit one or more forms of electromagnetic radiation (EMR) and/or acoustic waves which may be reflected by one or more surfaces of the consumable composition maintained within the consumable composition storage 165. The transmit/receive time of the reflected EMR and/or acoustic wave may be translated into the distance the level of consumable composition is away from the sensor module 150 (e.g. the level of the consumable composition). A known positional relationship of the sensor 150 with respect to the consumable composition storage 165 and the dimensions of the consumable composition storage 165 allow for the calculation of the volume of the consumable composition contained in the consumable composition storage 165. The detected volume of fluid in the beverage container 110 as measured in Operation 704 may be used in detecting a calculated ingestion of a consumable composition (Operation 604). For instance, a change in the detected volume of fluid in the beverage container 110 may be indicative of the likelihood of an ingestion of the consumable composition by a user 190.

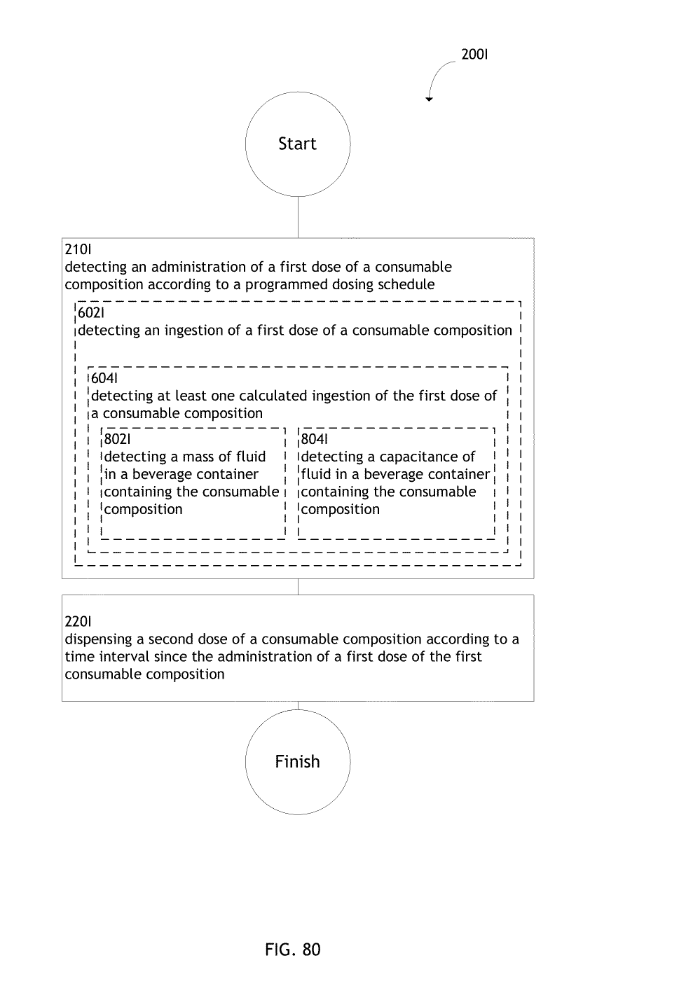

FIG. 80 illustrates an example embodiment where the operation 604I of FIG. 78 may include at least one additional operation. Additional operations may include an operation 802I, and/or an operation 804I.

Operation 802I illustrates detecting a mass of fluid in a beverage container containing the consumable composition (e.g. mechanical deflection pressure detection). For example, as shown in FIG. 1, the sensor module 150 (e.g. a fiber optic pressure sensor, mechanical deflection pressure sensor, strain gauge pressure sensor, piezoresistive pressure sensor, microelectromechanical (MEMS) pressure sensor, variable capacitance pressure sensor) may detect a force exerted by the mass of a consumable composition within the consumable composition storage 165. The sensing logic 124 may receive the force data and calculate an associated mass of the consumable composition contained in the consumable composition storage 165 based on the force data and known physical properties of the consumable composition as maintained in consumable composition identification data 126-3. The detected mass of fluid in the beverage container 110 as measured in Operation 802 may be used in detecting a calculated ingestion of a consumable composition (Operation 604). For instance, a change in the detected mass of fluid in the beverage container 110 may be indicative of the likelihood of an ingestion of the consumable composition by a user 190.

Operation 804I illustrates detecting a capacitance of fluid in a beverage container containing the consumable composition (e.g. calculating a concentration of a consumable composition from a detection of a capacitance of a consumable composition). For example, as shown in FIG. 1, a chemical field effect transistor sensor module 150 may sense a capacitance of a consumable composition maintained in the consumable composition storage 165. The capacitance may be correlated to a corresponding concentration (e.g. a lookup table relating detected capacitance to a concentration and maintained as consumable composition identification data 126-3). The concentration and the known dimensions of the consumable composition storage 165 may allow for the calculation of the amount of consumable composition contained in the consumable composition storage 165. The detected capacitance of fluid in the beverage container 110 as measured in Operation 804 may be used in detecting a calculated ingestion of a consumable composition (Operation 604). For instance, a change in the detected capacitance of fluid in the beverage container 110 may be indicative of the likelihood of an ingestion of the consumable composition by a user 190.

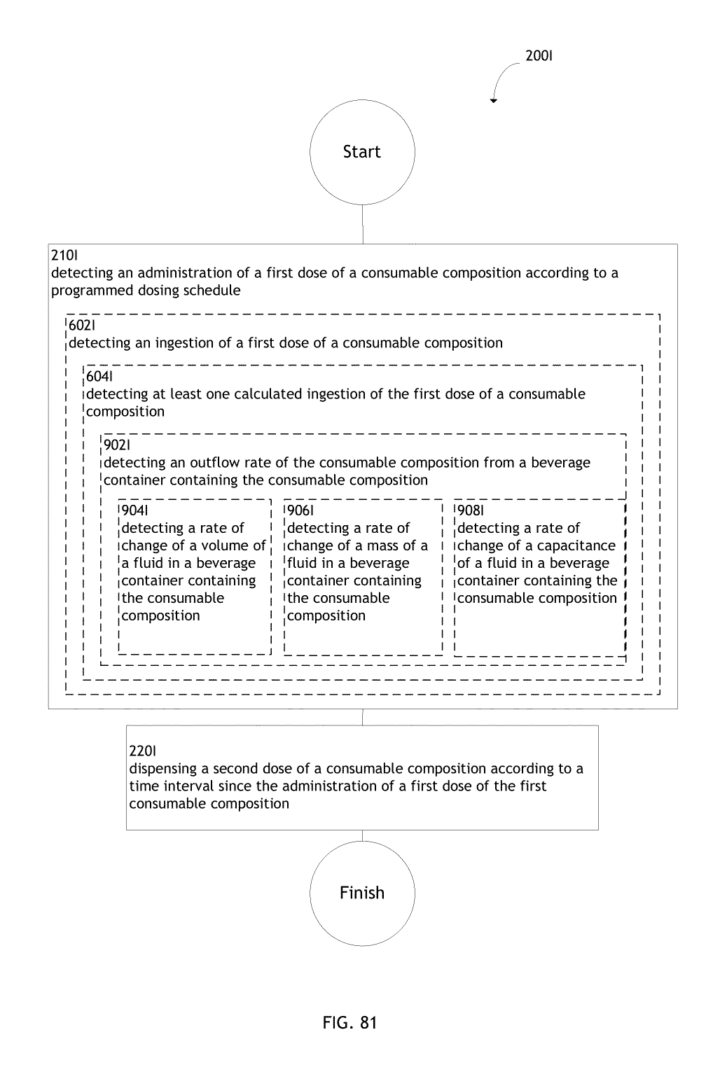

FIG. 81 illustrates an example embodiment where the operation 604I of FIG. 78 may include at least one additional operation. Additional operations may include an operation 902I.

Operation 902I illustrates detecting an outflow rate of the consumable composition from a beverage container containing the consumable composition (e.g. a rate at which a physical, chemical, electrical, or optical property changes). For example, as shown in FIG. 1, the sensor module 150 may include a fiber optic pressure/outflow sensor, mechanical deflection pressure/outflow sensor, strain gauge pressure/outflow sensor, piezoresistive pressure/outflow sensor, microelectromechanical (MEMS) pressure/outflow sensor, variable capacitance pressure/outflow sensor, flow meters, and the like, which sense an outflow from the beverage container 110 containing the consumable composition. The detected outflow rate of the consumable composition from the beverage container 110 (Operation 602I) may be used in detecting a calculated ingestion of a consumable composition (Operation 604I). For instance, an outflow may indicate a proper ingestion or an improper disposal of the consumable composition, depending on the outflow rate. For example, proper ingestion might be indicated by an outflow rate indicative of normal drinking (e.g. 50 ml per second), while improper disposal might be indicated by an outflow rate indicative of rapidly dumping the contents of the cup by upending the cup (e.g. 500 ml per second).

FIG. 81 further illustrates an example embodiment where the operation 902I may include at least one additional operation. Additional operations may include an operation 904I, 906I and/or 908I.

Operation 904I illustrates detecting a rate of change of a volume of a fluid in a beverage container containing the consumable composition (e.g. an optical and/or acoustical sensor measuring a change in a volume of fluid within the beverage container 110 over time). For example, as shown in FIG. 1, the sensor module 150 may be an optical and/or acoustic sensor module. The sensor module may emit one or more forms of electromagnetic radiation (EMR) and/or acoustical waves which may be reflected by one or more surfaces of the consumable composition maintained within the consumable composition storage 165. The transmit/receive time of the reflected EMR and/or acoustical wave may be translated into a distance the surface of consumable composition is away from the sensor module 150. A known positional relationship of the sensor 150 with respect to the consumable composition storage 165 and the dimensions of the consumable composition storage 165 may allow for the calculation of the volume of the consumable composition contained in beverage container. The sensor module may detect a first volume of fluid within the beverage container 110. At a later time, the sensor module 150 may detect a second volume of fluid. The sensing logic 124 may receive the EMR and/or acoustical wave data from the sensor module 150 and calculate the associated volume of the consumable composition contained in the beverage container 110 at both the first detection and the second detection. A rate of change of volume of the fluid in the beverage container 110 may be calculated from the difference in volume over the time period. The detected change in volume of the fluid in the beverage container 110 as detected in Operation 904, may be used in detecting the outflow rate of a consumable composition (Operation 902). For instance, the change in mass of the fluid over the time period and the concentration of the consumable composition within the fluid may be used to calculate the outflow of consumable composition from the beverage container 110.

Operation 906I illustrates detecting a rate of change of a mass of a fluid in a beverage container containing the consumable composition (e.g. a piezoresistive pressure sensor measuring the change in the mass present in a beverage container over time). For example, as shown in FIG. 1, the sensor module 150 (e.g. a fiber optic pressure sensor, mechanical deflection pressure sensor, strain gauge pressure sensor, piezoresistive pressure sensor, microelectromechanical (MEMS) pressure sensor, variable capacitance pressure sensor) may detect a first force exerted by the mass of a fluid within the beverage container 110. At a later time, the sensor module 150 may detect a second force exerted by the mass of a fluid within the beverage container. The sensing logic 124 may receive the force data and calculate the associated mass of the fluid contained in the beverage container 110 at both the first detection and the second detection. A rate of change of mass of the consumable composition may be calculated from the difference in mass over the time period. The detected change in mass of the fluid in the beverage container 110 as detected in Operation 906, may be used in detecting the outflow rate of a consumable composition (Operation 902). For instance, the change in mass of the fluid, density of the fluid and the concentration of the consumable composition within the fluid may be used to calculate the outflow of consumable composition from the beverage container 110.

Operation 908I illustrates detecting a rate of change of a capacitance of a fluid in a beverage container containing the consumable composition (e.g. calculating a capacitance associated with the presence of a consumable composition within a fluid containing the consumable composition). For example, as shown in FIG. 1, the sensor module 150 (e.g. a chemical field effect transistor sensor) may sense a first capacitance of a consumable composition maintained in the beverage container 110. At a later time, the sensor module 150 may detect a second capacitance of the consumable composition within the beverage container 110. The sensing logic 124 may receive the capacitance data and calculate a rate of change of capacitance of the fluid within the beverage container as the difference in capacitance over the time period. The detected change in capacitance of the consumable composition from the beverage container 110 as detected in Operation 908, may be used in detecting the outflow rate of a consumable composition (Operation 902). For instance, the change in capacitance of the fluid and the concentration of the consumable composition within the fluid (e.g. a detected concentration) may be used to calculate the outflow of consumable composition from the beverage container 110

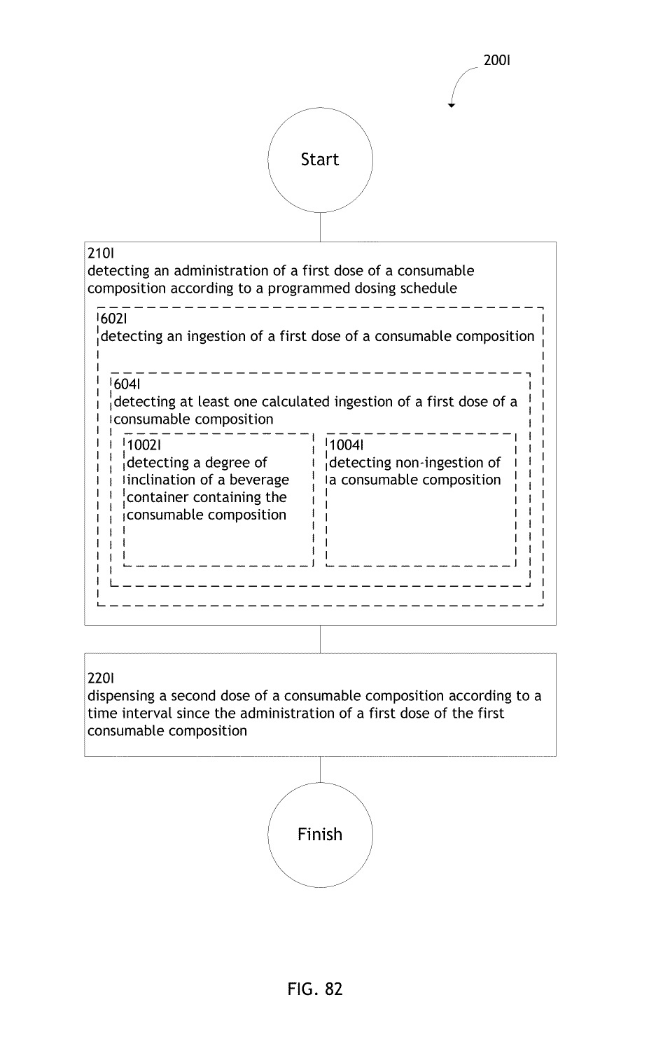

FIG. 82 illustrates an example embodiment where the operation 604I of FIG. 78 may include at least one additional operation. Additional operations may include an operation 1002I and/or an operation 1004I.

Operation 1002I illustrates detecting a degree of inclination of a beverage container containing the consumable composition (e.g. detecting that a user is rotating the beverage container by a certain degree relative to its designed resting position so as to ingest its contents). For example, as shown in FIG. 1, the sensor module 150 may include an inclinometer and the like. The detected inclination of the beverage container 110 as detected in Operation 1002 may be used in detecting a calculated ingestion of a consumable composition (Operation 604). For instance, the degree of incline of the beverage container 110 may indicate a proper ingestion (e.g. a rotation of less than or equal to 110 degrees may indicate proper ingestion) or an improper disposal (e.g. a rotation of greater than 110 degrees may indicate improper disposal) of the consumable composition, depending on the degree of incline.

Operation 1004I illustrates detecting non-ingestion of a consumable composition (e.g. a quantity of a consumable composition may be spilled from beverage container 110 prior to its ingestion by a user 190). For example, as shown in FIG. 1, the sensor module 150 may include a sensor (e.g. a piezoresistive pressure sensor) which may detect a pressure about an ingestion aperture of the beverage container 110 through which a user 190 may drink the consumable composition. The sensor module 150 may detect a pressure resulting from a flow of a consumable composition across portions of the ingestion aperture not associated with proper ingestion (e.g. simultaneous flow across opposite sides of a ingestion aperture) or variable flow rates (e.g. a flow across a first portion of the ingestion aperture has greater velocity that that across a second portion of the ingestion aperture) indicating spillage of the consumable composition across the ingestion aperture.

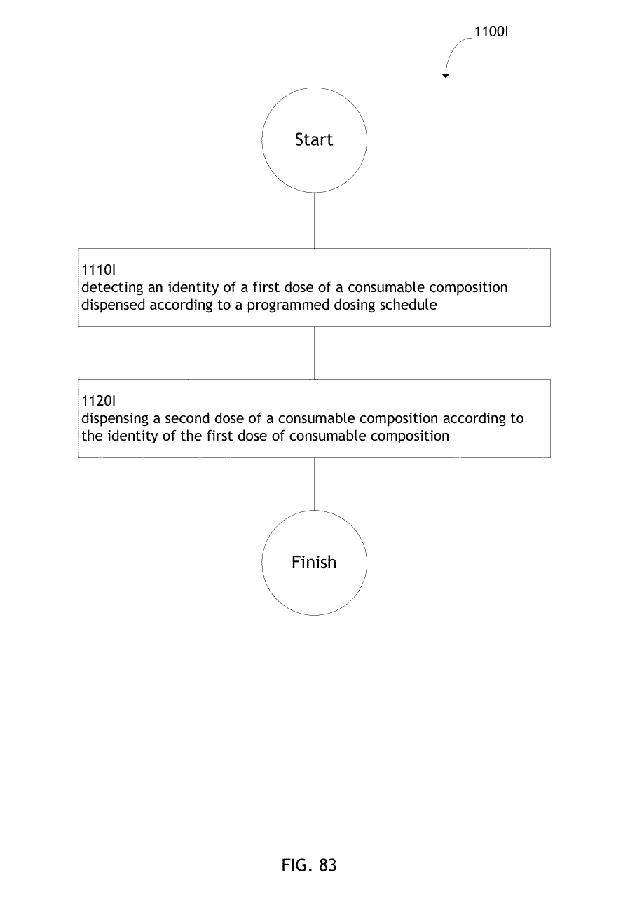

FIG. 83 depicts an operational flow 1100I representing example operations related to programmed dispensing of consumable compositions. After a start operation, the operational flow 1100I moves to an operation 1110I and/or an operation 1120I.

Operation 1110I depicts detecting an identity of a first dose of a consumable composition dispensed according to a programmed dosing schedule (e.g. spectroscopic measurement of the composition of a biochemical). For example, as shown in FIG. 1, an integrated consumable composition dispenser module 160, and/or an external consumable composition dispenser module 170 may distribute one or more doses (e.g. 30 mg) of a consumable composition (e.g., an anti-depressant, such as Paroxotene) into a beverage container 110 (e.g., a drinking cup) according to a programmed dosing schedule (e.g. electronic data representing a dispensing regimen maintained in memory 126). Sensing logic 124 may cause sensor module 150 to detect an identity (e.g. a chemical composition) of a consumable composition. Sensor module 150 may include a chemical composition analysis mechanism (e.g. photoionization sensors, spectroscopic sensors, spectrometric sensors, crystallographic sensors, electrochemical sensors, calorimetric sensors). Identity data regarding the first dose of a consumable composition may be compared to consumable composition identification data 126-3 maintained in memory 126 so as to determine an identity of the first dose of a consumable composition.

Operation 1120I depicts dispensing a second dose of a consumable composition according to the identity of the first dose of a consumable composition (e.g. distributing a second pharmaceutical composition in accordance with contraindications associated with a first dose of a consumable composition). For example, as shown in FIG. 1, an integrated consumable composition dispenser module 160, and/or an external consumable composition dispenser module 170 may distribute one or more doses (e.g. 30 mg) of one or more consumable compositions (e.g., a vitamin B-12 supplement) into a beverage container 110 (e.g., a drinking cup) according to the identity of the one or more consumable compositions (e.g. electronic data representing consumable composition identification data 126-3). The second dose of the consumable composition may be dispensed at varying time intervals following the dispensation of various different first doses of consumable compositions depending on calculated relative chemical interactions and physiological effects between the second dose and various first doses (e.g. a narcotic and a sedative may be dispensed at a different time interval than a vitamin and the sedative).

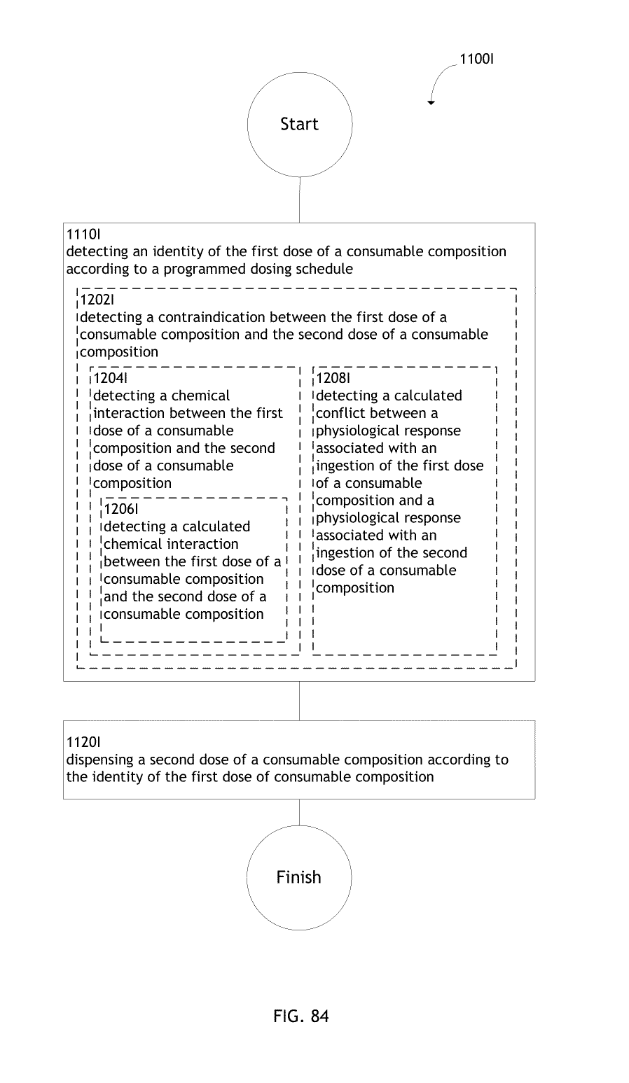

FIG. 84 illustrates an example embodiment where the operation 1110I of example operational flow 1100I of FIG. 83 may include at least one additional operation. Additional operations may include an operation 1202I, an operation 1204I, an operation 1206I and/or an operation 1208I.

Operation 1202I illustrates detecting a contraindication between the first dose of a consumable composition and the second dose of a consumable composition (e.g. detecting a combination of consumable compositions which, when ingested within a proximate time period, may be harmful to a user). For example, as shown in FIG. 1, the identity of the first dose of a consumable composition may be detected (e.g. detection of a chemical composition by a spectroscopic sensor module 150) and correlated with consumable composition identification data 126-3 for one or more second consumable compositions which may be generally contraindicated for the first dose of consumable composition or specifically contraindicated for a particular user 190 (e.g. consumable composition identification data 126-3 associated with a detected consumable composition may include one or more look-up table fields associated with one or more contraindicated consumable compositions). Alternately, the identities of at least one of the first consumable composition and second consumable composition may be transmitted to an ancillary system or device for analysis. For example, the communications module 130 may transmit detected consumable composition identity data to a monitoring entity 180 (e.g. a system associated with a physician) or a controllable device 185 (e.g. a wrist alarm, smart medicine cabinet, paramedic robot, and the like) to perform an interaction calculation.

Operation 1204I illustrates detecting a chemical interaction between the first dose of a consumable composition and the second dose of a consumable composition (e.g. detecting a deactivation of the functionality of a pharmaceutical consumable composition by a vitamin supplement). For example, as shown in FIG. 1, a chemical interaction between the first consumable composition and the second consumable composition may be detected by sensor module 150 (e.g. a spectrophotomer sensor) by detecting one or more chemical byproducts of a chemical reaction between the first consumable composition and the second consumable composition The chemical interaction between the first consumable composition and the second consumable composition as detected in Operation 1204 may be used in detecting a calculated contraindication between the first consumable composition and the second consumable composition (Operation 1202). For instance, the presence of one or more chemical byproducts may be indicative of a contraindicated interaction between the first consumable composition and the second consumable composition.

Operation 1206I illustrates detecting a calculated chemical interaction between the first dose of a consumable composition and the second dose of a consumable composition (e.g. detecting a potential deactivation of the functionality of a pharmaceutical consumable composition by a vitamin supplement based on data maintained in memory 126). For example, as shown in FIG. 1, the identity of the first dose of a consumable composition may be detected (e.g. detection of a chemical composition by a spectroscopic sensor module 150) and correlated with consumable composition identification data 126-3 for one or more second consumable compositions which may react chemically with the first dose of consumable composition (e.g. consumable composition identification data 126-3 associated with a detected consumable composition may include one or more look-up table fields associated with one or more contraindicated consumable compositions which react with the first consumable composition to produce undesired byproducts). The calculated chemical interaction between the first consumable composition and the second consumable composition as detected in Operation 1206 may be used in detecting a contraindication between the first consumable composition and the second consumable composition (Operation 1204). For instance, the consumable composition identification data 126-3 may include contraindication data representing consumable composition combinations which may be chemically incompatible and therefore, should not be administered within a given time period.

Operation 1208I illustrates detecting a calculated conflict between a physiological response associated with an ingestion of the first dose of a consumable composition and a physiological response associated with an ingestion of the second dose of a consumable composition (e.g. detecting proximate dispensations of an anti-coagulant, such as warfarin, and a blood pressure medication, such as a beta-blocker). For example, as shown in FIG. 1, the identity of the first dose of a consumable composition may be detected (e.g. detection of a chemical composition by a spectroscopic sensor module 150) and correlated with consumable composition identification data 126-3 for one or more second consumable compositions which, in combination with the first dose of consumable composition, may be associated with a an undesirable physiological response in a user 190 (e.g. consumable composition identification data 126-3 associated with a detected consumable composition may include one or more look-up table fields associated with one or more contraindicated consumable compositions which result in one or more incompatible physiological responses in user 190). The calculated physiological conflicts between the first consumable composition and the second consumable composition as detected in Operation 1208 may be used in detecting a contraindication between the first consumable composition and the second consumable composition (Operation 1202). For instance, the consumable composition identification data 126-3 may include contraindication data representing consumable composition combinations which may result in incompatible physiological responses in a user 190, and therefore, should not be administered within a given time period.

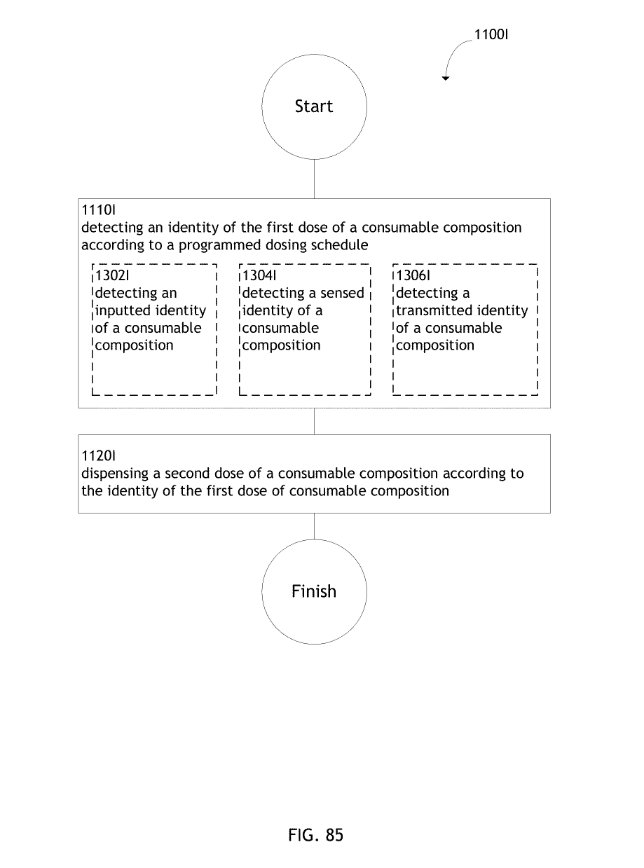

FIG. 85 illustrates an example embodiment where the operation 1110I of example operational flow 1100I of FIG. 83 may include at least one additional operation. Additional operations may include an operation 1302I, an operation 1304I, and/or an operation 1306I.

Operation 1302I illustrates detecting an inputted identity of a consumable composition (e.g. receipt of a user input identifying a consumable composition whose functionality may be affected by a second dose of a consumable composition). For example, as shown in FIG. 1, a user 190 may input an identity of a consumable composition via an input module 146 (e.g. a touch screen) of a user interface 140.

Operation 1304I illustrates detecting a sensed identity of a consumable composition (e.g. receipt of identification data from a label identifying a consumable composition whose functionality may be affected by a second dose of a consumable composition). For example, as shown in FIG. 1, the input module 146 of user interface 140 may include a bar code reader for reading a barcode from a label on a container for a consumable composition.

Operation 1306I illustrates detecting a transmitted identity of a consumable composition (e.g. receipt of identification data from a physician identifying a consumable composition whose functionality may be affected by a second dose of a consumable composition). For example, as shown in FIG. 1, the communications module 130, may receive consumable composition identification data from a monitoring system 180 (e.g. a system associated with a physician, a system associated with a consumable composition supply entity, or the like).

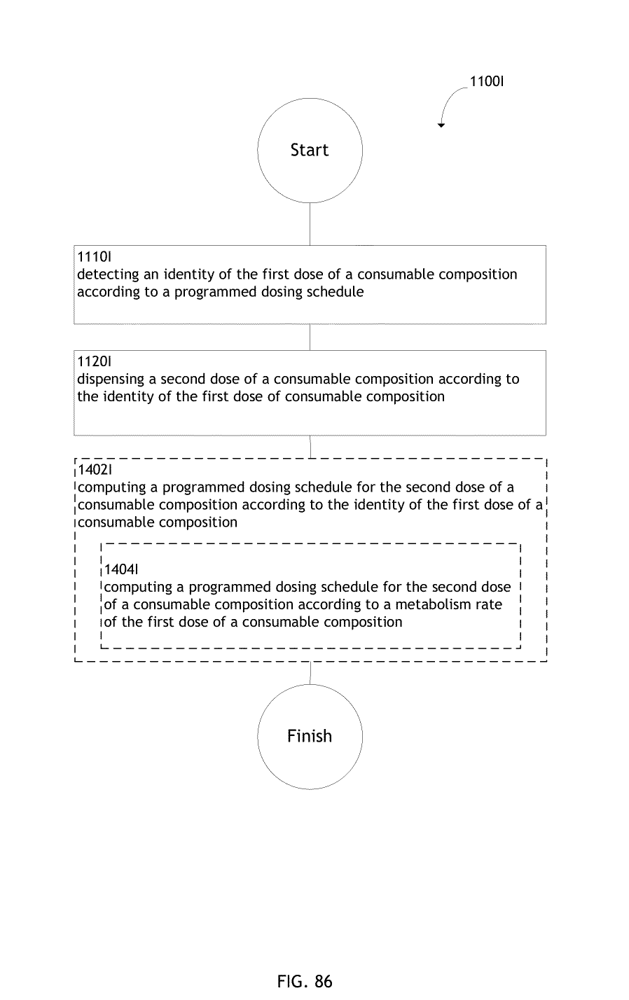

FIG. 86 illustrates an example embodiment where example operational flow 1100I of FIG. 83 may include at least one additional operation. Additional operations may include an operation 1402I, and/or an operation 1404I.

Operation 1402I illustrates computing a programmed dosing schedule for the second dose of a consumable composition according to the identity of the first dose of a consumable composition (e.g. a dose of an anti-coagulant may be scheduled for dispensation immediately following a dose of a narcotic but must be separated by a given time period from a dose of aspirin). For example, as shown in FIG. 1, sensing logic 124 may cause sensor module 150 to detect an identity (e.g. a chemical composition) of a first dose of a consumable composition which may be compared to consumable composition data 126-3. The consumable composition identification data 126-3 may include consumable composition interaction data regarding chemical and/or physiological interactions between various consumable compositions. The interaction data may include time values which must separate administration of doses of consumable composition pairs so as to avoid chemical and/or physiological interactions between consumable compositions. Upon detection of the identity of the first dose of a consumable composition, detection logic 121 may calculate a dosing schedule (e.g. 4 hours following administration of the first dose of a consumable composition) for the second dose of a consumable composition based on the interaction data. The dosing schedule for the second dose of a consumable composition may be stored as a dispensing program 126-2 in memory 126.

Operation 1404I illustrates computing a programmed dosing schedule for the second dose of a consumable composition according to a metabolism rate of the first dose of a consumable composition (e.g. a blood thinner may take 24 hours to fully metabolize in order to allow for a contraindicated dose of aspirin). For example, as shown in FIG. 1, composition identification data 126-3 maintained in memory 126 may include consumable composition interaction data regarding chemical and/or physiological interactions between various consumable compositions. The identification data may include metabolism rates for the consumable compositions. Upon detection of the identity of the first dose of a consumable composition, dispensing logic 125 may calculate a programmed dosing schedule for the second dose of a consumable composition based on the metabolism rate data (e.g. consumable composition A is metabolized at a rate of 50 mg/hour so a dose of contraindicated consumable composition B may be administered 2 hours following a 100 mg dose of consumable composition A). The identity and associated metabolism rate of the first consumable composition as detected in Operation 1404 may be used in computing a programmed dosing schedule for the second consumable composition (Operation 1402). For instance, a dosing schedule which avoids dispensing the second dose of a consumable composition until the first dose of consumable composition has been calculated as metabolized may be stored as a dispensing program 126-2 in memory 126.

Although a user 190 is shown/described herein as a single illustrated figure, those skilled in the art will appreciate that a user 190 may be representative of a human user, a robotic user (e.g., computational entity), and/or substantially any combination thereof (e.g., a user may be assisted by one or more robotic agents). In addition, a user 190, as set forth herein, although shown as a single entity may in fact be composed of two or more entities. Those skilled in the art will appreciate that, in general, the same may be said of “sender” and/or other entity-oriented terms as such terms are used herein.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1-40. (canceled)

41. A method for administering a consumable composition comprising:
dispensing a dose of at least one consumable composition into a container according to a programmed dosing schedule;
sensing an aspect of at least one dispensed dose of the consumable composition; and
communicating a sensed aspect of the at least one dispensed dose of the consumable composition to a system associated with a monitoring entity.

42. The method of claim 41, wherein the sensing an aspect of at least one dispensed dose of the consumable composition further comprises:
detecting an indication of a presence of a bodily fluid on the container.

43. The method of claim 41, wherein the sensing an aspect of at least one dispensed dose of the consumable composition further comprises:
detecting a movement of the container containing the consumable composition.

44. The method of claim 41, wherein the sensing an aspect of at least one dispensed dose of the consumable composition further comprises:
detecting a pressure applied to the container containing the consumable composition.

45. The method of claim 41, wherein the sensing an aspect of at least one dispensed dose of the consumable composition further comprises:
detecting a volume of fluid in the container containing the consumable composition.

46. The method of claim 41, wherein the sensing an aspect of at least one dispensed dose of the consumable composition further comprises:
detecting a mass of fluid in the container containing the consumable composition.

47. The method of claim 41, wherein the sensing an aspect of at least one dispensed dose of the consumable composition further comprises:
detecting a capacitance of fluid in the container containing the consumable composition.

48. The method of claim 41, wherein the sensing an aspect of at least one dispensed dose of the consumable composition further comprises:
detecting an outflow rate of the consumable composition from the container.

49. The method of claim 48, wherein the detecting an outflow rate of the consumable composition from the container further comprises:
detecting a rate of change of a volume of a fluid in the container.

50. The method of claim 48, wherein the detecting an outflow rate of the consumable composition from the container further comprises:
detecting a rate of change of a mass of a fluid in the container.

51. The method of claim 48, wherein the detecting an outflow rate of the consumable composition from the container further comprises:
detecting a rate of change of a capacitance of a fluid in the container.

52. The method of claim 41, wherein the sensing an aspect of at least one dispensed dose of the consumable composition further comprises:
detecting a degree of inclination of the container.

53. The method of claim 41, wherein the communicating a sensed aspect of the at least one dispensed dose of the consumable composition to a system associated with a monitoring entity includes:
communicating an amount of the consumable composition dispensed to a system associated with a monitoring entity.

54. The method of claim 53, wherein the communicating an amount of the consumable composition dispensed to a system associated with a monitoring entity includes:
communicating an amount of the consumable composition dispensed to a system associated with a consumable composition supply entity.

55. The method of claim 53, wherein the communicating an amount of the consumable composition dispensed to a system associated with a monitoring entity includes:
communicating an amount of the consumable composition dispensed to a system associated with a medical monitoring entity.

56. The method of claim 55, wherein the communicating an amount of the consumable composition dispensed to a system associated with a medical monitoring entity includes:
communicating an amount of the consumable composition dispensed to a system associated with a physician.

57. The method of claim 53, wherein the communicating an amount of the consumable composition dispensed to a system associated with a monitoring entity includes:
communicating an amount of the consumable composition dispensed to a system associated with an insurance entity.

58. The method of claim 53, wherein the communicating an amount of the consumable composition dispensed to a system associated with a monitoring entity includes:
communicating an amount of the consumable composition dispensed to a system associated with a legal entity.

59. The method of claim 58, wherein the communicating an amount of the consumable composition dispensed to a system associated with a legal entity includes:
communicating an amount of the consumable composition dispensed to a system associated with a parole entity.

60. The method of claim 41, wherein the communicating a sensed aspect of the at least one dispensed dose of the consumable composition to a system associated with a monitoring entity includes:
communicating an amount of the consumable composition calculated as ingested to a system associated with a monitoring entity.

61. The method of claim 60, wherein the communicating an amount of the consumable composition calculated as ingested to a system associated with a monitoring entity includes:
communicating an amount of the consumable composition calculated as ingested to a system associated with a consumable composition supply entity.

62. The method of claim 60, wherein the communicating an amount of the consumable composition calculated as ingested to a system associated with a monitoring entity includes:
communicating an amount of the consumable composition calculated as ingested to a system associated with a medical monitoring entity.

63. The method of claim 62, wherein the communicating an amount of the consumable composition calculated as ingested to a system associated with a medical monitoring entity includes:
communicating an amount of the consumable composition calculated as ingested to a system associated with a physician.

64. The method of claim 60, wherein the communicating an amount of the consumable composition calculated as ingested to a system associated with a monitoring entity includes:
communicating an amount of the consumable composition calculated as ingested to a system associated with an insurance entity.

65. The method of claim 60, wherein the communicating an amount of the consumable composition calculated as ingested to a system associated with a monitoring entity includes:
communicating an amount of the consumable composition calculated as ingested to a system associated with a legal entity.

66. The method of claim 65, wherein the communicating an amount of the consumable composition calculated as ingested to a system associated with a legal entity includes:
communicating an amount of the consumable composition calculated as ingested to a system associated with a parole entity.

67. The method of claim 41, wherein the communicating a sensed aspect of the at least one dispensed dose of the consumable composition to a system associated with a monitoring entity includes:
calculating a difference between an amount of consumable composition that is dispensed according to the programmed dosing schedule and an amount of the consumable composition that is calculated as ingested; and
communicating the difference between an amount of consumable composition that is dispensed according to the programmed dosing schedule and an amount of the consumable composition that is calculated as ingested to a monitoring entity.

68. The method of claim 41, further comprising:
providing an insurance discount according to the aspect of the consumable composition.

69. A system for administering a consumable composition, the method comprising:
at least one computing device; and
one or more instructions that, when implemented in the computing device, configure the computing device for:
dispensing a dose of at least one consumable composition into a container according to a programmed dosing schedule;
sensing an aspect of at least one dispensed dose of the consumable composition; and
communicating a sensed aspect of the at least one dispensed dose of the consumable composition to a system associated with a monitoring entity.

70. A system for administering a consumable composition, the system comprising:
circuitry for dispensing a dose of at least one consumable composition into a container according to a programmed dosing schedule; and
circuitry for communicating a sensed aspect of the at least one dispensed dose of the consumable composition to a system associated with a monitoring entity.
